(19) United States
(12) Patent Application Publication
(10) Pub. No.: US 2014/0329172 A1
(43) Pub. Date: Nov. 6, 2014

(54) ANISOTROPIC OPTICAL MATERIAL

(71) Applicant: HOLORAD, LLC, Salt Lake City, UT (US)

(72) Inventors: Stephen John Hart, San Juan Capistrano, CA (US); Daniel Louis Burman, Park City, UT (US); Dinesh Devanna Padiyar, Escondido, CA (US); Joyce Ann Padiyar, Escondido, CA (US)

(21) Appl. No.: 14/303,434

(22) Filed: Jun. 12, 2014

Related U.S. Application Data
(63) Continuation-in-part of application No. 13/133,440, filed on Jul. 15, 2011, now Pat. No. 8,786,925.
(60) Provisional application No. 61/144,535, filed on Jan. 14, 2009.
(60) Provisional application No. 61/121,509, filed on Dec. 10, 2008.
(60) Provisional application No. 61/844,298, filed on Jul. 9, 2013.

(51) Int. Cl. G03H 1/04

(52) U.S. Cl. CPC G03H 1/04
USPC 430/2; 355/2

(57) ABSTRACT

A method for producing a material with anisotropic optical properties, the method comprising: fabricating a patterned mask with alternating opaque and transparent regions; assembling a stack containing one or more layers of photosensitive material; and exposing the photosensitive material through the mask to photographically reproduce the pattern or its inverse. This photographic copying process yields a reproduction which is inherently well-registered to the mask's pattern, and the resulting registered patterns allow transmission in some directions whilst blocking transmission in other directions.

### CROSS REFERENCE TO RELATED APPLICATIONS

This application is a continuation-in-part of, claims priority to and the benefit of, U.S. Ser. No. 13/133,440 filed Jul. 15, 2011 and entitled “SYSTEM AND METHOD FOR COLOR MOTION HOLOGRAPHY.” The '440 application is a U.S. national phase filing under 35 U.S.C. §371 of PCT/US09/67588 filed Dec. 10, 2009. PCT Application No. PCT/US09/67588 claims priority to and the benefit of, U.S. Serial Nos. 61/144,535 filed Jan. 14, 2009 and 61/121,509 filed Dec. 10, 2008. This application is also a continuation-in-part of and a non-provisional of, claims priority to and the benefit of, U.S. Ser. No. 61/844,298 filed Jul. 9, 2013 and entitled “ANISOTROPIC ELEMENTS.” All of which are incorporated herein by reference in their entireties for all purposes.

### BACKGROUND

The disclosure generally relates to holography, and more particularly, to methods, systems and articles of manufacture for color motion holography and anisotropic optical material.

### SUMMARY

The disclosure includes a system, method or article of manufacture for producing an anisotropic optical material. More particularly, the method may comprise fabricating a mask upon which is disposed an alternating pattern of substantially-opaque regions and substantially-transparent regions, assembling a stack of one or more sheets of substantially transparent material upon which is disposed one or more layers of photosensitive material, and copying the pattern of the mask into the photosensitive material of the stack using photographic systems, processes and/or methods.

The mask may be attached to the stack prior to the copying or the mask may be removed from the stack subsequent to the copying. The process of fabrication of the mask may include a printing process and/or a photographic process. The printing process may be additive or subtractive. The photographic process may be a positive process or a negative process.

The pattern may comprise substantially-opaque lines alternating with substantially-transparent lines. The width of the substantially-opaque lines may be approximately equal to the width of the substantially-transparent lines. The shape and size of the substantially-opaque regions may be approximately equal to the shape and size of the substantially-transparent regions. The substantially-opaque regions and the substantially-transparent regions may be substantially square, substantially rectangular, substantially triangular and/or substantially hexagonal. The transition from a substantially-opaque region to a neighboring substantially-transparent region may be gradual.

The process of assembly may include lamination with a substantially transparent adhesive. The process of attachment may include lamination with a substantially transparent adhesive. The pattern may be created by copying a master pattern and the copying may use a photographic process. The photographic process may be a positive photographic process and/or a negative photographic process. The copying may use a substantially collimated exposure source and/or a scanned exposure source.

During the copying, the mask and/or stack may be scanned through exposure energy from an exposure source. The stack may be drawn from a roll. The copying may use exposure energy incident substantially at a normal angle of incidence and/or incident substantially at a substantially tilted angle of incidence.

### DESCRIPTION OF THE DRAWINGS

The features and advantages of the present disclosure will become more apparent from the detailed description set forth below when taken in conjunction with the drawings, wherein like numerals represent like elements.

FIG. 1A through FIG. 1D depict the transmission and blocking of different colors of light at different angles through stacks of holograms and dichroic filters, in accordance with various embodiments.

FIG. 2A through FIG. 2C depict front and side views of light paths and image points in dispersion compensated hologram replay systems, in accordance with various embodiments.

FIG. 3A through FIG. 3F depict a system analogous to that of FIG. 2C but with divergent and convergent beams, in accordance with various embodiments.

FIG. 4A through FIG. 4C depict hologram mastering and hologram copying systems, in accordance with various embodiments.

FIG. 5A through FIG. 5G depict transmission spectra for a dichroic at a range of angles, in accordance with various embodiments.

FIG. 6A through FIG. 6G depict transmission spectra for another dichroic at another range of angles, in accordance with various embodiments.

FIG. 7 depicts transmission for a holographic dichroic as a function of angle for three wavelengths, in accordance with various embodiments.

FIG. 8A through FIG. 8C depict the interior and exterior of a modified Voxbox display and a full-color hologram displayed thereon, in accordance with various embodiments.

FIG. 9A and FIG. 9B depict a hologram replay system, in accordance with various embodiments.

FIG. 10A through FIG. 10E depict image regions in a slice for a multi-slice hologram, with edge treatments, in accordance with various embodiments.

FIG. 11A through 11C depict the design of a character, a representation of it as slices, and one frame of the corresponding color animated hologram, in accordance with various embodiments.

FIG. 12 depicts swing-out in an animated hologram, in accordance with various embodiments.

FIG. 13 depicts an animated-hologram replay system, in accordance with various embodiments.

FIG. 14 depicts the drive electronics for a system similar to that of FIG. 13, in accordance with various embodiments.

FIG. 15 depicts another animated-hologram replay system, in accordance with various embodiments.

FIG. 16 depicts a storyboard for a holographic animation, in accordance with various embodiments.

FIG. 17 depicts the animated-hologram replay system of FIG. 15, in accordance with various embodiments.

FIG. 18 depicts a cross-section of a Voxblock material, with blocked and transmitted beams of three colors, in accordance with various embodiments.

FIG. 19A through FIG. 19D depict cross-sections of Voxblock materials, with blocked and transmitted beams, in accordance with various embodiments.

FIG. 20A through FIG. 20D depict transmission curves as functions of incident angle for materials similar to those in FIG. 19A through FIG. 19D respectively, in accordance with various embodiments.

FIG. 21A through FIG. 21E depict several of the opaque/transparent patterns described for Voxblock herein, in accordance with various embodiments.

FIG. 22A through FIG. 22C depict respectively a hard-edged opaque/transparent Voxblock pattern, a gray-scale rippled version thereof, and its binarization, in accordance with various embodiments.

FIG. 23 depicts a cross section of a three-pattern Voxblock material, with obstructed and transmitted beams, in accordance with various embodiments.

FIG. 24A and FIG. 24B depict a second-passthrough of a two-pattern Voxblock material, and the series of its passthroughs, in accordance with various embodiments.

FIG. 25 depicts moiréing of misaligned Voxblock patterns, in accordance with various embodiments.

FIG. 26 depicts calculated passthroughs for a two-pattern Voxblock material for different polarization states, in accordance with various embodiments.

FIG. 27 depicts a designed Voxblock pattern, in accordance with various embodiments.

FIG. 28 depicts a cross-section of a Voxblock exposure assembly with a removable mask and mirror, in accordance with various embodiments.

FIG. 29 depicts an exploded cross-section of a film stack similar to that of FIG. 28, in accordance with various embodiments.

FIG. 30 depicts an exposure geometry for use with an assembly similar to that of FIG. 28, in accordance with various embodiments.

FIG. 31 depicts measured passthroughs for a two-pattern Voxblock material, in accordance with various embodiments.

FIG. 32 depicts a calculated passthrough for a two-pattern Voxblock material, and its measured passthrough, in accordance with various embodiments.

FIG. 33 depicts transmission micrographs of a mask for a two-pattern Voxblock, and of its recordings, in accordance with various embodiments.

FIG. 34 depicts the spectral-sensitivity of a recording film for use in an assembly similar to that of FIG. 28, in accordance with various embodiments.

FIG. 35 depicts HD curves for front and rear Voxblock patterns recorded in a film similar to that of FIG. 34, in accordance with various embodiments.

FIG. 36 depicts transmission micrographs of a mask and its recordings for a narrower pattern than that of FIG. 33, in accordance with various embodiments.

FIG. 37 depicts a hologram recording system with an occlusion-mask, in accordance with various embodiments.

FIG. 38 depicts the use of binary occlusion masks for two views, in accordance with various embodiments.

FIG. 39 depicts the use of multiple occlusion masks for a cuboidal object, in accordance with various embodiments.

### DETAILED DESCRIPTION

The present disclosure includes systems and methods for creating and using color moving holographic images portraying arbitrary objects and/or scenes. As used herein, color may include full or partial color or any individual color combinations. For convenient description, exemplary embodiments may be broken down into three primary interrelated aspects, namely color, motion, and occlusion. However, each feature can also be practiced advantageously individually or in combination with either or both of the other features.

The detailed description of exemplary embodiments herein makes reference to the accompanying drawings, which show the exemplary embodiments by way of illustration. While these exemplary embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

Most previous work in the field of color holography has assumed the availability of an actual colored object, and has set out to record the object holographically using several (typically three) laser beams of different, carefully chosen colors, using a holographic recording material with panchromatic response. Generally, such approaches yield holograms in which accurate color rendition is hard to achieve because of spectral-response limitations of the available recording materials, and the limited color-space sampling provided with a small set of specific laser wavelengths, and because they have been used for holographic replay techniques which do not adequately reconstruct sharp accurate color images of significant depth and with adequate angle-independent color. A “dispersion compensation” holographic technique has been available which can provide matched geometry in two-dimensions of a reconstructed color hologram, but this technique suffers from a residual longitudinal color dependence which limits it to fairly shallow holograms and fairly small viewing angles.

The present disclosure solves these problems by providing systems, methods and techniques to produce and use deep color holograms of arbitrary subject matters (including computer or other data), wherein the recording of the holograms may be achieved using a single color of laser light and a recording material which may only be sensitive at this wavelength. The recording and replay of such holograms disclosed herein overcomes the problem of residual longitudinal color and further provides for accurate color registration and geometric fidelity, even for close and off-axis observers and even for replay reference beams which are not well matched (in angle, vergence, or wavelength) to the recording reference beams.

Most previous work in motion holography has generally either assumed the availability of an actual moving object, and has set out to record the object holographically using pulsed lasers recording a linear series of holograms on a rather narrow strip of film, or has used holographic techniques to record and replay stereoscopic images (not true holograms in the sense of Gabor, Denisyuk, and Leith) in which the motion is present in the form of a series of stereo pairs. The present disclosure solves these problems by providing systems, methods and techniques to produce and use true holograms (i.e., with actual extent in all three dimensions) without significant size restrictions and of arbitrary subject matters (including computer or other data), wherein multiple holographic images are recorded within a single holographic material such that they may be replayed one at a time in series, random, or non-sequential order, via the rotation of the replay reference beam relative to the recording material.

Most previous work in multiple-slice holography has generally concentrated on recording and replaying radiological data such as CT and MR scans in which spatially distinct slices of information are already available, and in which transparency is desirable during replay, so as to see interior details within the data. The present disclosure addresses these issues by providing means and techniques to produce and use holograms using arbitrary data (e.g., computer animations originally produced for cinematic display) with controllable occlusion, such that holographic content may be seen to be fully or partially opaque.

Color

In various embodiments, the systems and methods achieve full-color holographic imagery by combining multiple single-color holograms and angle-dependent color filters. For example, a full-color transmission hologram may be achieved which replays its image content in red, green, blue and/or any of a wide range of other colors and shades of color. The shades of color may be achieved by combining two or more colors in different proportions, including for example white and a range of grays, which are balanced combinations of red, green, and blue, yellow, which is a balanced combination of predominantly green and red, and black, which is the substantial absence of all colors.

By way of an introductory example to the present disclosure, a first holographic film is prepared as a transmission hologram in which the recorded light represents the degree to which each image point in three dimensions is to replay as red. For convenience, this is referred to as film R (or the R film) and the image it replays is referred to as the R image (or R hologram). Similarly, a second holographic film is prepared as a transmission hologram in which the recorded light represents the degree to which each image point in three dimensions is to replay as blue. For convenience, it is referred to as film B (or the B film) and the image it replays is referred to as the B image (or B hologram). And similarly, a third holographic film is prepared as a transmission hologram in which the recorded light represents the degree to which each image point in three dimensions is to replay as green. For convenience, this is referred as film G (or the G film) and the image it replays is referred to as the G image (or G hologram).

For this example, each of the R B and G films is recorded with a substantially collimated off-axis monochromatic reference beam at substantially a particular reference beam angle. The reference beam angle for the R film is referred to as REFr, the reference beam angle for the B film as REFb, and the reference beam angle for the G film as REFg.

In this example, each of the three films records a representation of what it itself is to replay, and each the representation is visible upon replay through a viewing volume which may conveniently be described as having an angular width which for the R film is referred to as angle Wr and an angular height which for the R film is referred to as angle Hr. Similarly the B and the G films each record a representation which is visible upon replay through viewing volumes described respectively by width and height angles Wb, Hb, Wg, and Hg.

Of these three holographic films, each one in effect records, and hence is able to replay, a representation of their shared subject matter such that it may be replayed in one of three primary colors, red, green, and blue. Our goal now is to replay these three films in combination such that for any replay point within the replay region which is visible between the overlap (if any) of Wr Wb and Wg and between the overlap (if any) of Hr Hb and Hg, the net color of the point is determined by the combination of a proportion of red light from the R film with a proportion of blue light from the B film and a proportion of green light from the G film in relative ratios suitable to obtain any color or shade which may be produced by the additive combination of these primary colors.

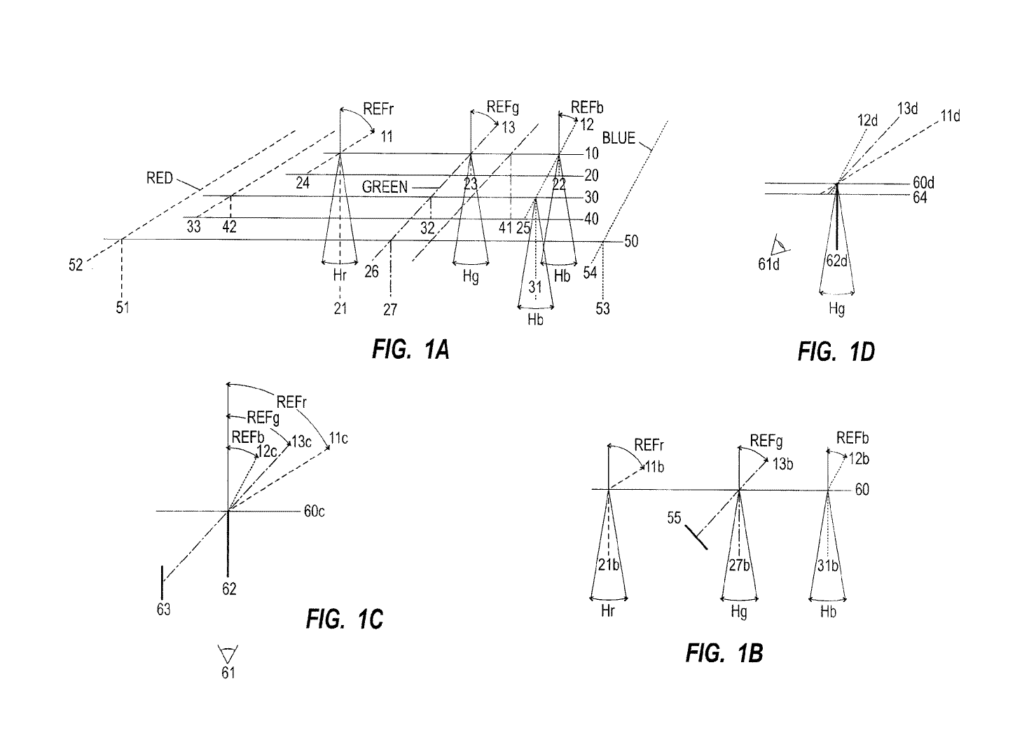

To achieve this goal in our example, and with reference to FIG. 1A, three holographic films R (10) B (30) and G (50) are stacked with two interposed dichroic filters (20 and 40). In FIG. 1A these films and filters are shown as seen from their edges with their planes extending out of the page, and the various light paths through them are shown for light travelling in the plane of the page. Gaps have been left between the films and filters in FIG. 1A so that the light paths may be seen more clearly. These gaps are eliminated in FIG. 1B, FIG. 1C, and FIG. 1D.

The first of the two filters (20) is placed between the R film (10) and the B film (30). This filter is referred to as the Pi filter. It substantially or completely transmits red light incident upon it within the intended Hr by Wr viewing angles of the R hologram (21) but it substantially or completely blocks blue light incident upon it within the intended Hb by Wb viewing angles of the B hologram (22) and it substantially or completely blocks green light incident upon it within the intended Hg by Wg viewing angles of the G hologram (23). Furthermore, this Pi filter (20) substantially or completely blocks red light incident upon it at or near the reference angle REFr (24) and it substantially or completely transmits blue light incident upon it at or near the reference angle REFb (25) and it substantially or completely transmits green light incident upon it at or near the reference angle REFg (26).

The second filter (40) is placed between the B film (30) and the G film (50). This filter is referred to as the St filter. It substantially or completely transmits red light incident upon it within the intended Hr by Wr viewing angles of the R hologram (21) and it substantially or completely transmits blue light incident upon it within the intended Hb by Wb viewing angles of the B hologram (31), but it substantially or completely blocks green light incident upon it within the intended Hg by Wg viewing angle of the G hologram (32). Furthermore, this St filter (40) substantially or completely blocks red light incident upon it at or near the reference angle REFr (33) and it substantially or completely blocks blue light incident upon it at or near the reference angle REFb (25) and it substantially or completely transmits green light incident upon it at or near the reference angle REFg (26).

The combined effect of these three films and two filters so disposed in a stack is as follows.

Upon transmission illumination at or near the red reference angle REFr (11), the R film (10) replays the red content (21) for the final image and this red content (21) is substantially or perfectly visible in transmission through the stack because it is replayed at or near angles which are substantially or completely transmitted by each in turn of the Pi filter (20), the B film (30), the St filter (40), and the G film (50).

Upon transmission-illumination at or near the blue reference angle REFb (12), the B film (30) replays the blue content (31) for the final image and this blue content (31) is substantially or perfectly visible in transmission through the stack because it is replayed at or near angles which are substantially or completely transmitted by each in turn of the St filter (40) and the G film (50).

Upon transmission-illumination at or near the green reference angle REFg (13), the G film (50) replays the green content (27) for the final image and this green content (27) is substantially or perfectly visible because the G film is the final component of this example stack.

FIG. 1B shows a gapless stack (60) comprising in sequence the R film (10), Pi filter (20), B film (30), St filter (40), and G film (50) of FIG. 1A, and shows only those light paths which exit such a stack, specifically, a blue image (31b) originating from the diffraction of the blue replay reference (12b) by film B (30), a green image (27b) originating from the diffraction of the green replay reference (13b) by film G (50), and a red image (21b) originating from the diffraction of the red replay reference (11b) by film R (10).

FIG. 1C shows a gapless stack (60c) comprising in sequence the R film (10), Pi filter (20), B film (30), St filter (40), and G film (50) of FIG. 1A, with red replay reference beam (11c), green replay reference beam (13c), and blue replay reference beam (12c) all incident upon the same region of the stack (60c). An observer (61) viewing the illuminated assembled stack (60c) sees the three-dimensional holographic image (62) with red content produced from the red replay reference beam (11c) in shades of red as diffracted by the R film (10) and with negligible or no red imagery from the B film (30) or the G film (50), combined with blue content produced from the blue replay reference beam (12c) in shades of blue as diffracted by the B film (30) and with negligible or no blue imagery from the R film (10) or the G film (50), combined with green content produced from the green replay reference beam (13c) in shades of green as diffracted by the G film (50) and with negligible or no green imagery from the R film (10) or the B film (30). The combined effect is that observer (61) viewing the stack (60c) sees a full-color three-dimensional holographic image (62), wherein the shades of red are produced solely or almost entirely by the R film (10), the shades of blue are produced solely or almost entirely by the B film (30), and the shades of green are produced solely or almost entirely by the G film (50).

Referring again to FIG. 1A, the R film (10) may have a broadband response, such that in addition to replaying the red image (21) upon illumination by red light (11) at or near angle REFr, it may also replay to some visually significant degree a blue image (22) upon illumination by blue light (12) at or near angle REFb and/or a green image (23) upon illumination by green light (13) at or near angle REFg. However these spurious blue (22) and green (23) images, if present, are substantially or completely blocked by the Pi filter (20), and the spurious green image (41) is further substantially or completely blocked by the St filter (40). The observer viewing light transmitted through the stack sees a red image (21) from the R film with comparatively little or no blue or green image from the R film (10).

Similarly, the B film (30) may have a broadband response, such that in addition to replaying the blue image (31) upon illumination by blue light (12) at or near angle REFb, it may also replay to some visually significant degree a red image (42) upon illumination by red light (33) at or near angle REFr and/or a green image (32) upon illumination by green light (13) at or near angle REFg. However, the original red reference light (11) present at or near angle REFr has been substantially or completely blocked before it can reach the B film (30) due to the combined actions of the R film (10) and the Pi filter (20), so no significant red spurious image can be formed by the B film (30), and the spurious green image (32), if present, is substantially or completely blocked by the St filter (40). The observer viewing light transmitted through the stack sees a blue image (31) from the B film (30), with comparatively little or no red or green image from the B film (30).

Similarly, the G film (50) may have a broadband response, such that in addition to replaying the green image (27) upon illumination by green light (13) at or near angle REFg, it may also replay (to some visually significant degree) a red image (51) upon illumination by red light (52) at or near angle REFr and/or a blue image (53) upon illumination by blue light (54) at or near angle REFb. However, the original red reference light (11) present at or near angle REFr has been substantially or completely blocked before it can reach the G film (50) due to the combined actions of the R film (10), the Pi filter (20), the B film (30), and the St filter (40) so no significant red spurious image can be formed by the G film (50). Similarly, the original blue reference light (12) present at or near angle REFb has been substantially or completely blocked before it can reach the G film (50) due to the combined actions of the R film (10), the Pi filter (20), the B film (30), and the St filter (40) so no significant blue spurious image can be formed by the G film (50). The observer viewing light transmitted through the stack sees a green image (27) from the G film (50) with comparatively little or no red or blue image from the G film (50).

In so far as the R film (10) has less than perfect holographic efficiency, a proportion of the red reference beam (11) continues past the R film (10) still at or near angle REFr and is incident (24) upon the Pi filter (20) which substantially or completely blocks it before it would otherwise reach the B film (30) or the G film (50). Hence the B film (30) and the G film (50) each receives little or no red light at or near angle REFr and hence, even if they are able to diffract a significant proportion of the red light, they receive too little such red light to produce a visibly significant red image.

Similarly, in so far as the B film (30) has less than perfect holographic efficiency, a proportion of the blue reference beam (12) continues past the B film (30) still at or near angle REFb and is incident (25) upon the St filter (40) which substantially or completely blocks it before it would otherwise reach the G film (50). Hence the G film (50) receives little or no blue light at or near angle REFb and hence, even if it is able to diffract a significant proportion of the blue light, it receives too little of such blue light to produce a visibly significant blue image.

The R film (10) and the Pi filter (20) do not substantially deviate the blue (12) or green (13) reference beams. Upon transmission illumination in blue light at or near the blue reference angle REFb and in green light at or near the green reference angle REFg, the R film (10) transmits all or at least part of the blue and green reference lights without substantially changing their respective angles of propagation. These blue and green reference beams then are incident upon the Pi filter (20) at or near their respective reference angles REFb and REFg, and the Pi filter (20) transmits all or at least part of the blue and green reference lights without substantially changing their respective angles of propagation such that they are incident upon the B film (30) as reference beams at or near their respective angles REFb and REFg.

Similarly, the B film (30) and the St filter (40) do not substantially deviate the green reference beam (13). Upon transmission illumination in green light at or near the green reference angle REFg, the B film (30) transmits all or at least part of the green reference light without substantially changing its angle of propagation. This green reference beam then is incident upon the St filter (40) at or near angle REFg, and the St filter (40) transmits all or at least part of the green reference light without substantially changing its angle of propagation such that it is incident upon the G film (50) as a reference beam at or near angle REFg.

In so far as the G film (50) has less than perfect holographic efficiency, a proportion of the green reference beam (26) continues past the G film (50) still at or near angle REFg. This residual green reference beam does not disrupt the viewing by observer (61) of the red, blue, and green holographic content (62) because it remains at or near angle REFg which is assumed to be outside of the viewing volumes defined by angles Wr Wb Wg Hr Hb and Hg. Typically this residual reference beam illuminates a beam block (55) or the floor (63) of the space in which the hologram is viewed. In some circumstances it may be advantageous for this residual reference beam to illuminate another surface such as a table or the ceiling or a wall. As another aspect of this disclosure, as shown in FIG. 1D, a third angle-dependent filter (64) which is referred to as the Sa filter, may be added to stack (60d), the stack comprising in sequence the R film (10), Pi filter (20), B film (30), St filter (40), and G film (50) of FIG. 1A. This third filter follows the G film (50), and substantially or completely transmits red light incident upon it within the intended Hr by Wr viewing angles of the R hologram and substantially or completely transmits blue light incident upon it within the intended Hb by Wb viewing angles of the B hologram and substantially or completely transmits green light incident upon it within the intended Hg by Wg viewing angles of the G hologram (62d), but it substantially or completely blocks green light incident upon it at or near reference angle REFg (13d) and ideally also substantially or completely blocks any residual blue light incident upon it at or near reference angle REFb (12d) and ideally also substantially or completely blocks any residual red light incident upon it at or near reference angle REFr (11d). By this means, even a second observer (61d) located, for example, in the optical path of any such residual light sees little or no such light passing through Sa filter (64).

An advantage of the present disclosure is that the constituent holograms can be made using holographic recording materials, processes, and geometries that do not directly involve or adequately record or reproduce all the desired colors. For example, using a green laser such as a frequency-doubled Nd:YAG laser at 532 nm (a very convenient green wavelength) a holographic recording material and process can be used which gives excellent performance for green light but which would record poorly or not at all in red or blue light (such films and processing regimes are widely available, e.g., see Bjelkhagen's “Silver Halide Recording Materials for Holography and Their Processing, Springer-Verlag, 1993). The “red” and “blue” films, produced in accordance with various embodiments, can be replayed in red and blue light respectively even though only green light and green-sensitive film was used in their recording. This also overcomes the blue-scatter and resolution problems which have been a problem for blue-sensitive and panchromatic holographic materials. And it permits the use of recording materials and geometries for which even the “green” film is produced using another wavelength (e.g., a pulsed red source such a ruby laser) where to do so may be advantageous (e.g., holography of non-stationary objects). For example, a wide variety of holographic recording materials are suitable for recording the individual holograms, in accordance with various embodiments, including silver-halide, thermoplastics, DCG, liquid crystal, photoresist, crystalline or glassy electro-holography materials, bacterial materials, and photopolymers, even if such materials are unsuitable for recording one or more of the primary colors, either directly or as master holograms or as intermediate holograms for eventual holographic copying into the same or other materials.

The color aspect of the present disclosure, as described above in example form, envisages the use of angle-dependent filters between (and, in the case of the Sa filter, following) the films, and hence as described the B film (30) is further from the observer than the G film (50) by at least the thickness of the St filter (40) (and perhaps by a somewhat greater separation including the thickness of the holographic films themselves and of any spacers and other layers introduced in to the film-filter stack). Similarly, the R film (10) is even further from the observer, being behind the Pi (20) filter. Hence accurate color registration in certain embodiments includes the red, blue, and green holographic images being produced by their respective films with slight shifts in the direction perpendicular to the film, so that, in the example given, the R film projects its image a slightly greater distance than the G film does its corresponding image, and the B film projects by an intermediate amount, the exact offsets between the images corresponding to the optical distance between the recording surfaces of the respective films, where by “optical distance” we mean to indicate that while the Pi filter (20) may, for example, have a physical thickness of 3 mm, its apparent thickness is less than this by a factor 1/n where n is the average refractive index of its substrate material, just as a pool of water looks shallower than it really is.

The red blue green ordering described in the above example may instead be implemented as red green blue or any other ordering of these or other suitable colors. In practice it may be easier, less costly, or otherwise advantageous to design or fabricate filters and holograms based upon one particular color order. The present inventors could more easily achieve a satisfactory performance using the red blue green ordering described above.

The above example refers to “red” light, “blue” light, and “green” light, without giving a specific wavelength or wavelength range for each the color. The present disclosure can be practiced using broadband wavelength ranges from a white light source, with each color spanning a range of about one hundred nanometers. It may however be advantageous to use narrower-band illuminants, such as the light from red blue and green LEDs with full-width-at-half-maximum (FWHM) bandwidths of for example tens of nanometers, or even very narrow-band red blue and green laser sources with FWHM bandwidths of for example a few nanometers or less: narrower bandwidth sources can simplify the design, production, and use of filters which may lack sharp and/or efficient pass-bands and block-bands, however broadband sources are generally less costly. A commercially or otherwise advantageous design may involve sources of different natures for each color, such as for example band-filtered white light for the green source, a blue LED or band-filtered blue LED, arc light, or incandescent source for the blue source, and several red lasers combined for the red source. In particular, it may be easier to design and fabricate suitable filters and/or holograms if the FWHM bandwidth of each color is restricted (or reduced by additional filtration before, within, or following the disclosure as so far described) so that one or more regions of the visible spectrum becomes substantially irrelevant to the design and performance of one or more of the filters and/or holograms.

For example, in the present inventors' color demonstration (described below) an additional small filter can be introduced at a point at which light from the source is not significantly expanded. For example, a Semrock BrightLine Multiband Bandpass FF01-457/530/628 dichroic filter [Semrock Inc, Rochester, N.Y.] is suitable. This limits the bandwidths of the three broadband LEDs used in this demonstration, which bandwidths in the case of the specific components used contain a significant degree of spectral overlap which makes the design and fabrication of suitable filters more challenging and can lead to visible colored ghost images caused by, for example, a proportion of yellowish and greenish-blue light undesirably passing through the Pi and St filters and then acting as reference light and being reconstructed by the G film yielding colored ghost images.

In the context of the present disclosure, ghost images can occur as colored or uncolored sharp or diffuse images around or adjacent to the intended holographic images or displaced from them and can be of a two-dimensional or three-dimensional nature. Various kinds of ghost image can appear, including those described above (also referred to above as spurious images), ghosts due to misalignment as described below, and ghosts due to several other potential causes such as inter-reflections between components in the film/filter stack. It is generally advantageous to eliminate or substantially reduce the number and intensity of such ghosts because they can be visually distracting, and they can reduce the visibility, brightness, contrast, and color saturation of the intended holographic content. However they can sometimes be accommodated as acceptable aesthetic or artistic effects, or even allowed for in the design or selection of image content.

A further source of ghosts is ambient light originating on the observer's side of the present disclosure. This can be of arbitrary color, intensity, polarization, and direction, and can include specular, focused, and diffuse components. Such light can be reflected, refracted, diffracted, and scattered from and between the various components of the present disclosure, and may then be visible to the observer as two-dimensional or three-dimensional colored or uncolored ghost images or sparkles or glare or diffuse, concentrated, or focused noise. Such defects may be reduced or eliminated by careful positioning of the display system embodying the present disclosure with respect to the sources of ambient light, by reducing or eliminating all or some of the sources of ambient light, by providing anti-reflection or further color-filtering coatings to the optical components of the present disclosure, by adjusting the design of one or more of the optical components to reduce the severity of such defects, or by a combination of one or more such means. The outermost color filter, filter St in the example above, or filter Sa if this additional optional filter is included, is prone to the non-holographic causes of such defects, and the outermost hologram, the G film in the above example, is prone to the holographic causes of such defects, because these are the filter and film respectively which respectively are closest to the observer and any ambient light sources. This may be recognized in the design of any particular implementation of the present disclosure and in the use of any such implementation: for example, if the outermost film is chosen to be the G film then green ambient light sources (and other ambient light sources which contain a green component such as yellow lights and white lights) are likely to be particularly troublesome so that it may be more advantageous to have the B film or the R film closest to the observer. Similarly, it is generally advantageous to design the outermost filter element (St or Sa in the above example) to not strongly reflect ambient light back in the direction of the observer or observers otherwise it can act as mirror in which well defined reflections can be seen of the ambient sources and of the observer and of the room or other space external to and optically in front of the present disclosure.

The green content of a color image is commonly the most important component for visual communications. This is recognized, for example, in the NTSC system for color television [National Television System Committee, 1953] in which the green component is allocated approximately twice as much bandwidth as either of the blue and red components. Two design considerations derive from this in the context of the present disclosure. Firstly, it may be beneficial to prefer the green content over the red and/or blue content, for example by dividing the green content between two or more films rather than using a single film for all the green content if by so doing each film can, for example, be made sufficiently brighter, more contrasty, or less noisy so that this division into two or more films results in an improved green image, and in the preview environments and metric-based optimizations described below, special care can be taken to alert users to green-related problems, and metrics can be weighted to find solutions which favor the green components of images. Secondly, it may be advantageous to choose a color ordering in which the G film is not on the observer's side of the stack, so that it and the final color-selection filter (St or Sa in the above example) do not act as green mirrors so that this becomes for example a blue mirror or red mirror problem which may generally be more easily mitigated or may generally be less problematic for the observer.

The principles of the disclosure as described in the example above may be extended to more than three basis colors, for example using red, green, blue, and yellow, or red reddish-green, blueish-green, and purple because such a selection of basis colors may be more suitable for accurate or pleasing color rendition, or may further enhance designability, manufacturability, or ruggedness, or reduce the cost of the corresponding filters and holograms.

The principles of the disclosure as described in the example above may be applied for two rather than three or more colors, for example using only red and green, because such limited basis colors may provide sufficiently accurate or pleasing color rendition in some cases, or may further enhance designability, manufacturability, ruggedness, or reduce the cost of the corresponding filters and holograms.

In general, for a set of n basis colors, at least n−1 filters and n hologram films are used, with at least one extra filter if the final blocking of the final reference beam component (green via the Sa filter in the above example) is desired. It may prove advantageous to use two or more filters in place of any one filter described above if their combined effect is broadly as described: for instance, two filters may each cover only part of the waveband used for a particular “color” but may in combination filter that color sufficiently well or even to a superior degree or at lower cost than a single filter. It may prove advantageous to split the image content for a given color between two or more hologram films, as described above for the G film.

The principles of the disclosure as described in the example above may be applied for two or more visible or non-visible colors, such as bands in the radio, microwave, infrared, ultraviolet, or x-ray for non-visual applications or where, for example, an ultraviolet excitation is used for a fluorescent or phosphorescent image. As an example, a thermal infrared holographic volume may be superimposed upon a hologram representative of a hot muffin so that if an observer reaches in to touch the holographic muffin they feel a suitable distribution of heat as they approach the visual image of the muffin. Similarly, radio or microwave holograms can be used to sense or trigger the presence, proximity, or spatial location of small hand-held receiving/transmitting devices such as a Radio Frequency Identification Devices (RFIDs) or Near Field Communications (NFC) devices. And the thermal and other radiation effects of a holographic image may be used to permanently or temporarily modify the properties of a physical material spatially coincident with or adjacent to the holographic image, so that, for example, image-space heating or bioluminescence may be induced or a photopolymer or a powdery substance may be solidified or ice melted in a spatial pattern substantially corresponding to the distribution of appropriate energies in at least a part of the holographic image, for example for the creation or modification of specific two- or three-dimensional shapes for artistic, scientific, or commercial purposes.

The principles of the disclosure as described in the example above may also be implemented with one or more of the filters and/or films operating in reflection rather than transmission, though the transmission stack as described above has several useful advantages including that it can be assembled as a comparatively thin stack which can optionally use lamination or bonding of its individual elements to form a substantially solid and temporarily or permanently substantially indivisible assembly if this is advantageous for reasons such as enhanced ruggedness, simplicity of use, or the reduction of undesired optical effects including for example absorption, scattering, reflection, diffraction, and refraction at the optical transitions between elements.

Further optical and mechanical elements may advantageously be included in the film/filter stack or assembly including for example cover windows for mechanical protection on one or both of the input and output sides, gaskets, spacers, seals, and optical-indexing methods to establish or eliminate gaps and inclinations between elements and to prevent the ingress of contaminants such as dust and/moisture. Sealing, especially against moisture, by edge seals, lamination of layers, or the application of cover layers such as Barix [Vitex Systems, San Jose, Calif.] is useful in any operating or shipping environment in which dirt, dust, or other contaminants, or atmospheric humidity, may be significant or outgassing, absorption, or adsorption is undesirable, and is especially useful with holographic materials which are significantly moisture sensitive, such as DCG, or that are to be used underwater or at high humidity, in a vacuum or a low-pressure, high-pressure, or potentially explosive environment.

The above example used dichroic filters and holographic films, however, the principles of the disclosure as described in the example above may also be implemented with other filters or filtering elements that exhibit angle dependences and color effects similar to or as described but which are not per se dichroic filters, such as, for example, by achieving color filtration by exploiting spatially-patterned color filters, prismatic or total-internal-reflection effects, chromatic aberrations in lenslet or prismatic sheets, optical metamaterials with negative refractive indices, or holographic dichroism or dichroic-like effects in holographic filters, and with films which are not holograms as described but are similar elements such as for example diffraction gratings or color holograms in which full or limited color rendering has been achieved by means other than those of this disclosure.

Whereas the above example maintains substantially constant values for the reference angles REFr REFb and REFg, it may be advantageous to alter the angle of one or more of the colored reference beams upon the beam's interaction with one or more of the film or filter components, or by introducing additional optical components for this purpose, for example by using chromatic dispersion or color-dependent diffraction, so as to optimize the propagation of the beam through the films and filters and other components to achieve particular or optimal values for the incidence angles of each the beam on each the film, filter, or other component.

The terms “optimize” and “optimum” and “optimal” are used herein to indicate a process of, and/or the results of, seeking or experimenting or calculating or modeling to find improved results. Such terms should not be limited to the determination or discovery of the best possible result, though this may be the result.

Having introduced the color aspect of the present disclosure via the above example, an advantageous method to achieve a color hologram of arbitrary content with good three-dimensional color registration is now described.

Bazargan [U.S. Pat. Nos. 4,623,214 and 4,623,215] teaches a Dispersion Compensated holographic display system, which can beneficially be used with the present disclosure, and which has been made commercially available by Holorad LLC [Salt Lake City, Utah]. In this, a transmission hologram is made using, for example, a substantially collimated reference beam of a specific wavelength and reference beam angle, for example approximately 56.3° (Brewster's angle for typical holographic materials with refractive indices of about 1.5) at approximately 532 nm, a green wavelength which is a convenient choice since very suitable lasers and film/chemistry combinations are widely available for this wavelength. This hologram (or a holographic copy of it) is then viewed in front of a display device which incorporates a white-light source such as a halogen lamp, a collimating optic such as a Fresnel lens, a diffraction grating which can conveniently be fabricated as a transmission hologram, and an anisotropic blocking material such as the angled variety of 3M's Light Control Film [3M Imaging Systems Division, St. Paul, Minn.].

These elements are typically combined in a free-standing self-contained hologram display device which may also include a housing to hold the display's parts, a mechanism to permanently or temporarily attach or hold one or more holograms in front of the device, and other desired or advantageous components such as an electrical power supply and an on/off switch. The principle of operation is as follows: the hologram as described replays comparatively strongly and without substantial spatial distortion when re-illuminated with substantially collimated light of the same wavelength (or nearly so) and at or near the same reference beam angle as was used when recording it; for other longer or shorter wavelengths at that same reference angle it generally replays (typically less strongly) with significant geometrical distortion. However for any given replay wavelength there is a matching reference beam angle (the “dispersion compensating angle”) for which the lateral distortions in the replayed hologram are minimized. This angle is determinable using the well known “grating equation”. And in practice if the grating element is made with substantially the same wavelength and reference angle as the hologram to be viewed then it diffracts each wavelength of light from the collimated white-light beam through an angle which closely matches that wavelength's dispersion compensation angle, and in combination with the hologram it produces a grayscale holographic image with negligible lateral distortion.

In Bazargan's device, this desirable compensation can conveniently be accomplished by making the hologram and the grating using identical or very similar beam angles, recording materials, and processing regimes. If the material/processing results in a significant swelling or shrinkage of the hologram or the dispersion-compensating grating, which could shift its respective diffraction angle, this may be corrected for by using a correspondingly altered reference beam angle (determined experimentally or using mathematical methods such as, for example, those provided by Bazargan). Alternatively, the grating or the hologram may be tilted with respect to the primary optical axis or the light source may be moved perpendicularly to this axis. Again, the tilt or offset can be established experimentally or using mathematics such as Bazargan's.

With a dispersion compensation technique such as that of Bazargan, the present disclosure can conveniently and advantageously be implemented using similar or identical recording reference beam angles for each replay color in conjunction with a single recording laser emitting at a single wavelength. This optional feature allows one hologram recording setup to be used for producing all the hologram films without using multiple laser wavelengths or any change in reference beam angle. Since making such changes generally includes the physical relocation and the partial or complete duplication of expensive, heavy, delicate beam-directing and collimating optics, this can be a significant commercial advantage, and may even permit hologram recording geometries which otherwise would be difficult or impossible to achieve practically.

The basic features of this dispersion compensation technique are well known to those skilled in the arts. What is not well known, but is described in detail in Bazargan's doctoral thesis [Techniques in Display Holography, University of London, 1986], is that a residual longitudinal chromatic effect is still present: specifically, while the dispersion compensation technique can in theory perfectly correct lateral distortions/displacements in the holographic image, a longitudinal variation in image magnification remains in which the depth and extent of the holographic image is wavelength dependent. A mathematical treatment of this is provided in Dr Bazargan's aforementioned doctoral thesis, using the mathematical techniques of Champagne [Nonparaxial Imaging, Magnification, and Aberration Properties in Holography, JOSA 57, 51-5, 1967].

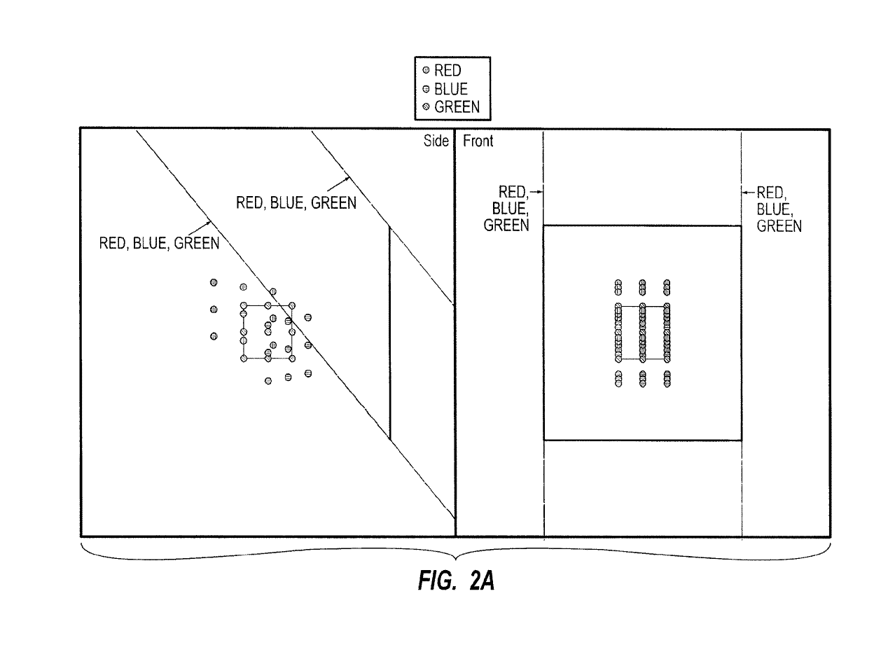

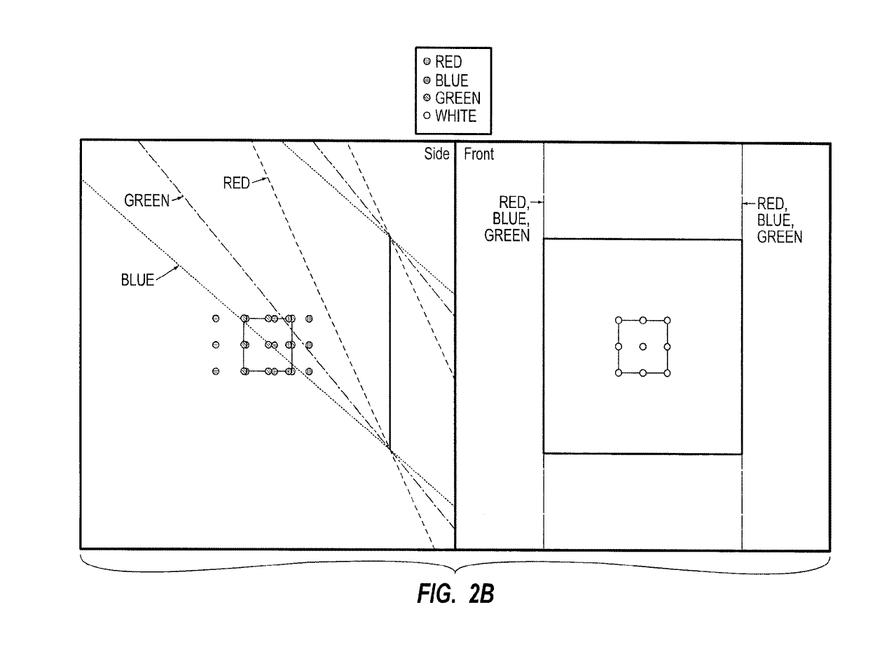

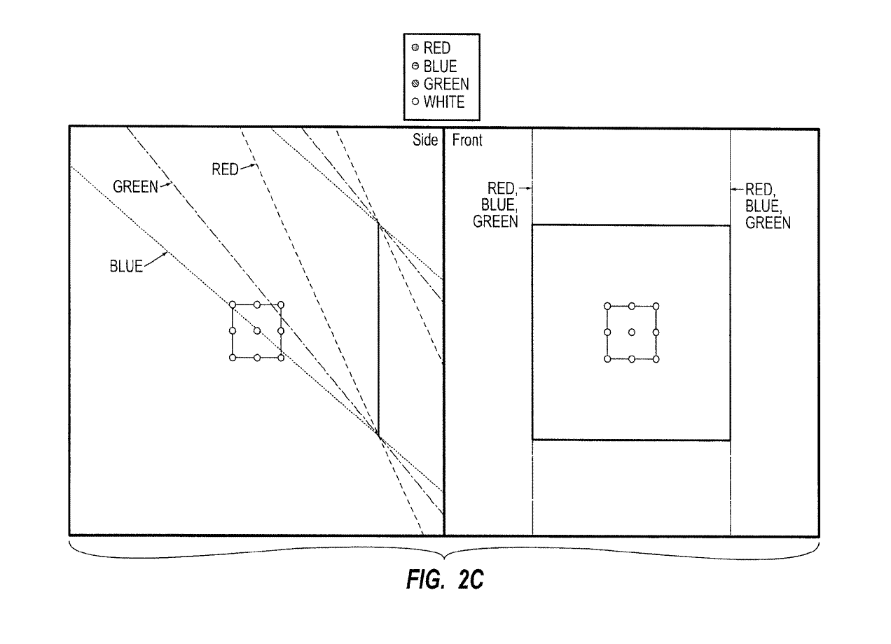

FIG. 2A and FIG. 2B illustrate in side and front views an exemplary dispersion compensation technique of Bazargan as seen by an observer located at a substantial distance along the z-axis (the axis perpendicular to and centered upon the hologram) for a collimated 532 nm recording reference at a 48.3° reference angle, and collimated 640 nm, 532 nm, and 447 nm replay references at 48.3° (in FIG. 2A) and at dispersion compensated angles of, respectively, 63.9°, 48.3°, and 38.9° (in FIG. 2B).

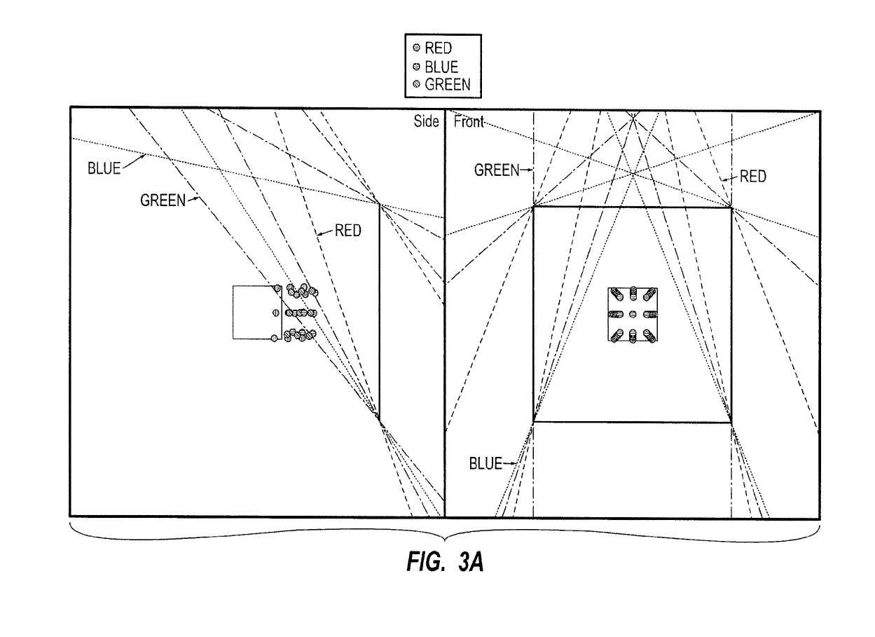

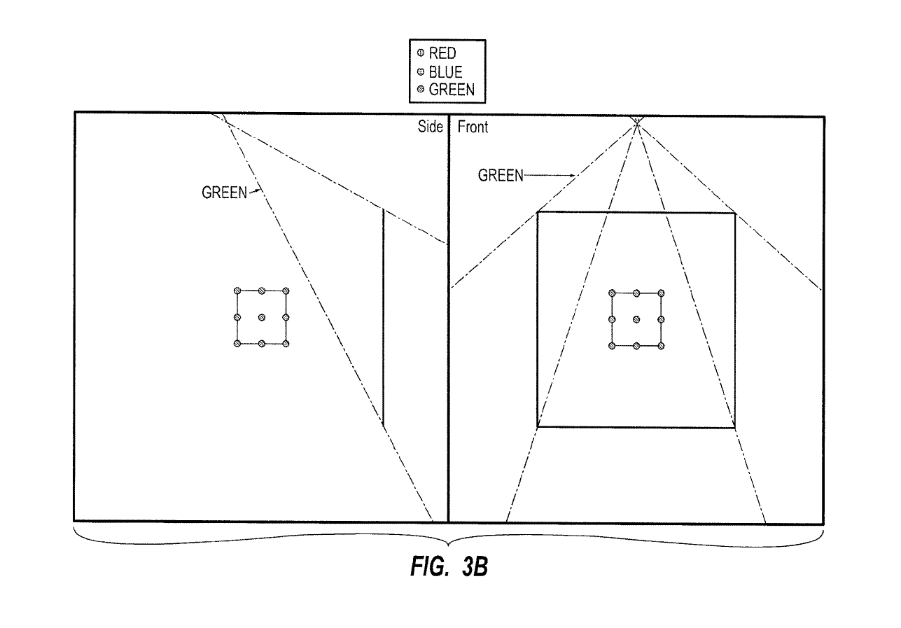

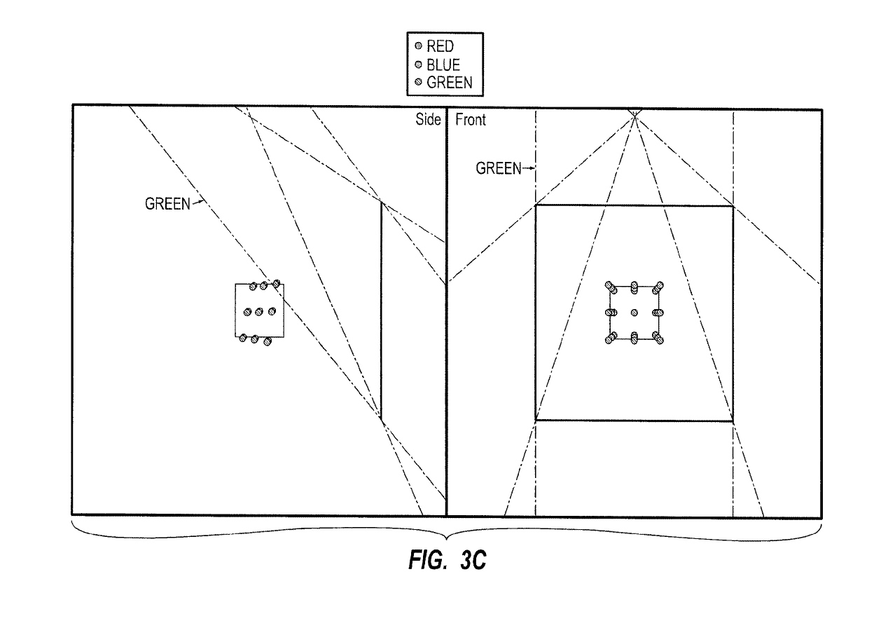

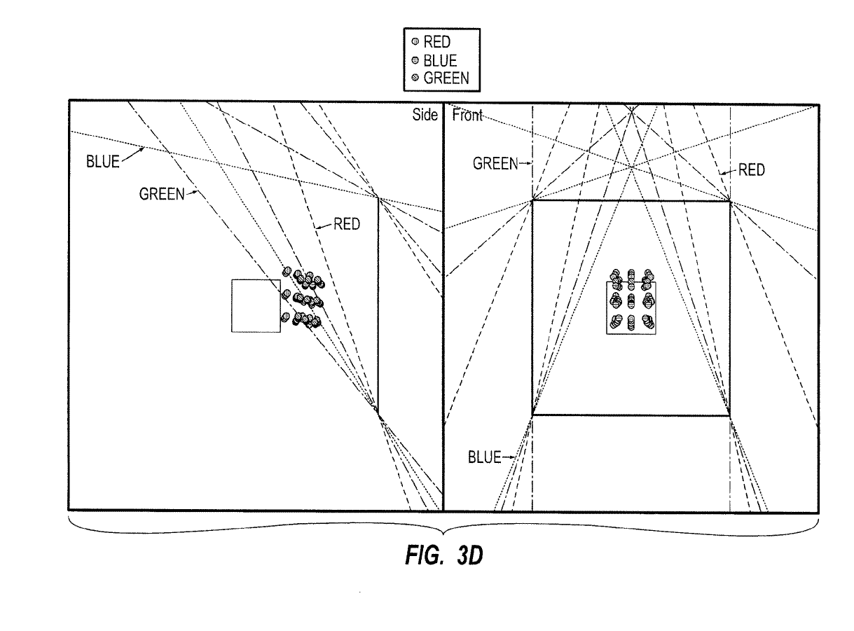

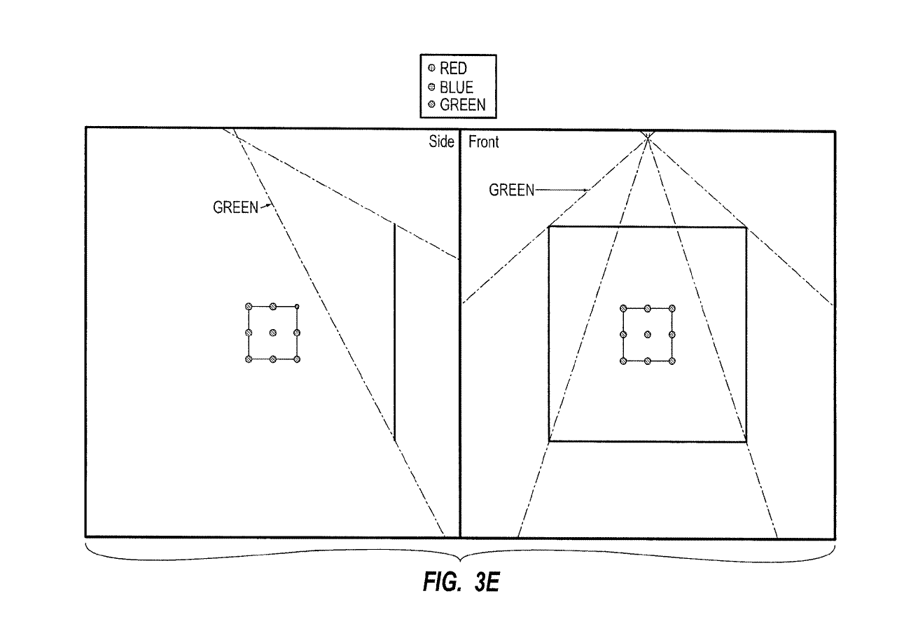

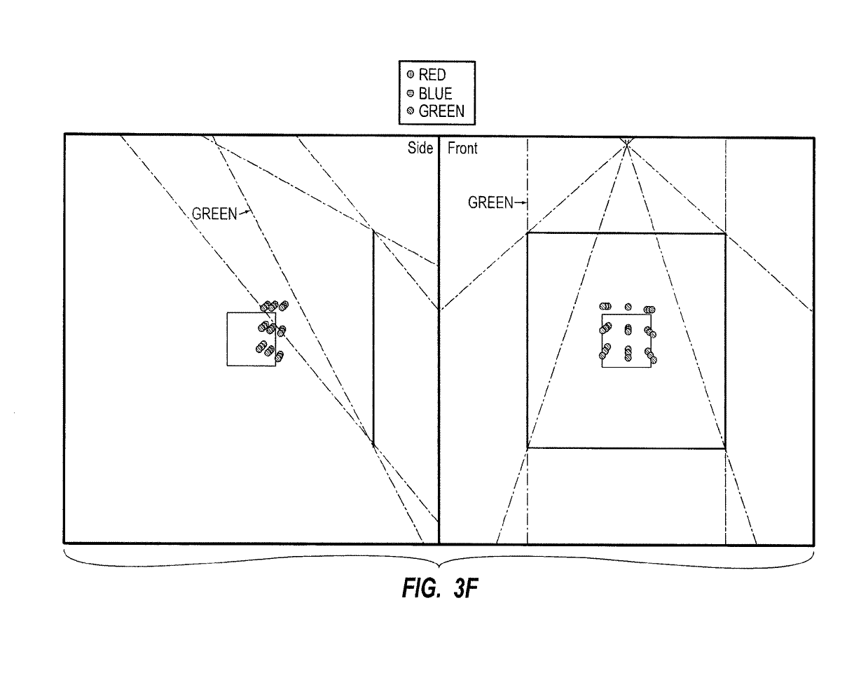

described above: to do so, each of the present disclosure's single-color holograms is made with substantially identical image positions and sizes in lateral dimensions (the two directions substantially parallel to the holographic films) but with suitably calculated different image positions and sizes in the axis substantially perpendicular to the films (which is referred to as the z-axis). For example, if the mathematics provided by Bazargan predicts that for a certain red wavelength the red image point occurs at a z-axis distance from its film of 60% of the corresponding z-axis distance for the corresponding green image point, and that the corresponding blue image point occurs at a z-axis distance from its film of 140% of the corresponding z-axis distance for the corresponding green image point, then the reciprocals of these scales indicate that in the present disclosure the red hologram should be stretched in its depth axis by a factor of 1/0.6 (or approximately a factor of 1.66), and the blue hologram should be compressed in its depth axis by a factor of 1/1.4 (or approximately a factor of 0.71). For completeness, the green image point would be at 100%. If this is done then the red image point from the red hologram, the green image point from the green hologram, and the blue image point from the blue hologram overlap in all three dimensions so long as allowance is made for any shrinkage or swelling of any of the holographic recording films and for the differing distances from the individual films to the observer as described above.
replay references at dispersion compensated angles of, respectively, 63.9°, 48.3° and 38.9° and with recording z-scales of, respectively, 84% (=447/532), 100% and 120% (=640/532).
white light split into broad nominally red blue and green bands each with a bandwidth of several tens of nanometers, this technique can be used to substantially reduce the effects of the longitudinal chromatic variation by ensuring that the visually dominant wavelengths of each color band are corrected exactly or nearly so: this results in a substantial or complete overlap of the three bands, providing a reduction by a factor of about three in the remaining longitudinal chromatic variation.
the same proportion then a gray-scale hologram may be achieved without significant color content but with greatly improved sharpness in the z-axis.
equations as described by Bazargan, or they may be established experimentally by producing and assembling test stacks (films and filters) in which the positions of image points can be measured using a ruler or other depth-measuring instruments or techniques. A similar experimental, computational, or blended technique can be used to determine any residual origin, offset, or scale errors in any of the three dimensions for any of the color images relative to any of the other color images, and corresponding corrections can then be designed into the production of the corresponding filters or holograms. In extreme cases, this technique may even be used to correct for gross discrepancies between the recording and replay conditions of each hologram, for example to produce a hologram which yields the desired geometry when replayed with a substantially non-collimated reference beam even though recorded with a substantially collimated reference beam, or vice-versa, though in more extreme cases such as this it may also be desired to make spatial variations in the performance specifications of the filters so that, for example, their bandwidths or band-centers vary radially from the central z-axis outwards or linearly from top to bottom or from side to side. Further, these techniques can be used to exploit the inherent magnification or minification of a hologram recorded and/or replayed with reference light which is significantly uncollimated: for example, holograms can be recorded with substantially collimated reference beams and replayed with divergent beams, and the resulting magnification and distortion of the holographic image can be substantially or completely eliminated or even converted to a degree of minification, and this can be achieved for each component color in the context of the present disclosure even though the degree of magnification or demagnification and other related distortions in such circumstances are generally wavelength dependent. As an example, FIG. 3A shows side and front views of an exemplary system analogous to that of FIG. 2C, but in which the recording reference beam is collimated and the replay reference beams are strongly divergent: substantial color-breakup is evident, along with substantial geometric distortion even for each single color. FIG. 3B shows that such color breakup and distortion can be corrected for each single color (the 532 nm case is shown in FIG. 3B) by using an exemplary convergent recording reference beam matching the divergent replay reference beam. FIG. 3C shows that a similar but less complete correction can be obtained even when using an exemplary collimated recording reference beam with strongly divergent replay reference beams by modifying the x-scale, y-scale, and z-scale of the content recorded by each hologram so that upon replay the distortions and color breakup introduced by the vergence mismatch are substantially corrected by in general corresponding but substantially opposite modifications in the recorded content (in FIG. 3C, x-scale=150%, y-scale=200%, z-scale=200%). Even this residual geometric distortion can be corrected for to a very high degree by, for example, calculating the x, y, z recording coordinate for each pixel of the original content which results in replay of the pixel at its correct position, in effect resampling the original content on a pixel-by-pixel, slice-by-slice, or region-by-region basis to pre-distort it prior to recording it such that upon replay it is substantially undistorted. And the color-breakup which results from the geometrical distortion being color dependent can similarly be corrected for to a very high degree by repeating this pre-distortion process independently for each replay color.

FIG. 3D, FIG. 3E, and FIG. 3F show respectively similar exemplary systems as FIG. 3A, FIG. 3B, and FIG. 3D but with the observer's location moved close to the hologram (300 mm) and substantially away from the z-axis (25° to the left and 25° up): the case with matched references (FIG. 3E) still exhibits excellent correction, and even the case with collimated recording, strongly divergent replay, and simple scalings along each axis (FIG. 3F) is partially corrected. Replay vergence and reference angles may also be adjustable and controlled during replay, for example to optimize holographic image quality as a motion-tracked observer moves, or to generate varying distortions and colors for artistic or aesthetic effects.

As a more detailed example of the present disclosure's color aspect, the present inventors have built an exemplary demonstration full-color holographic display upon the above described principles.

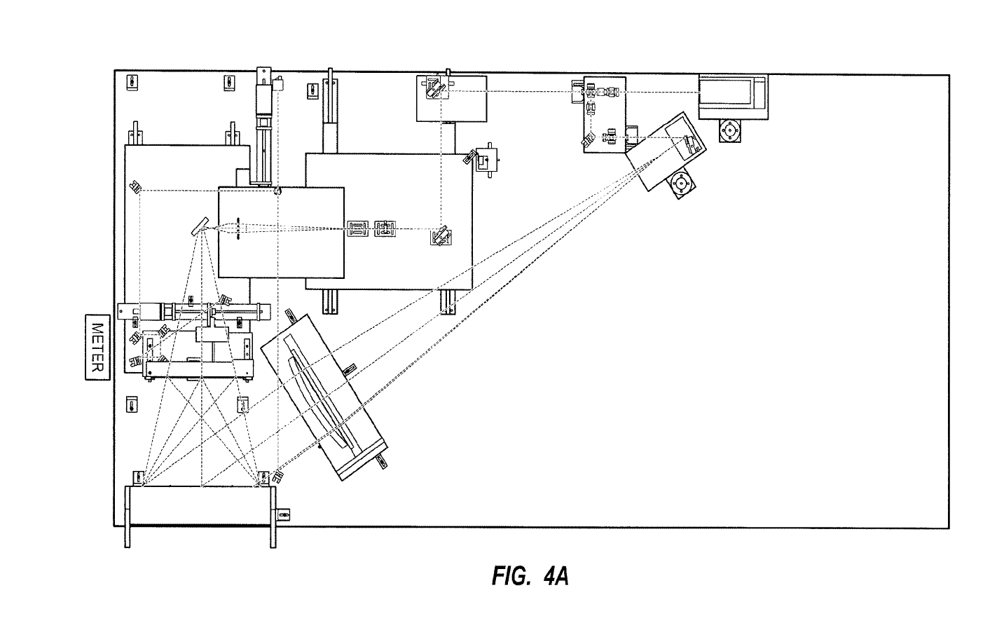

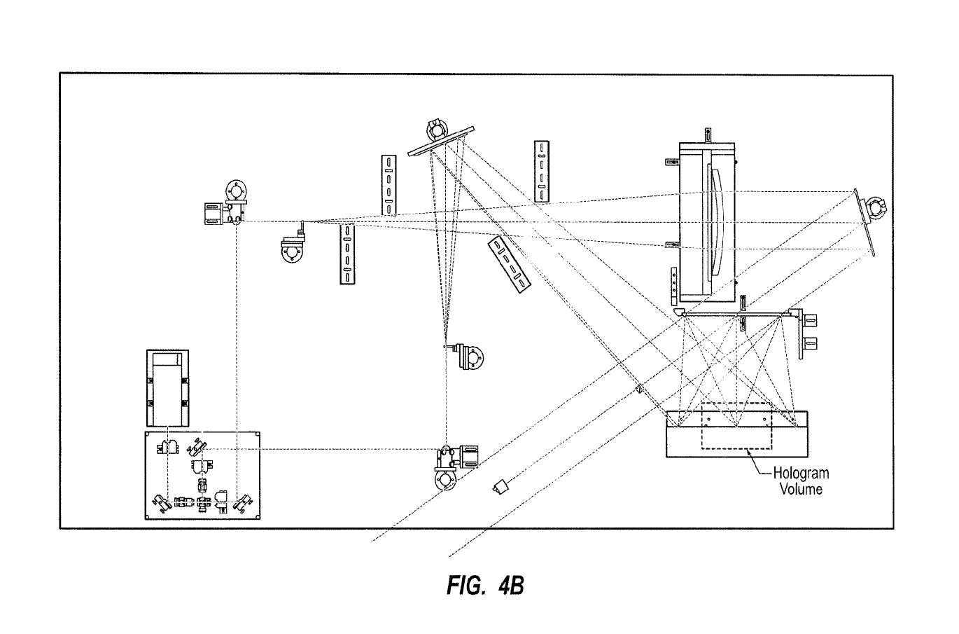

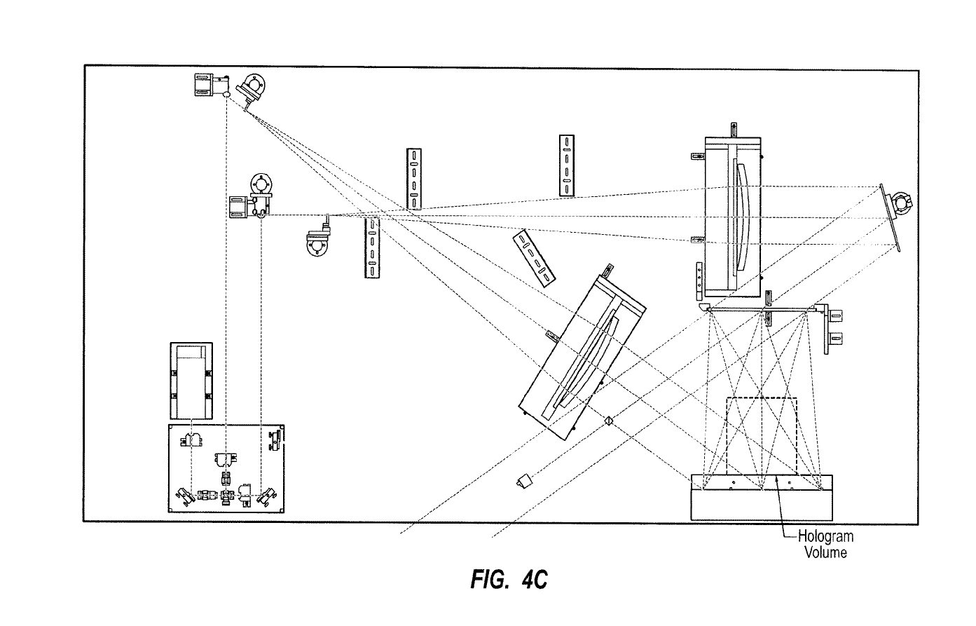

We used three hologram films, one each for red, green, and blue. We used a two-step multiple-slice sequential-exposure holographic process as described in Hart [U.S. Pat. No. 6,151,143 and CIPs thereof] with master holograms recorded in approximately 14 inch by 17 inch Agfa Gevaert 8E56 emulsions factory-coated on approximately 0.006 inch thick polyester substrates and processed in a developer formulated with ascorbic acid and phenidone-B and a bleach formulated with sodium dichromate (and low-chloride water) using a Colex RTK20SP automatic film processor [Colex Imaging Inc., Paramus, N.J.]. These master films were copied into a similar holographic film (a custom material manufactured by Konica [Konica Corporation, Tokyo, Japan], though the aforementioned Agfa 8E56 would also have been quite suitable) and processed in the same way as the masters. For the master films (FIG. 4A) we used a substantially collimated reference beam angle of approximately 56.3° and substantially P polarization. For the copy films (FIG. 4B) we used an uncollimated reference beam with approximately a 3° full-angle divergence over a 6 inch by 7 inch copy film, a reference angle of approximately 48.3° at the film center, and substantially P polarization. Master-to-copy physical and optical separation was approximately 14.5 inches, which with our recording system (substantially as described by Hart) resulted in an accessible image volume for the real image in the copy films from approximately 4 inches behind the film to approximately 6 inches in front of the film. These masters and copies were all recorded at approximately 532 nm using an OEM-version of a Coherent 100 mW diode-pumped solid state laser [Coherent Laser Group, Santa Clara, Calif.]. This example illustrates the preparation of “copy” or “H2” holograms from “master” or “H1” holograms, however the present disclosure can also be practiced using master holograms without copying, or using third generation (or greater) holograms copied from H2s.

To reduce scatter noise from the backing layer on the Konica material we used a dilute (approximately 10%) solution of household bleach to remove the backing layer. In general it is greatly advantageous to take any possible precautions to reduce sources of noise in the hologram films of the present disclosure or which may result from scatter or other undesirable effects including stray light within or between the films and the other optical components desired or used to implement this disclosure during hologram replay and hologram recording. For example, the content and positioning of elements within the holographic images, and the distribution and other details of the slabbing, feathering, or shelling of the content (as described below) may be adjusted manually or automatically to reduce the number of sequentially recorded holograms (which generally improves the brightness and contrast and reduces the noise) and to prevent the occurrence of exposures which contain very little information (such as a few isolated non-dark pixels) and which hence generally use lengthy exposures which may be impractical or commercially undesirable and which may make them more prone to vibration and other disturbances tending to prevent the recording of bright clean holograms.

Hart teaches that the beam ratio between the reference and object beam should be kept substantially uniform from one sequential exposure to the next and should have a value which tends to unity as the number of such exposures increases. The following empirical formulae work well for the beam ratio and the exposure energy for mastering as functions of the number of sequential exposures N (in the range N=1 to approximately N=100) recorded in materials similar to Agfa 8E56.

Beam ratio k=reference power/object power=6.153832543*N̂(−0.334672624)

Exposure energy (in μJ/cm²) for each sequential exposure E=18.22665*N̂(0.4796472)

The resulting k and E values for each value of N can be pre-computed, tabulated, approximated, and/or derived by other formulae than those shown above yielding similar values.

These formulae may be used in conjunction with a measured or estimated reference beam power at (and normal to) the recording material Pr (in μW/cm²) and a measured or estimated object beam power at (and normal to) the recording material Po (in μW/cm²) to calculate a suitable effective exposure duration t_{effective} (in seconds) for each sequential exposure recorded in materials similar to Agfa 8E56 using, for example, the following formula.

t_{effective}=E/(Po+Pr)

A suitable actual exposure duration t_{actual} (in seconds) for each sequential exposure recorded in materials similar to Agfa 8E56 may be calculated using, for example, the following empirical fifth-order polynomial formula to compensate for reciprocity failure over approximately the range from t_{effective}=0.02 seconds to t_{effective}=50 seconds.

t_{actual}=10̂(0.04704082954975890+1.08351170247430000*Log₁₀(t_{effective})+0.11749593991745200*Log₁₀(t_{effective})̂2+0.00018336117455206*Log₁₀(t_{effective})̂3−0.01827231737567560*Log₁₀(t_{effective})̂4)

Resulting t_{actual} values for a convenient range of t_{effective} values can be pre-computed, tabulated, approximated, and/or derived by other formulae than those shown above yielding similar values.

For recording images which would use lengthy exposures (which is generally undesirable for reasons including those described above), a satisfactory result may generally be obtained by allowing the beam ratio for such an exposure to exceed the value indicated by the above formulae to a sufficient extent that t_{actual} (allowing for the reciprocity correction) does not substantially exceed a chosen maximum (for example, 20 seconds may be a practical and t_{actual}) convenient choice for t while maintaining substantially the effective exposure energy indicated by the above formulae. This process is referred to as “reference boost”.

Other effective noise-reduction techniques employed by the present inventors include careful control of the degree and orientation of polarization of object and reference beams to maximize their mutual interference, and clean-working chemical processing to avoid photo-chemical and mechanical sources of noise in the films such as fogging, chemical color casts or contamination, surface abrasions, dents, scratches, and other such damage.

Using copy holograms as described in Hart is potentially advantageous because, among other benefits as described in Hart, it can be used to convert a deep-image hologram which recreates entirely on one side of the master film and at some considerable distance from the master film (about 10 to 18 inches in our implementation of Hart) into a shallow-image hologram in which the holographic image is closer to and may even exist on both sides of (i.e., straddle) the copy film. Otherwise in general it is difficult to make a shallow-image transmission master hologram because the mastering reference beam for a transmission hologram is incident upon the recording material from the same side as the mastering object beam, though this issue can in part be addressed by, for example, the use of edge-lit geometries, the use of steep mastering reference beams, or the use of re-imaging optics introduced between the diffusing screen and the recording film in Hart's mastering geometry. As another option, especially if a landscape-mode copy is desired from a portrait-mode copy, or vice versa, a tight fitting geometry which is referred to as “crossed references” can be used which has a side reference beam for one reference and an overhead reference beam for the other, in which case one can be P polarized at its film and the other S polarized at its film (because at the copy film both are then in the same polarization direction) which can be better than the conventional approach (in which both beams are in the same polarization state at their respective films) because it can yield more uniform diffraction and can be less sensitive to polarized scattered light.

In so far as deep-image holograms are or may be blurred or otherwise indistinct due to their image falling too far from their film if a broadband illumination source is used in the context of the present disclosure, any such blurring or other lack of clarity may be less evident in a shallow-image copy of such a master. However the use of narrow band sources in the context of the current disclosure permits sharp replay of even deep-image holograms: the present inventors have, for example, viewed a series of crab images (as described below) in the form of deep-image master holograms at depths of approximately 10 to 18 inches very satisfactorily. Another aspect of the use of master or copy holograms in the present disclosure is that each may have, and may be optimized somewhat differently to have, different viewing angles, vertically and horizontally. A comparatively large master film can capture and replay wide viewing angles of a comparatively small region, but even a similarly or equally large copy of this same master may have reduced viewing angles due to constraints associated with bringing the copy and the master reference beams to their respective films during the copying process. These constraints may be reduced (and hence the copy's viewing angles potentially increased) via the use of edge lighting, steep references, reimaging optics, or the crossed-reference geometry as described above. On the other hand, the vertical or horizontal viewing angle of a master hologram in the context of this disclosure, or of a copy thereof, may desirably be reduced or made asymmetric, non-rectilinear, or intermittent for artistic or aesthetic effects or to increase the brightness or contrast of the hologram.

The Agfa 8E56 material is an example of a holographic material which, depending on the processing regime used, can post-processing retain a degree of photosensitivity such that upon subsequent exposure to light, especially to bright blue or ultraviolet light, a process of photolytic silver grain formation occurs and via this or other effects (generically termed “printout”) such a material gradually darkens. This can be used to create holograms with a deliberately limited lifespan: such holograms darken with use such that after a predictable period of use they become sufficiently less bright as to be unsatisfactory or unusable. The present inventors have also observed that printout in some material/processing systems can in fact improve the image quality of holograms because scatter noise, perhaps attributable to the presence of photosensitive grains of certain sizes, may darken more rapidly or before the holographic image itself does, and hence printout can improve a hologram's image contrast and may advantageously be induced, accelerated, or promoted deliberately by, for example, subjecting a hologram to intense light, especially blue or ultraviolet light such as can be provided for example by Q-Panel's UV-enhanced fluorescent lamps [Q-Panel Company, Cleveland, Ohio]. This deliberate induction of printout may also be accelerated by immersion of the target hologram during this light exposure in a developing agent such as, for example, a weak solution of ascorbic acid. Printout may be avoided, or slowed, even in materials such as Agfa's 8E56, by the use of a desensitizing bath or ingredient prior to, during, or subsequent to photographic processing, and in the context of the present disclosure one or more of the component color films may be partially or substantially shielded from the desired actinic light because of its location within the film/filter stack. For example, in the present inventors' color demonstration, as described herein, only the outermost film facing the observer is directly exposed to ambient light, the other films being behind filters which filter out portions of any such external ambient light before it can reach these other films. Similarly, the outermost film receives from the illumination source only that proportion of the colors of light for which the other films are responsible which those films direct into their respective images, but is substantially protected by the filters from the remaining portion, if any, of the un-diffracted reference beams of these colors. Further protection from printout induced by the internal sources and any external sources of actinic light may be provided by the addition of respectively back and front protective windows or covers to reflect back or absorb the most harmful wavelengths such as in particular those in the ultraviolet region.

Such front and back windows may in any case be desirable to hold the front and back films in place and flat, and in the case of the front window to protect the front film from scratching and impacts either accidental or on the part of a malicious or curious observer, and in the case of the back window to protect the film/filter assembly from infrared heat generated by the illumination source (very little such heat is generated if laser sources are used, but LEDs and especially incandescent white light sources can be significant heat sources).

The “object” for each of the three holograms in the present inventors' color demonstration consisted of a series of two-dimensional images as described by Hart, though in this case we used a selection of corporate logos rather than radiological imagery and we assigned each color component of each logo to an arbitrary z-depth to achieve a visually pleasing distribution of content in color and all three spatial dimensions. The original full-color digital file of the artwork for each logo was color-separated and color-corrected using the built-in commands of the ImageJ image processing program [Wayne Rasband, National Institutes of Health, Bethesda, Md.]. Each such two-dimensional image was recorded (FIG. 4A) in series generally as described by Hart, using a Sony LCX016AL LCD projected and magnified onto a holographic diffuser [LSD, Physical Optics Corporation, Torrance, Calif.] with an approximately 45° symmetric full-angle diffusion and its diffusing side facing away from the recording material (the side which does face the recording material can beneficially be anti-reflection coated to reduce scatter and halation within the diffuser and mirror images between it and the recording film). Other film production details were broadly as described by Hart, including gamma control and superblacking implemented in a combination of ImageJ and our proprietary hologram production software, copying (FIG. 4B), and replay of the copies using an example of Bazargan's dispersion-compensating display with a grating matched for 532 nm at 48.3° (this angle was chosen empirically because if the otherwise generally preferable 56.3° is used (Brewster's angle as discussed above), Fresnel reflection losses can be severe, especially for the red end of the dispersion compensated spectrum which passes through the optical layers of the dispersion-compensating display, as described in more detail below, at steeper angles).

Gamma correction was based upon the use of a Look-Up-Table (LUT) to provide the desired exponential ramp matching the response of the human eye, the lookup table being computed from the measured grayscale response of the Sony/POC projection system. Color-matching and white-point selection could have been achieved by using a different LUT for each color film. The use of LUTs is a practical convenience for computational efficiency, but since a LUT contains essentially an indexed record of a series of computations or estimations its use can generally be replaced by execution of the computation or estimation as and when the desire arises.

In addition, we calculated z-scale offsets and scales for each film to allow for the correction of Bazargan's longitudinal chromatic scale-dependence as described above. In so calculating we allowed for the known thicknesses of our hologram films and of our filters. Rather than using the full form of Champagne's equations we noted that we had a special case with simplified math: specifically, for this special case in which each film is made using a collimated reference beam with the same reference angle and green laser wavelength and is replayed using our color method in an example of Bazargan's dispersion compensating display implemented with collimation and a compensation grating made for the same reference angle and green wavelength, 1) the green image did not use z-scaling, and, since our G film was the final element in the stack (i.e., was closest to the observer), also did not use a z-offset, 2) the B film included a z-scale in the same proportion as the predominant blue and green wavelengths used for its reconstruction, and included a z-offset allowing for its own optical thickness and the optical thickness of the St filter, and 3) the R film included a z-scale in the same proportion as the predominant green and red wavelengths used for its reconstruction, and included an additional z-offset allowing for its own optical thickness and the optical thickness of the Pi filter.

To construct the dispersion-compensated display, we used a modified example of Holorad's Voxbox Model-22 [Holorad, Salt Lake City, Utah] implementing Bazargan's device including its housing, Fresnel lens, and grating. We also used its anisotropic material, a sheet of Holorad's Voxblock material which performs a function akin to the 3M LCF described by Bazargan but which is, as described below, superior for our purposes. The standard Model-22 Voxbox uses a broadband halogen lamp: we substituted a tri-color LED illumination source based on individual red green and blue LEDs [PhlatLight PT120 Projection Chipset, Luminus Devices, Inc., Woburn, Mass.] with beam-combining optics in the form of a Samsung BP96-01725A [Samsung Electronics America, Inc. Ridgefield Park, N.J.] as used in the Samsung's HL-T560875 rear-projection television. Whereas Samsung uses these parts for time-series illumination of each color, and hence wires the LEDs in parallel so each can be activated individually at full (18 Amps) or reduced power, we rewired the LED's in series and ran them continuously (DC mode in Luminus's nomenclature) powered by an BK Precision 1621A variable power supply [BK Precision, Yorba Linda, Calif.] operating in constant voltage mode at approximately 4.5 Volts and approximately 10.9 Amps. We retained the fan-based air cooling system Samsung use in the HL-T560875, substituting this for the Model 22's standard fan cooling, though conductive cooling could have been sufficient given the inherently high wall-plug efficiency of the substitute LED sources.

Color-matching, white-point selection, and brightness and contrast control can also be achieved by adjusting the relative brightness of each LED, for example by introducing fixed or variable resistances between the LEDs in series or by operating them with individually selectable voltages and/or currents and/or in a Pulse Width Modulation (PWM) scheme (linear or logarithmic), or by tilting the optical components in our film/filter stack. It may be desirable to use methods such as these to supplement or override an initial step of color-matching and white-point selection and brightness and contrast control achieved in software for example using color-specific LUTs. This can be done to adjust the color-matching and white-point and brightness and contrast to better suite a specific application or environment or the visual response of an observer, allowing for, for example, inter-observer variations or the psychovisual effects of different ambient lighting conditions, either as a set-up adjustment, or dynamically in response to a light-measuring mechanism, a timer, or observer-directed control inputs.

Color matching and white-point correction are particularly useful for holograms including skin tones or edible produce or corporate identity marks such as logos, in the former two cases because the human visual system is particularly adept at noticing errors in skin tones and in the color of fruit and other edible comestibles, and in the later case because the correct and accurate use of certain colors, such as, for example, Eastman Kodak's trademarked yellow color, is commercially and legally important.

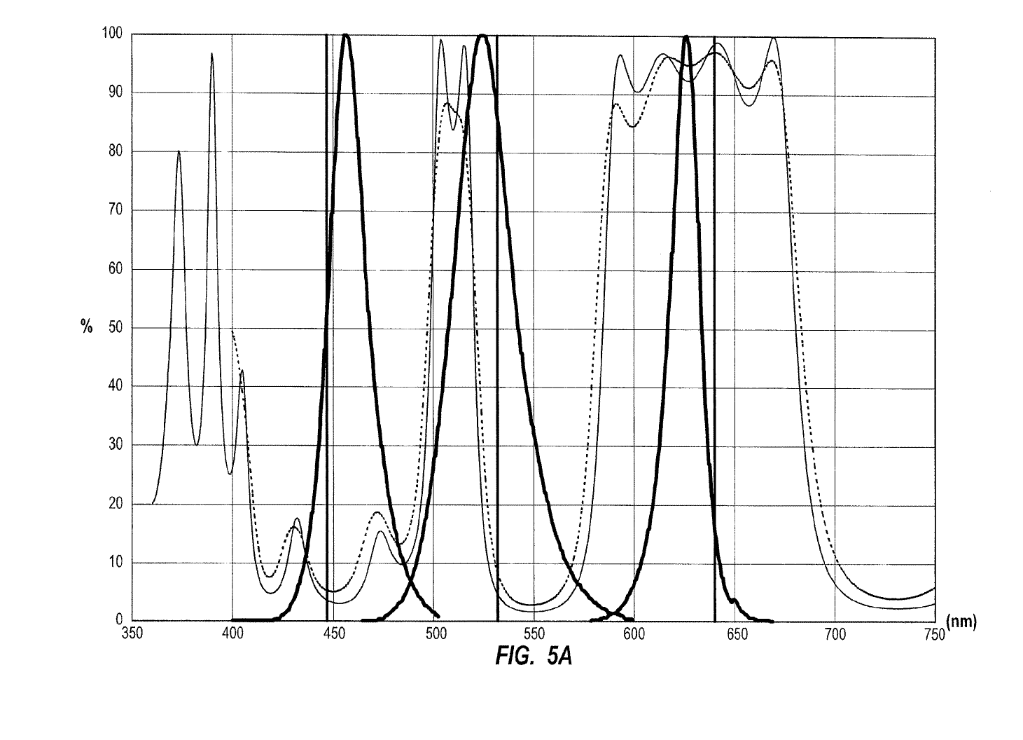

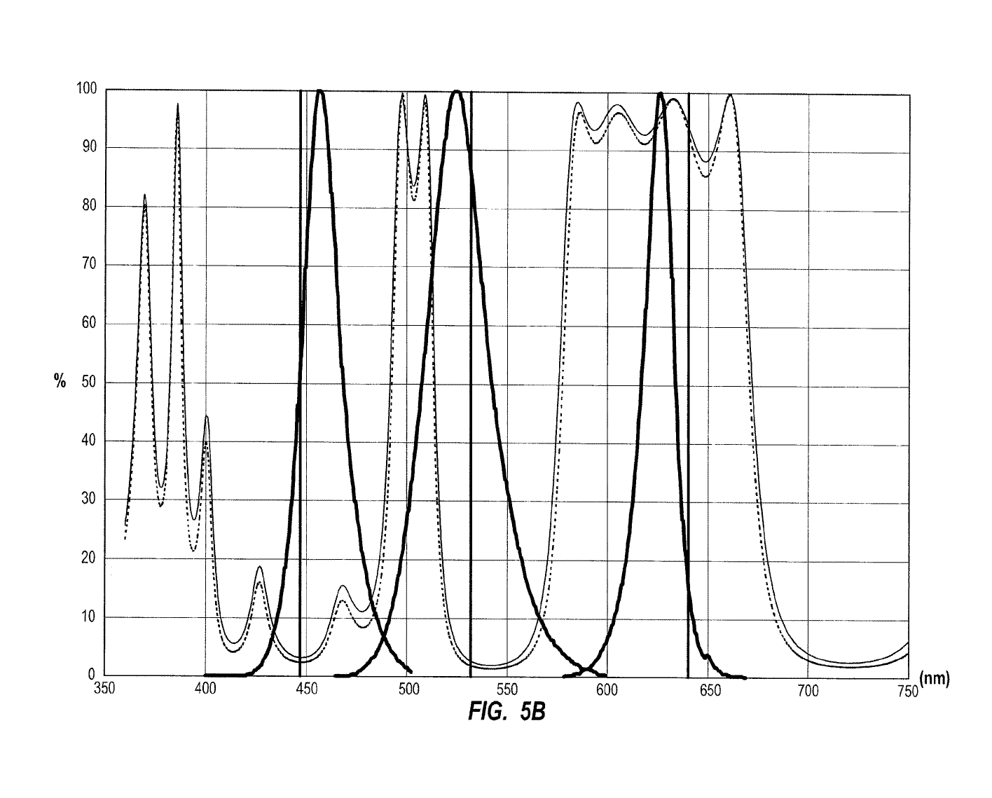

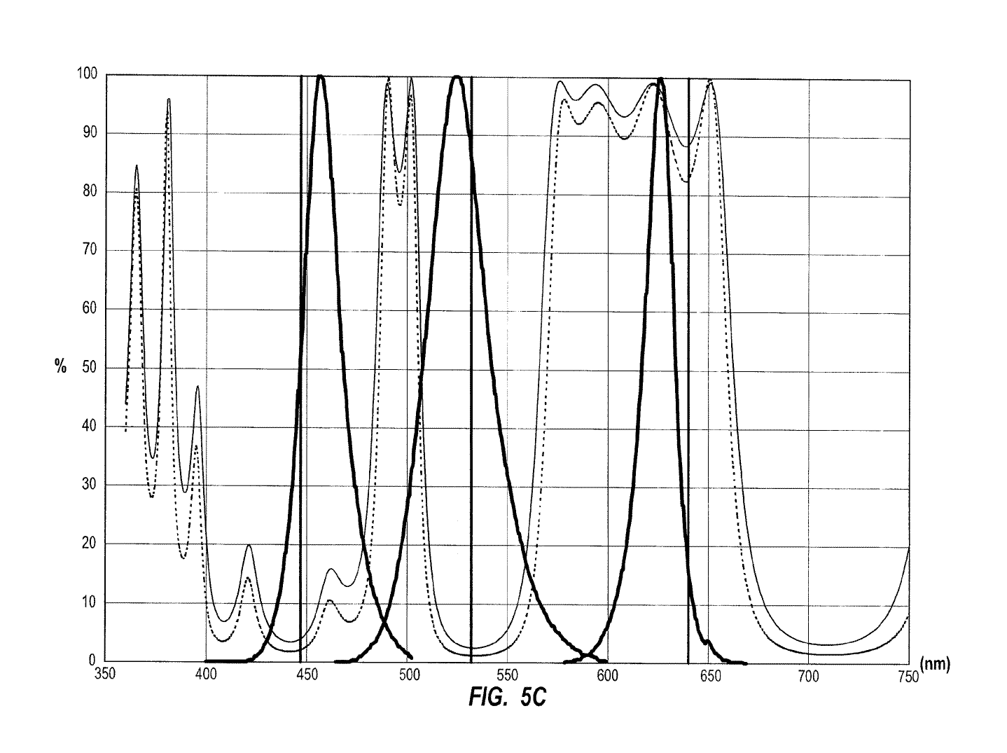

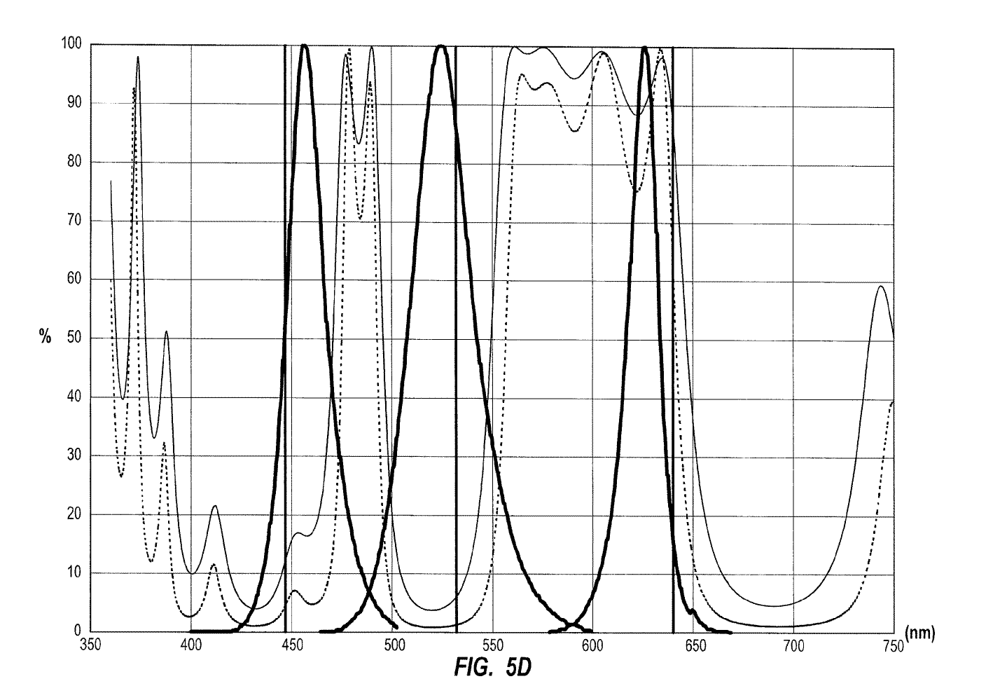

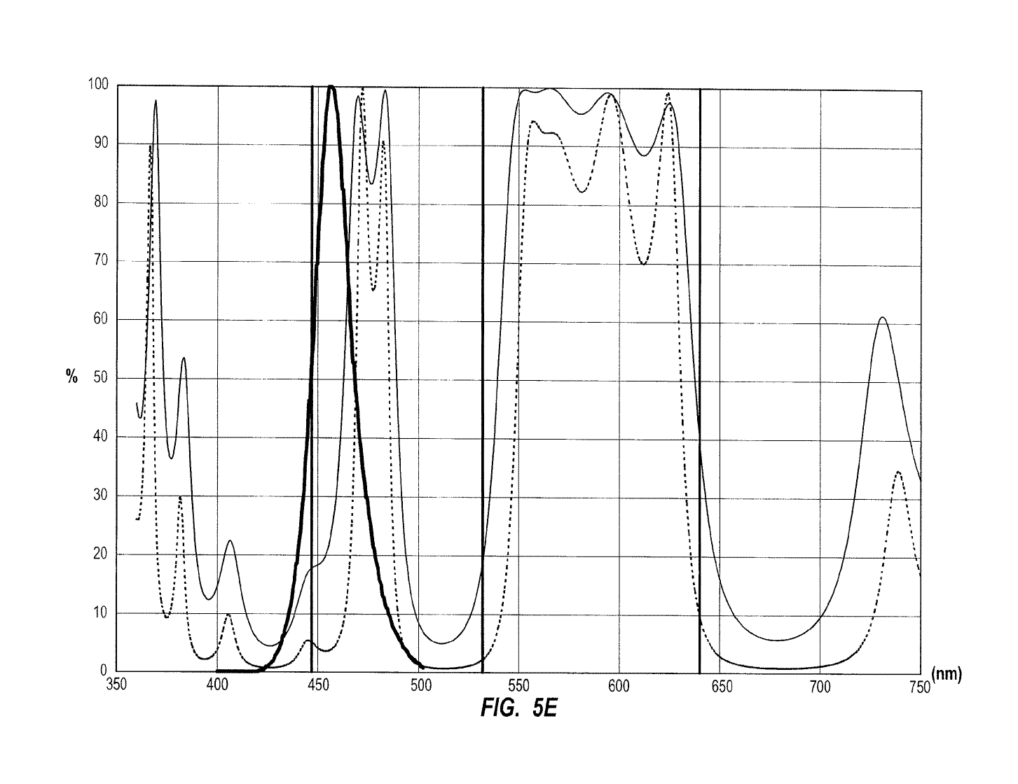

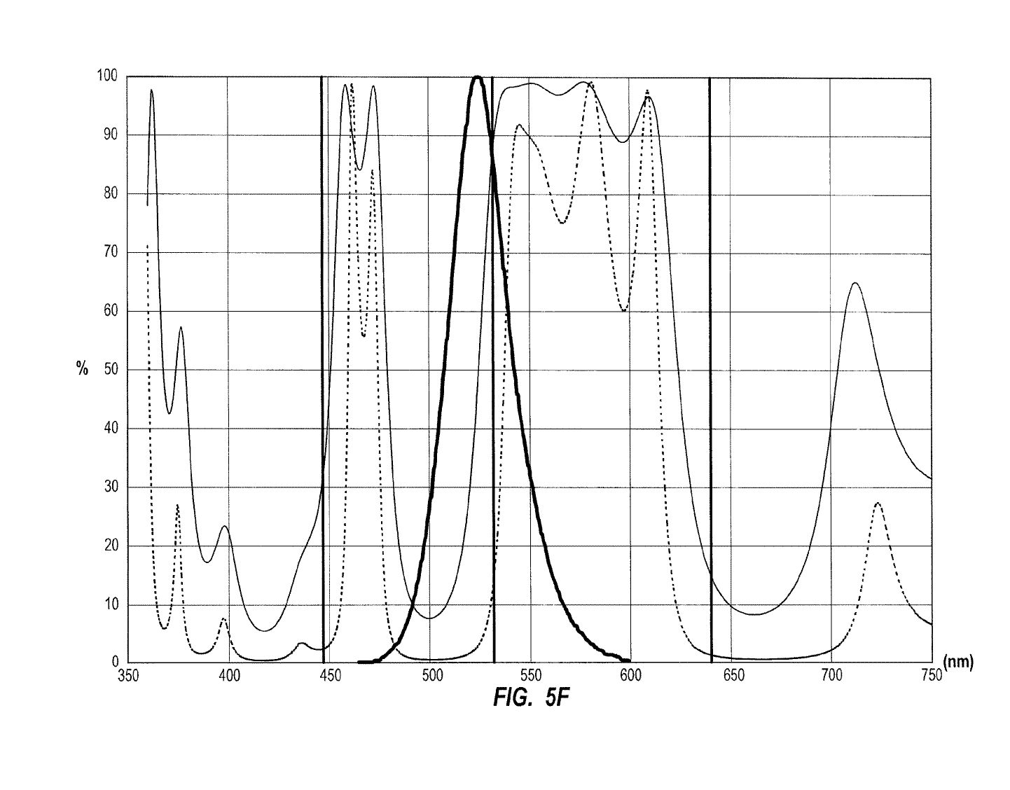

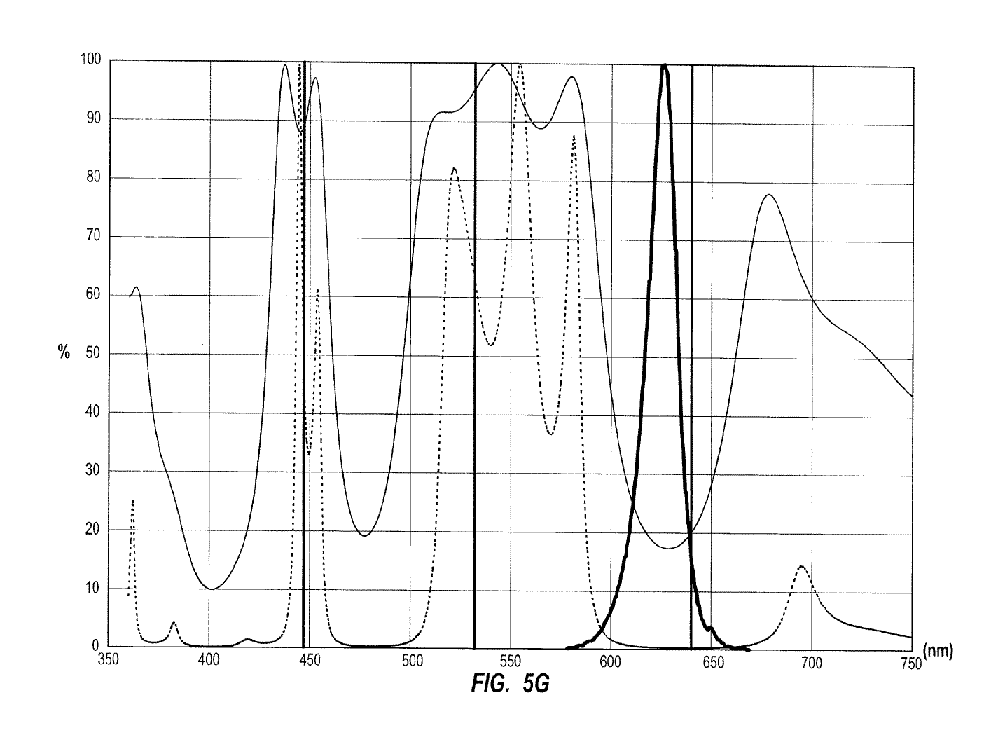

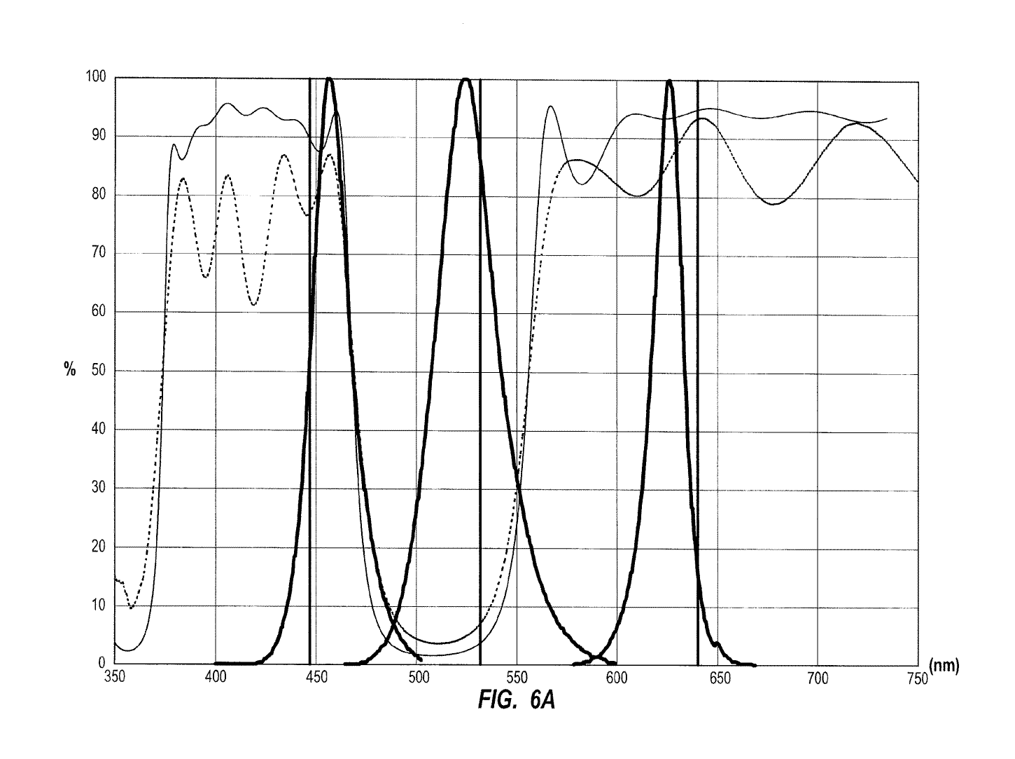

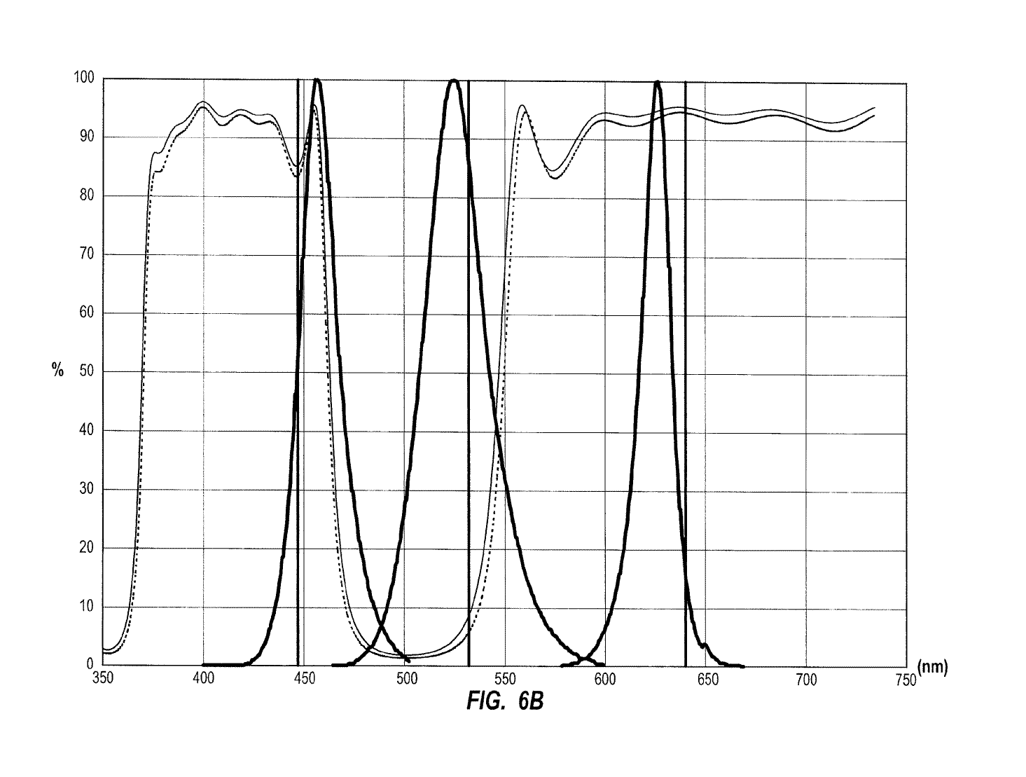

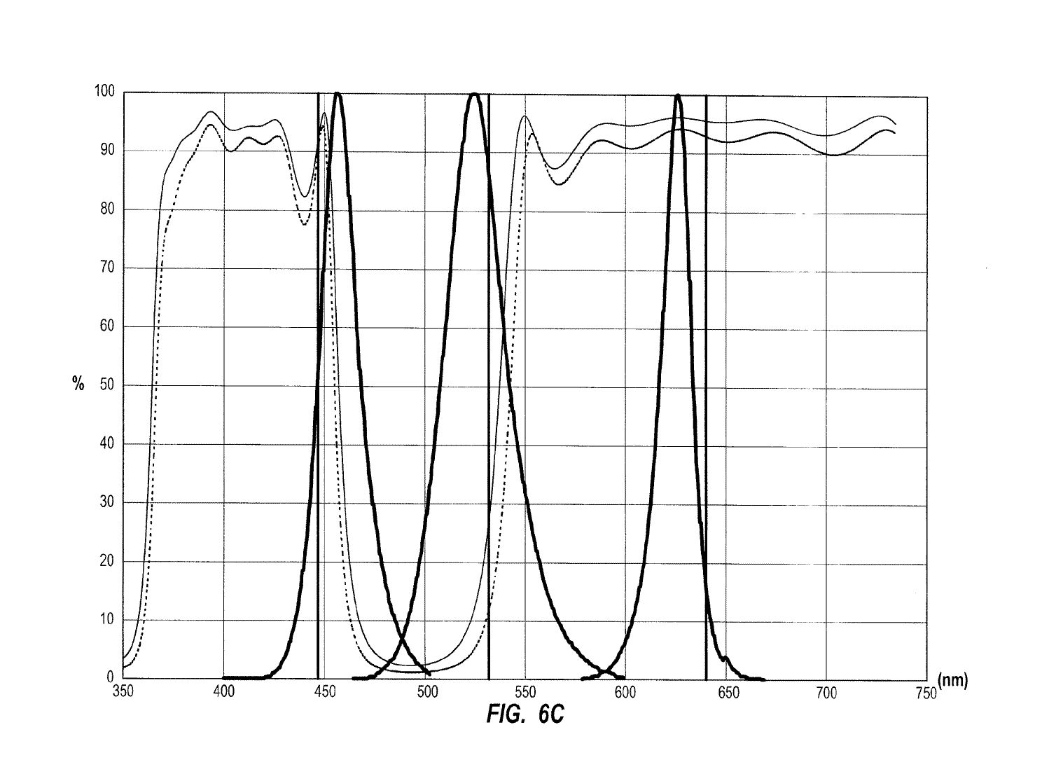

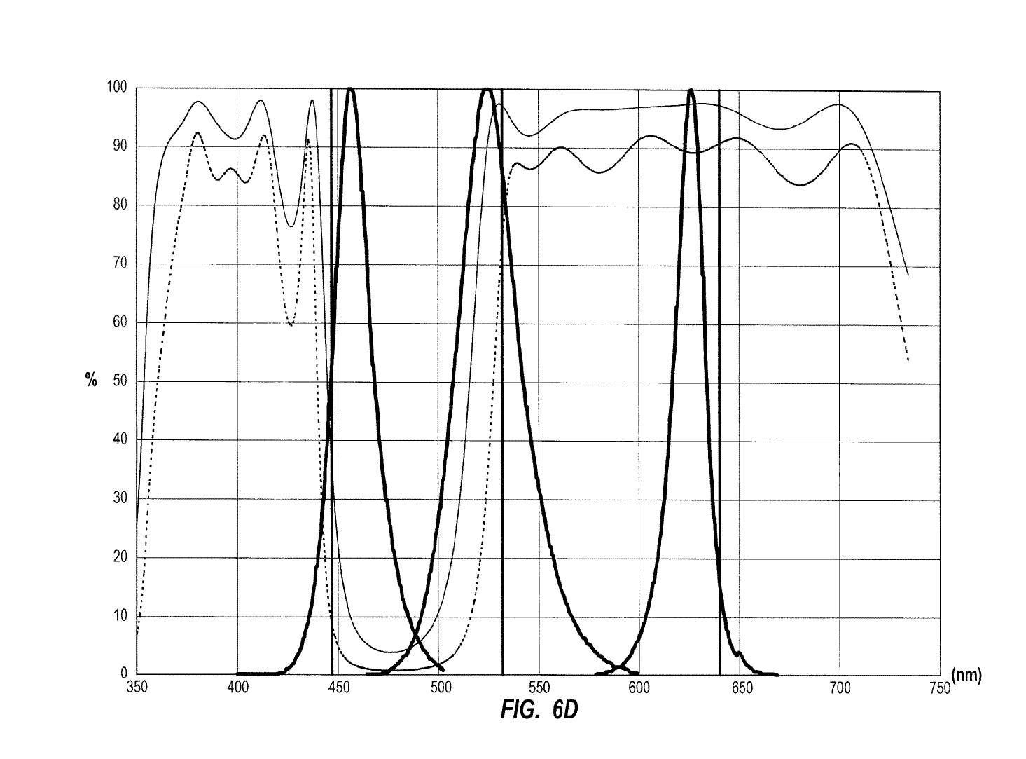

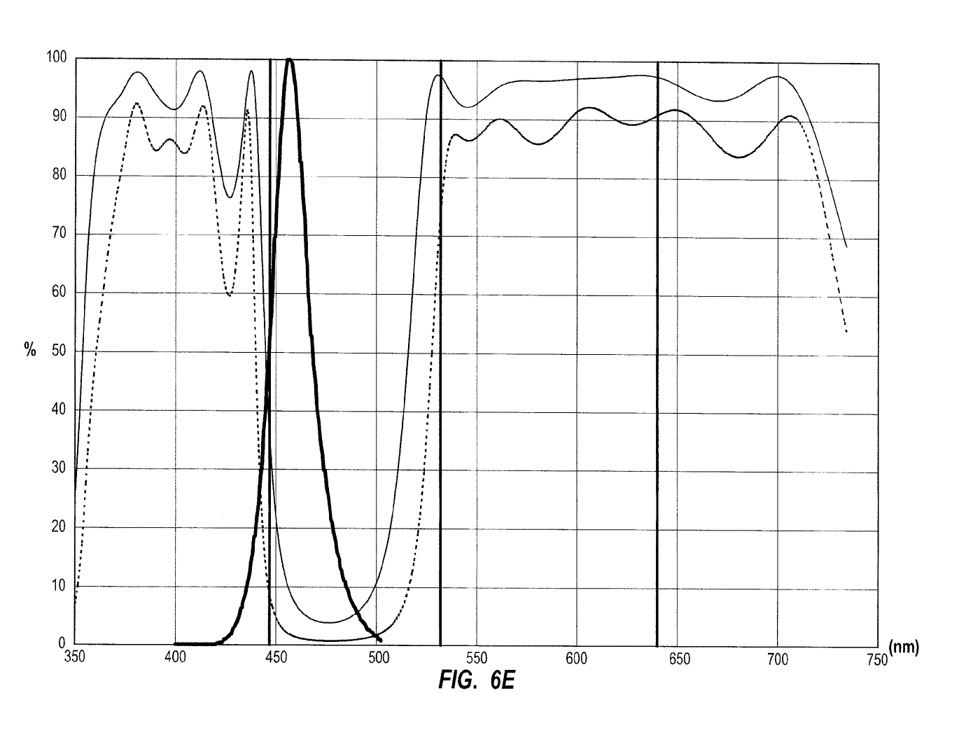

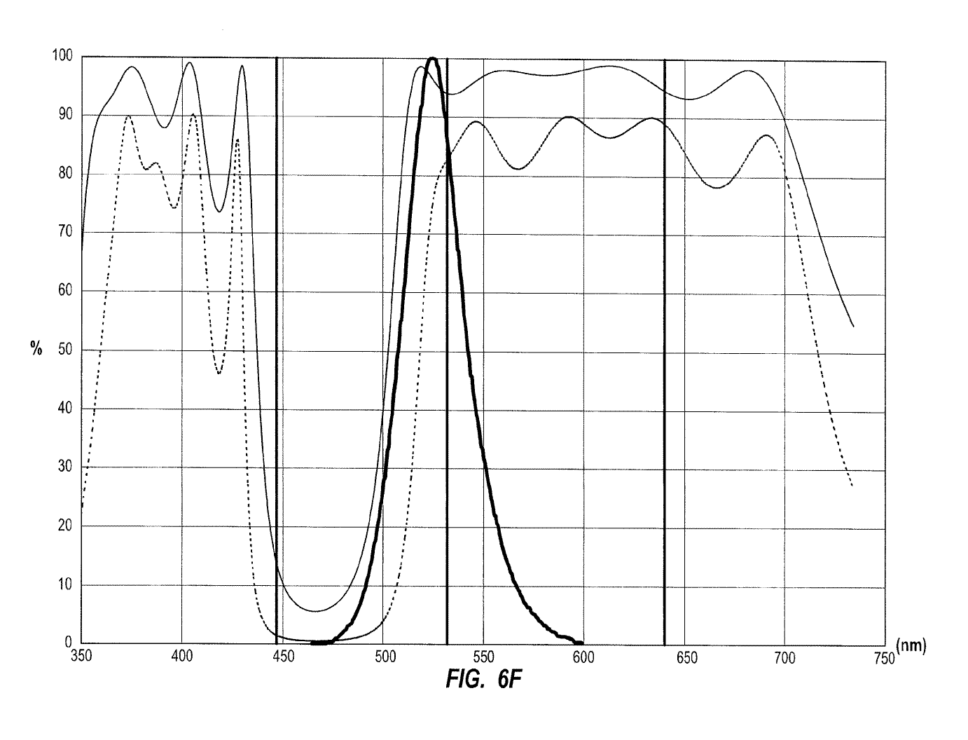

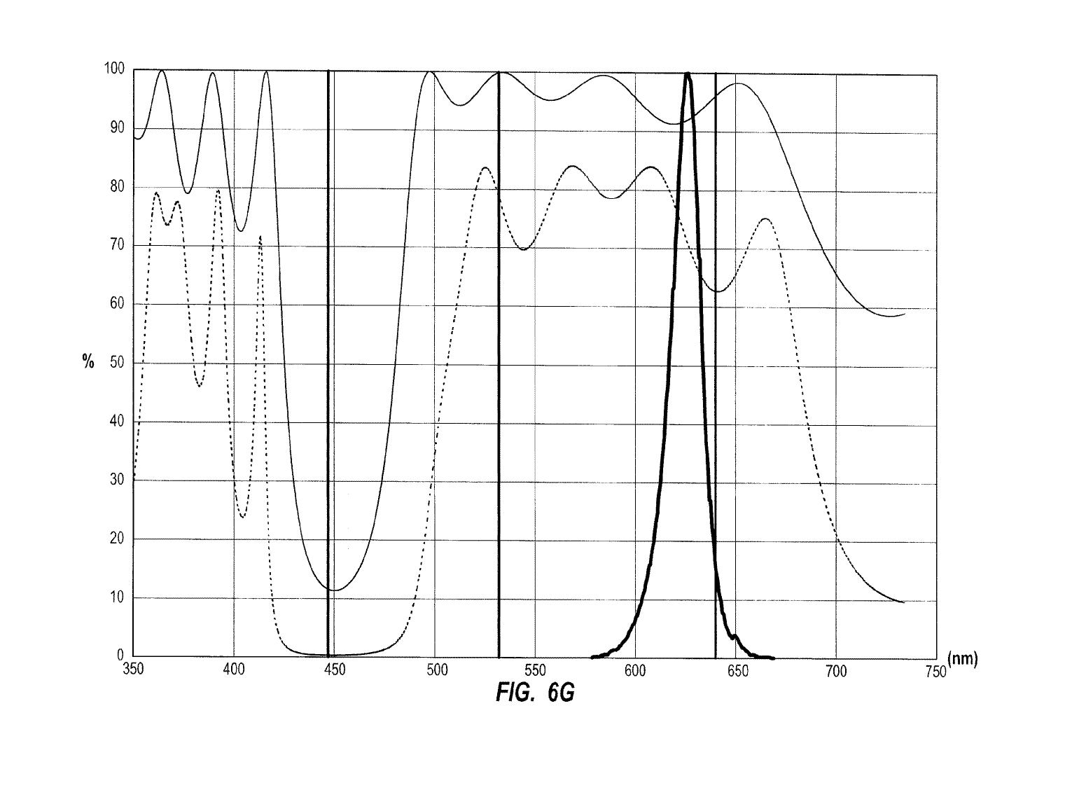

Behind the Model 22's standard approximately 3 mm thick transparent acrylic cover plate we added an approximately ¼inch thick black (to reduce scattered noise) acrylic plate with an approximately 12 inch approximately circular opening cut through it into which we mounted our three hologram films and our two glass dichroic filters. Suitable dichroics comprise, for example, for the Pi filter part number 070927-01 from Optical Filter Source, LLC [Austin, Tex.], and for the St filter part number 071011-04 also from Optical Filter Source, LLC. These filters were designed for the present inventors' color demonstration using OFS's in-house dichroic design software and FilmStar [FTG Software Associates, Princeton, N.J.] to match a specification we provided based on our own detailed calculations. Specifically, we calculated in Excel [Microsoft Corporation, Seattle, Wash.] the desired filter transmittances for each filter as functions of wavelength for each of S and P polarization in 5 nm steps from violet (400 nm) through red (700 nm) using the dispersion-compensation mathematics of Bazargan, the grating equation, the standard photopic response curve of the human eye [Commission Internationale de l′Eclairage Proceedings, 1924, Cambridge University Press], and our own measurements of the angular-dependence of the transmission, scatter, and diffraction of our gratings and holograms and of the transmission of our Voxblock material. FIG. 5 shows exemplary transmission spectra in P (solid line) and in S (dashed line) polarization of the Pi dichroic at 0.0° (FIG. 5A), 17.0° (FIG. 5B), 25.0° (FIG. 5C), and 35.0° (FIG. 5D) for image content, and 40.2° (FIG. 5E) for the blue replay reference, 47.5° (FIG. 5F) for the green replay reference, and 61.3° (FIG. 5G) for the red replay reference. FIG. 6 shows exemplary transmission spectra in P (solid line) and in S (dashed line) polarization of the St dichroic at 0.0° (FIG. 6A), 17.0° (FIG. 6B), 25.0° (FIG. 6C), and 38.0° (FIG. 6D) for image content, and 38.0° (FIG. 6E) for the blue replay reference, 45.0° (FIG. 6F) for the green replay reference, and 57.0° (FIG. 6G) for the red replay reference. Slightly different reference angles are shown for the two dichroics because they were designed and measured assuming slight adjustable tilts in the film/filter stack.

These particular filters were fabricated on approximately 3.3 mm borofloat glass, but other suitable substrate materials could have been used including for example plastic substrates which may advantageously weigh less or be less costly or less fragile or otherwise beneficial. It is also possible to use holographic filters which exhibit the desired angular dependencies, and these may be manufactured on thin flexible plastic substrates each, for example, on the order of a few thousands of an inch thick enabling the cost, thickness, and fragility of the entire stack to be considerably reduced. For example, flexible angle-dependent filters, such as holographic dichroic filters, may advantageously be laminated with or otherwise permanently or semi-permanently attached to flexible holograms.

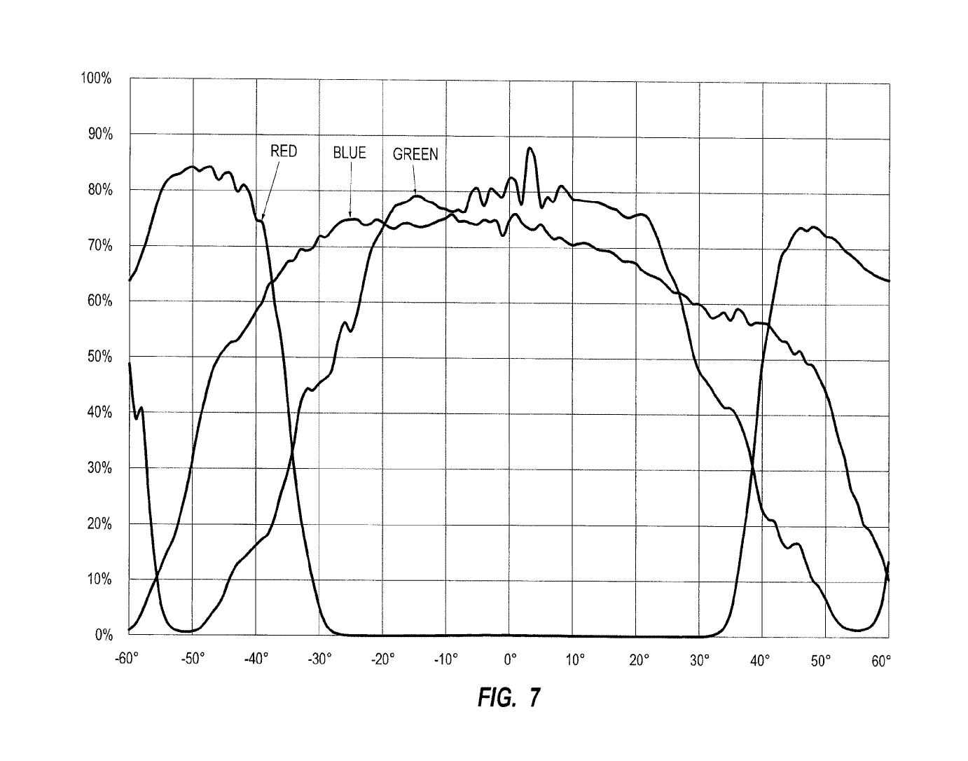

An exemplary holographic “dichroic” may be produced as follows. Dichromate emulsion is produced by dissolving approximately 45 grams of gelatin in approximately 300 ml of water at approximately 35° C. This mixture is slowly and continuously stirred while the gelatin dissolves and liquefies. Upon complete liquefaction of the gelatin, approximately 8 grams of Ammonium Dichromate is added, and the mixture is stirred at temperature for a further approximately 15 minutes. Clean glass plates are then coated with the gelatin/dichromate mixture to a thickness of approximately 12 μm, allowed to dry for approximately 48 hours at room temperature, and aged for approximately two weeks before use. The filter is recorded in reflection mode using an exposure of approximately 120 mJ/cm² using two substantially collimated 488 nm beams at approximately a symmetric angle around the plate normal. The filter is developed by hardening for approximately 30 seconds in Kodak Rapid Fixer [Eastman Kodak Company, Rochester, N.Y.], washed for two minutes in filtered water, and dehydrated by being passed through a series of baths of graded percentages of alcohol/distilled-water mixtures for approximately 1 minute each ending with a bath of 100% dry alcohol. Finally the plates were dried in filtered warm air at approximately 70° C., and, if desired, laminated to prevent the ingress of moisture. FIG. 7 shows transmission spectra of such a filter (compare with the conventional dichroic of FIG. 6).

The specific style of Fresnel lens and holographic diffraction grating used in the present inventors' exemplary demonstrations can be replaced by other kinds of, respectively, collimating and dispersing elements. For example, collimation may be achieved using solid or liquid-filled plastic or glass lenses (including TIR lenses which can be optically very fast for their thickness), or using spherical, parabolic, or higher-order mirrors, on-axis or off-axis. Embossed gratings can be used, and either kind of grating can be given optical power so that it achieves or contributes part of, or to some degree color-corrects, the collimation.

The analysis (experimentally and mathematically) and control of polarization in the present device can be quite interesting. Many of the light paths through the present disclosure are incident upon films, filters, gratings, lenses, mirrors, holograms, windows, or other optical components at quite steep angles for which there may be a significant polarization dependence in their subsequent refraction, reflection, diffraction, scattering, and absorption. This can lead to polarization dependent losses of light and hence impact overall or localized brightness and color of the observed holographic image. Introduction of additional polarization-dependent optical components (such as polarizers, waveplates, and polarization recyclers) may be advantageous, for example to polarize light from a fully or partially unpolarized source, or to eliminate or reduce polarization induced brightness variations within the holographic image or polarization induced variations in any background noise which is visible in conjunction with the holographic image. As a further consideration, observers of the holographic image may be wearing polarizing glasses, such as for example polarization dependent sun glasses, and hence it may be advantageous to ensure that the net polarization of the holographic image is uniform or negligible or aligned or otherwise orientated with respect to the anticipated polarization axes of such glasses, for example by achieving a substantially linear polarization, substantially circular polarization, or substantially unpolarized state for the holographic image via the use of, for example, an additional waveplate incorporated within the already described stack or in front of or behind it.

As a general observation regarding the design of systems such as this, whether strictly via computation, experimentally, or as a blended combination of calculation and experiment, in many cases the functional features of each filter described above can be substantially simplified or relaxed, either to simplify the design or to enhance manufacturability or operation. For example, if in the detailed example above the Pi filter removes substantially all the residual red reference beam at or near the REFr angle then there is little or no need for the St filter to also block red light at or near the REFr angle, and the red diffraction efficiency of the blue and green holograms can essentially be ignored, or, in fact, these two holograms can be individually optimized for their respective blue and green roles. Generally there are several ways like this in which each component can be better optimized if other components before and/or after it can be optimized in other ways, and, while this can partly be decided by simple theoretical arguments, in practice a somewhat detailed modeling effort allowing for wavelength and polarization dependencies can reveal unexpected opportunities for such optimizations. For example, the utility of and design parameters for antireflection coatings on one or more surface of one or more components can be estimated, as can the potential advantages of tilting components or index-matching components together. Such design calculations can be performed by hand or formulaically in a mathematics program such as Excel or in optical design software capable of modeling many or all of the significant physical effects, e.g., ZEMAX [ZEMAX Development Corporation, Bellevue, Wash.].

One goal of any such design activity may be to enhance rather than to reduce or eliminate a particular effect, such as polarization dependence, either because the end result of this is an improved holographic image, or because it can be used as an additional effect or decoration to enhance the holographic image by altering or modulating or otherwise modifying it in a permanent or temporary or varying manner. For example, an angle dependent color shift may be used for aesthetic or artistic effect, or a temporary or permanent flickering or wobbling of the image may make it more attractive or exciting.

Similarly, the holographic image may be enhanced by using it in combination with, for example, colored or shaped surrounds and enclosures, other holograms, and two-dimensional or three-dimensional text, graphics, imagery, and decorations adjacent to or in the vicinity of the holographic image or printed embossed or otherwise applied to or attached to or in the vicinity of one or more of the hologram films of the present disclosure (especially the frontmost such film) or to one or more of the other described components such as a protective front window. Such additional decorative or informative elements may also take the form of mists, fogs, smoke, gasses, fluorescent or phosphorescent, reflective, diffractive, refractive, diffusive elements which are in part or whole illuminated by the holographic image or images or by other light sources herein described (such as residual or utilized reference beams) or provided as additional illuminants for this purpose or derived from ambient light sources. Two-dimensional and/or three-dimensional static or moving or moveable objects, shapes, or devices (including sculpted, found, or specially fabricated objects, shapes, or devices) may be disposed around or within the holographic image or images: such objects or shapes or devices within the holographic image may selectively occlude the holographic imagery from certain viewpoints either permanently, temporarily, or intermittently, and may reflect or image other two-dimensional or three-dimensional images or objects into part or all of the space occupied by the holographic images.

Returning now to the exemplary color demonstration, we rigidly mounted the Samsung/Luminus source to the Model 22's base plate and introduced two extra flat folding mirrors (one a high-quality aluminum on glass mirror from Newport Corporation [Irvine, Calif.], the other a low-quality aluminum on plastic mirror fabricated for us by a local plastics shop, both mounted on Newport adjustable optical mounts (high quality optics are generally not used in the implementation of Bazargan's display device which we have found to be pleasingly immune to imperfections and damage to its optics) to route the combined white beam from this source to approximately the focal point of the Model-22's plastic Fresnel lens, via the Model 22's existing flat beam-folding mirror. This is a fast (approximately f/0.5) custom Fresnel lens [RHK Japan Inc, Tokyo, Japan], so even quite small displacements and tilts of the various folding mirrors can produce a significant error in collimation which in turn can lead to some image distortion and to a display which, for example, has some difficulty achieving a saturated and bright red color at the upper part of the image and a saturated and bright blue color at the lower part of the image or vice versa: while this color variance can be used for aesthetic or artistic effect, it can also be reduced or eliminated by careful alignment of the optics and by the introduction (as we did) of spacers to hold the existing beam-folding mirror of the Model-22 a little further away from its mounting post (and hence a little closer to the Fresnel) than was the original design intent. If instead the desired correction had been to increase the distance between these components we would have introduced spacers at the front of the Model-22 to move the Fresnel lens a short distance towards the observer.

For this demonstration, we added simple flat mirrors to route light within the enclosure of the Model-22 and we retained the existing flat mirror present primarily for the purpose of reducing the Model-22's overall depth. It is advantageous to use such mirrors to fold the optical path to this extent and even to a greater degree. For example, a longer optical path permits the use of a slower collimating optic, which generally is less costly and performs better than a corresponding fast element like the f/0.5 Fresnel lens used in the Model-22. Also, a longer optical path implies a lesser proportional difference between the distance travelled by on-axis rays from the source to the hologram film and the distance travelled by off-axis rays from the source to the hologram film and this reduces the resulting diminution of brightness of those parts of the holographic image which are lit by the off-axis rays compared with those parts lit by the on-axis rays, an effect further enhanced by the shallower angle of incidence upon the collimator of off-axis rays with a longer path length. However if the lengthier path is not folded or is only folded once or twice the overall depth of the display device can become commercially or technically unreasonable or inconvenient. Several factors, however, weigh against folding the path too often or too sharply. For example, each mirror, even if antireflection coated, reflects only a polarization-dependent proportion of the light incident upon it, the remainder of the light being absorbed or scattered or to some extent depolarized to the detriment generally of image brightness and image contrast, though suitably interposed baffles can generally intercept and hence attenuate much or all of any such scattered light. Further, for sources with comparatively high etendue, such as incandescent lamps, less of the source's light can be captured by the collimator if a greater path length is used since in this case the source subtends, or appears to subtend, a lesser solid angle as seen from the collimator, and hence a dimmer holographic image results, though in partial compensation of this detrimental effect, because the source also appears to be smaller (unless a physically larger and hence typically brighter source is used in an attempt to offset this loss of brightness) it appears to be more nearly an ideal point source which results in a higher resolution for hologram image points off the film plane.

Generally, a single fold mirror which is quite large (approximately as large in one or two extents as the minimum dimension of the collimating element) can be used to fold the path of even an f/0.5 collimator, and this can result in a theoretical minimum device depth of at most one half of the lesser linear extent of the collimating element in its own plane (i.e., not one half of the collimator's thickness, which in the case of a Fresnel lens, especially an embossed or otherwise high pitch Fresnel lens, can be very thin compared to its other dimensions, for example, approximately 2.7 mm in the case of the Model-22's Fresnel). So, for example, using a 14 inch by 17 inch Fresnel lens collimator in the Model-22 permits it to be folded with a single mirror to a depth no greater than approximately 14/2≈7 inches. In practice a somewhat greater depth is generally desired even in this case because the folding and the folded optics themselves have a certain depth and generally include some manner of holder, retainer, or mount to position them and this holder, retainer, or mount itself generally has some depth. For example, the actual depth of a Model-22 is approximately 9 inches (excluding an optional handle).

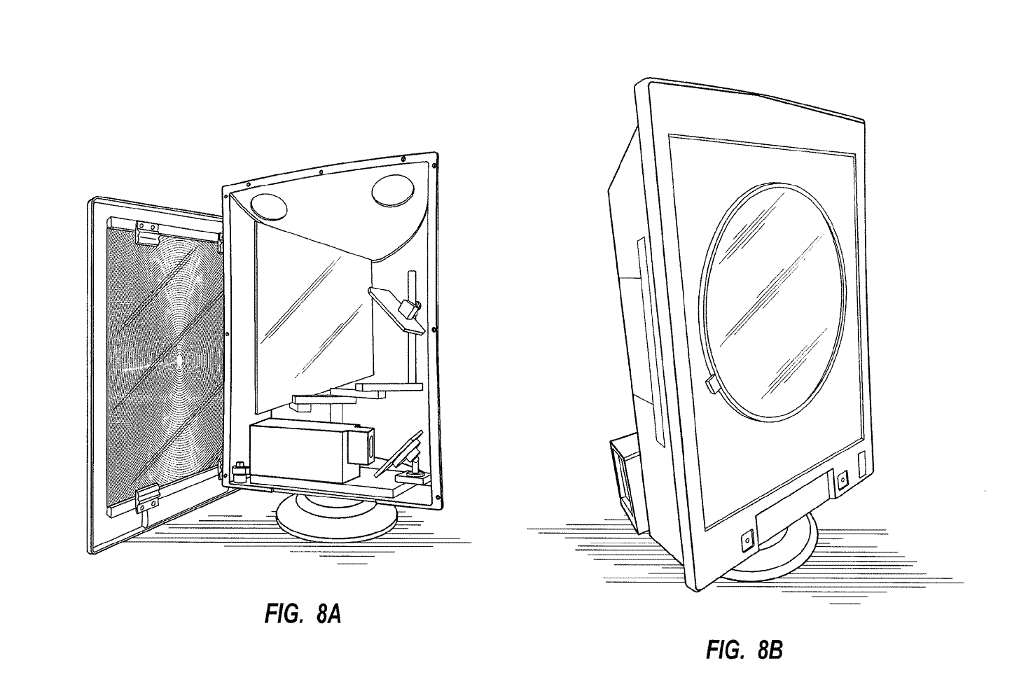

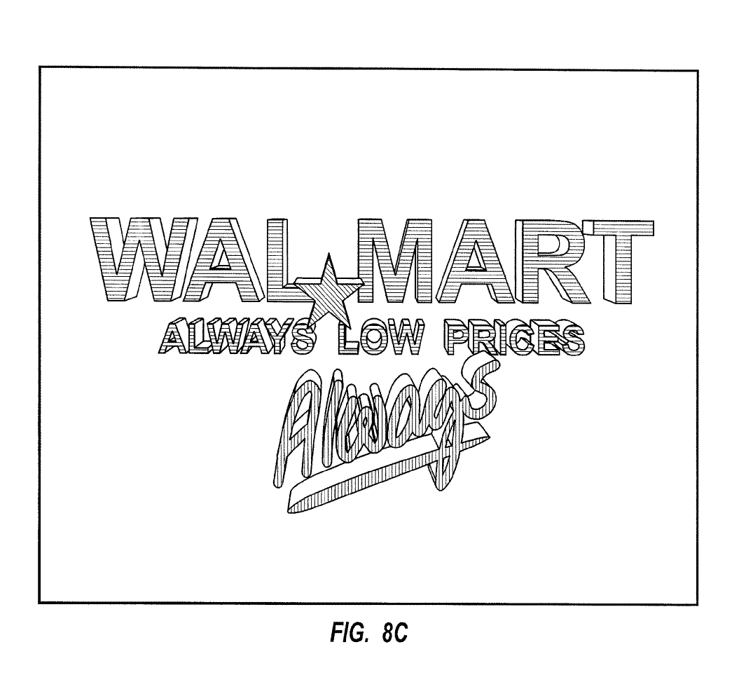

FIG. 8A and FIG. 8B respectively show an exemplary interior and exterior of the modified Model-22 as described above, and FIG. 8C shows an exemplary demonstration full-color hologram as illuminated by this device.

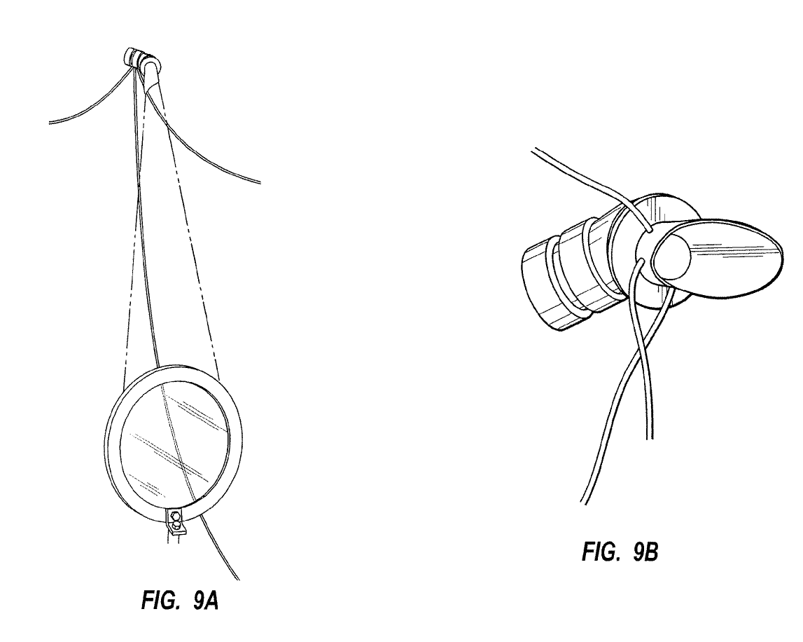

In another approach, a visually and commercially appealing embodiment of the present disclosure uses low or very-low etendue LED or laser sources to permit bright illumination of the hologram or holograms by a light source (or sources) which is (or are) physically or optically at a substantial distance behind the hologram or holograms and physically or optically substantially off-axis so that the hologram or holograms may be viewed without the use of an anisotropic material such as Voxblock or LCF as otherwise described herein (FIG. 9A). In such a geometry, the light source or sources can illuminate from a sufficient actual or apparent distance and at a sufficient actual or apparent angle as not to be visible within the viewing angle of the hologram or holograms, and hence the anisotropic material is not used (though it may still be advantageous for other reasons, such as to make the display opaque so that the environment immediately behind the display is not directly visible to the observer). Such a system can be implemented even for the color aspect of the present disclosure using laser illuminants (or sufficiently narrow band LEDs) without using dispersion compensation (though it may still be advantageous for other reasons) because each illuminant color can be obtained from a different source which the sources can be positioned to illuminate at or close to the desired reference angles (REFr REFg and REFb, for example) and hence the dispersion grating and its resulting dispersion compensation as described herein and by Bazargan may be omitted. Each the source can be independently collimated, or may be sufficiently distant that additional collimation is not desired, or the vergence corrections described above may be used to allow for the divergence of a comparatively close point source.

FIG. 9A and FIG. 9B show an embodiment using an unfolded light path from a point source 530 nm peak 70 nm FWHM 53 lumen LED [part number LXHL-NM98 “Luxeon Star/O”, Philips Lumileds, San Jose, Calif.] for the green channel, located approximately 705 mm behind and approximately 1,057 mm above a vertically mounted circular hologram of approximately 300 mm diameter. The LED in this example is bandwidth narrowed using a 532 nm peak 10 nm FWHM dichroic filter [part number N62-157, Edmund Optics, Barrington, N.J.] to improve the sharpness of hologram details, located in this example out in front of the hologram in a range extending from approximately 200 mm to approximately 300 mm. An advantage of this geometry is that the space directly behind the hologram is clear, whereas in the example described using a modified Model-22 Voxbox display this space is occupied by the LCF/Voxblock, grating, and Fresnel lens immediately adjacent to and behind the hologram, and further back by the mirrors and the optically in-line source.

The psychological impact of such a hologram display may be enhanced because with free-standing holograms mechanically unconnected to their (potentially concealed) illuminants, the observer often cannot easily determine or even guess how the replay is achieved. Whereas with a box, case, or housing (such as the Model-22) immediately behind the hologram, the observer may generally assume there is some arbitrarily complicated mechanism or trickery concealed within it. Further, the space behind the hologram may be used for other visual effects and equipment. For example, an object such as a sculpted face located in this space is generally invisible to the observer unless separately illuminated, so that by turning on/off such additional illumination a startling apparition may be caused to appear/disappear. As another example, a video camera, periscope, peephole, or other observation or recording means may conveniently be located behind the hologram such that it can be used to watch or record the observer of the hologram, for example to monitor their reaction to the hologram for market research purposes or to provide a means for controlling or triggering an interaction between the observer and the hologram or the hologram's ancillary interactive systems such as loud speakers to provide audible feedback/interaction or motion within the hologram as described below.

If a second hologram is mounted with or close to the first hologram in an arrangement such as, for example, that of FIG. 9A, and a second illuminant is provided in front of the first hologram shining back through both holograms, and such second hologram is rotated such that it is reconstructed by the second illuminant and not by the original illuminant of FIG. 9A while the first hologram is reconstructed by the original illuminant and not by the second illuminant, then a first observer can see the first hologram from one side of the system as described but not the second hologram, whereas a second observer located on the opposite side of the holograms can see the second hologram but not the first hologram. The two observers may see each other if they are both illuminated, or one observer may be concealed from the other by being in a dark location or by being shrouded or otherwise concealed, or both observers may be in dark locations or shrouded or otherwise concealed and thus not able to see each other. Any such concealed observer can be revealed at any time, for example by being illuminated continuously or intermittently, and such ghostly apparitions of the other observer may be caused to appear or disappear or change color or brightness as part of a planned or impromptu interaction or performance between the holograms, the observers, and, optionally, an external operator or control system.

Returning now to the subject of illumination sources, the etendue-limited issues discussed above are substantially reduced by the use of low etendue LEDs and essentially eliminated if very-low etendue laser sources are used. As an example, the Mitsubishi L65-A90 LaserVue rear-projection television (RPTV) [Mitsubishi Digital Electronics America, Inc. Irvine, Calif.] uses laser sources (at wavelengths of approximately, 447, 532, and 640 nm), and achieves a tightly folded beam path incorporating aspheric and off-axis components to illuminate an internal collimator of approximately 57 by 32 inches (approximately a 65 inch diagonal) in an enclosure depth of approximately 10.1 inches, i.e., approximately ⅓ of the collimator's least dimension rather than the ½ which is the best which can generally be achieved with a simple single flat fold mirror as described above. Other more complex optical elements, such as holographic optical elements (HOEs), can also be used to produce a shallow overall depth in a device such as this. Extremely tight folding of the optical path is generally substantially less problematic using laser sources, even without aspheric or off-axis lenses or mirrors or HOEs, and even the reflection and scattering losses can be reduced through the use of wavelength-optimized and polarization-optimized coatings because an additional advantage of laser sources is that they are generally well or at least partially polarized: every reflection off a mirror, and (typically to a lesser degree) every scatter or reflection of a lens surface or HOE, has a polarization dependence, and these can be better managed with a polarized source for which in large degree, in one embodiment, only one of the orthogonal polarization states may, at least initially, be present, considered, and allowed for.

A potential disadvantage of using narrow band laser sources for one or more of the colors is the resulting presence and potential visibility of laser speckle. In practice in the context of the present disclosure laser speckle is not as troubling as might be expected: if more than one laser is used, either to provide the different colors, or to provide more light of any particular color, then the speckle for any of these single laser source, even if noticeable or objectionable on its own, is substantially uncorrelated with the speckle, if any, from the other laser source or sources and hence is less visible in combination. Further, the color holographic display of the present disclosure can be practiced with lasers which have very short coherence lengths: such lasers are generally unsuitable for recording (or copying) the component holograms, but are quite satisfactory for their replay. If it is desired to further reduce or substantially eliminate laser speckle, commercially available devices to do so are cost effective e.g., the speckle removal device available from dyoptyka [Dublin, Ireland], and can conveniently be incorporated in a hologram display device incorporating the present disclosure.

The present inventors' demonstration of these color hologram principles provides a holographic image visible over an approximately 6 inch high by 7 inch wide rectangular area approximately centered in the approximately 12 inch diameter approximately circular filters used. A black card mask is applied to the front of the display to frame this area. However in general the illuminated area of the films and filters, and any mask or surround, can be of an arbitrary size and shape, including for example non-rectangular shapes such as circles, ellipses, ovals, star shapes, or the geometric forms of letters, numbers, or other symbols or glyphs. This can be achieved by shaping and sizing one or more of the films or filters (or their surrounds and/or masks) to limit the illuminated area to the desired shape or size, or by introducing additional elements in the form of apertures or masks to further define or establish the desired size or shape. In general, smaller holograms can be illuminated with adequate brightness using less bright light sources, which may for example permit battery-powered operation (or operation by harvested energy such as solar power) where a larger display may include a more substantial electrical supply.

An advantage of the present disclosure is that the stack of films/filters can be held or attached to the front of an illumination mechanism, such as the modified Voxbox Model-22 display device described above, which permits the convenient and simple interchanging of holographic imagery. The front of the display device can be formed or equipped to permit the temporary attachment of a replaceable cartridge, holder, or cassette which retains the films and filters in substantially their desired geometrical relationships and yet which can be removed and interchanged with another similar cartridge, holder, or cassette containing different films and/or filters to display different holographic content or the same content in different colors. Such a cartridge, holder, or cassette, front-loading or otherwise, can be attached or retained with a locking mechanism or with fasteners that are actuated using a special or custom tool or process so that accidental or unauthorized removal or replacement of the cartridge, holder, or cassette may be prevented. Similarly, a mechanism or fixture may be provided which retains the filters substantially in place but permits the films arranged adjacent to the filters to be removed, exchanged, repositioned, interchanged, or replaced, and again a lock or locks or special fasteners may be provided to prevent accidental or unauthorized removal, exchange, repositioning, interchange, or replacement of the films. Holograms recorded on flexible films may be held in a substantially flat or planar fashion in this way, yet may also be rolled or otherwise deformed for convenient shipping and storage. On the other hand, holograms recorded on glass or other rigid or semi-rigid materials may in some circumstances be easier to handle and their greater rigidity may be relied upon to align and orient the correct assembly and operation of the film/filter stack.

As a safety feature for observers, installers, and others in the vicinity of or able to see a display device incorporating the present disclosure, especially such a device using bright light sources, and most especially one using laser sources, interlocks can be provided so that the light source is disabled, turned off, or hidden by a shutter or other interposing beam blocking mechanism, and these safety features can be linked to sensors and switches which sense or detect states of the device which otherwise could lead to a potentially unsafe exposure to the source, such as, for example, switches which detect the absence or presence, correct placement, and state of the cartridge, holder, cassette discussed above or of the films and filters themselves, or sensors which detect suitable, appropriate, or anticipated levels and wavelengths of light at one or more locations within the device's housing, or sensors or switches which detect the opening or closing of access hatches or covers permitting access (for example for service purposes) to the light from the enclosed source or sources.

The present inventors' demonstration of these color hologram principles used a modified Model-22 Voxbox display, in part for the advantages this embodies in terms of compactness, ease of use, enclosure of the optics, and convenience of use, all of which are inherent benefits achievable using the present disclosure, however the present inventors also anticipate that the component parts of the present disclosure, individually or combined as described, may have utility as modular parts for incorporation in other forms of display device utilizing the present disclosure. For example, the film/filter stack as described, or the parts thereof, or one or more of these parts incorporated into or contained within a cartridge, holder, or cassette as discussed above may be provided without some or all of the other parts and components and systems and processes described herein. In particular, the present disclosure may be manufactured and sold in the form of a module or a kit of parts used by others to build, implement, service, or repair hologram display devices or to add holographic display capabilities to other devices such as for example kiosks, vending machines, advertising and promotional displays, slot machines, posters, games, information displays, toys, furniture, and art works.

The present inventors' demonstration of these color hologram principles used component holograms made broadly as described by Hart. However the basic color disclosure presented here may be used with holograms produced in other ways, subject to the z-axis scale of each component hologram being such as to satisfactorily allow for or exploit the longitudinal chromatic defect identified by Bazargan.

For example, a stereolithographic process may be used to convert or “print” a CAD model or other three-dimensional computer data into a solid physical model, form, object composed of a material such as solidified photopolymer, sintered metal, or laminated paper (a wide variety of such systems have been commercially and experimentally implemented using these and other materials, and the use of such equipment is commonly referred to as Desk-Top Manufacturing or DTM). In such a DTM process the source data or model can generally be manipulated prior to printing so that, for example, its scale may be altered in one or more dimensions, and its scale can be different in one dimension, so the color-dependent z-scaling of the present disclosure can be accomplished. For example, a model of a building may be scaled from life-size to approximately 1% of life-size in two dimensions and 1.66% in the other dimension. This process may be repeated, producing a set of models which are substantially the same scale in two of their three dimensions but which have different scales in their third dimension, such as for example a set where for each model two dimensions are scaled to approximately 1% and the third dimension is scaled to approximately 1.66% in a first model, approximately 1.0% in a second model, and approximately 0.71% in a third model. These values of approximately 1.66%, 1.0%, and 0.71% are in the same relative proportions as the values of approximately 166%, 100%, and 71% used in our earlier example of Bazargan's z-axis mathematics. If now three holograms are made, one of each model, using substantially the same recording geometry and process for each and with the models oriented with respect to the holographic recording material such that the dimension in which their scales vary is substantially perpendicular to the recording material, and if desired, they are offset along that axis by amounts corresponding to the z-axis offsets described above as being desirable to compensate for the physical and optical spacing between the films/filters upon their replay, then upon such replay of the films in a replay system utilizing the color aspect of the present disclosure the holographic images are subject to the longitudinal chromatic variation. The model which was recorded with an approximately 1.66% scale along the z-axis replays in substantially a first color with an approximately 1.0% z-axis scale, the model which was recorded with an approximately 1.0% z-axis replays in substantially a second color with an approximately 1.0% z-axis scale, and the model which was recorded with an approximately 0.71% scale along the z-axis replays in substantially a third color with an approximately 1.0% z-axis scale. Thus corresponding image points in each model approximately overlay in their combined holographic reconstruction and a grayscale holographic representation the original CAD model may be observed at a matched scale in all three dimensions of approximately 1%

Several DTM processes are available which are capable of producing objects in two or more colors or in shades of one or more color or with surface textures or finishes which appear visually different or which interact differently with laser light, and prior to printing each of the three differently-z-scaled objects described above, the CAD model or other three-dimensional computer data may be re-colored. So, for example, to the extent that the original data described a blue color for a particular point or region, that point or region can be printed in different shades of gray or different colors or with different surface textures or finishes so that when illuminated by the laser light used to record a hologram of it those points which were originally intended to be colored bright blue appear brighter under the laser's light (or brighter when viewed through a polarizing filter) than those points which were originally intended to be colored dark blue. This re-colorizing can be performed manually or automatically in software, or printed or otherwise fabricated objects can be painted or otherwise have their surface colors, shades, textures, or finishes modified, so that each of the objects when laser viewed as described portrays substantially the relative brightnesses intended for the color to be used in reconstructing the hologram of that object. Now when the holograms of these objects are made and viewed using the color aspect of our disclosure as described, a color holographic image of the original CAD model or other three-dimensional computer data can be viewed rather than the grayscale or single-color image which results when the individual objects are not so treated.

Alternatively, suitable objects for this process may be available without the described z-axis scaling, or with somewhat or substantially incorrect z-scalings. Such objects may still be recorded and replayed as described above by using an additional means of changing their apparent depth along the z-axis. For example, compressible objects may be physically shrunk or stretched along one dimension, either mechanically or, for example, by heat processing if for example they consist of a material or materials with anisotropic thermal properties. Or optical means may be used, such as magnifying or minifying lenses, mirrors, or other optical devices. Or such objects may be immersed in reasonably transparent liquids or gases (which may subsequently be frozen, gelled, or otherwise partially or fully solidified) such that their apparent depth along one dimension is altered.

It is common in CAD applications to use indicia such as different colors for different aspects of a design. For example, one color, shade, or pattern may be used for a glass part and another color, shade, or pattern may be used for a metal part. Or different such representations may be used to indicate differences in finish or tolerancing. In any case, such indicia may be color coded in a hologram produced in accordance with the present disclosure, either with the same colors as would otherwise be used in the source CAD system or with a different choice of colors. Further, if two parts of a CAD data set (or of other data sets) are recorded on different holograms in color and are viewed in a display device or arrangement which permits the translation and/or rotation of one hologram with respect to the other, then where the holograms are seen to overlap their colors blend additively and volume pileup (described below) increases the brightness. For example, mechanical interferences between two parts can be detected by noting such areas of blended color or increased brightness when such holograms are adjusted to bring the images of their respective parts in to substantially their intended relative positions. Similarly, an actual part (for example a mechanical, mineral, or organic part, found, selected, or fabricated for this or other purposes) can be inserted into the replay volume of a hologram so that it occupies a specific region of the holographic volume and hence blocks light within that region and by such means a comparison may be made between the actual part and, for example, its representation within the hologram or the representation of other parts or features within the hologram. As a non-CAD example, holograms may be use to display rare or valuable works of art or culture, and further a hologram of a complete or restored artistic or architectural work can be replayed within the volume occupied by the actual incomplete or damaged art work or building (or a scale model thereof) so that, for example, the missing arms of the Venus de Milo [attrib. to Alexandros of Antioch] may be restored. As a further example, for education or training purposes, a partial mechanism or a damaged or unfinished part may be inserted into the replay volume of a hologram, with the visible parts of the hologram demonstrating or teaching via static or dynamic content how controls or additional parts are intended to be added or adjusted to complete or prepare the mechanism for use or how finishing processes are to be performed.

In certain embodiments, in the color hologram methods and examples described above, the component holograms may not be adequately aligned in six degrees of spatial freedom. If, for example, inadequate alignment is achieved for a blue hologram such that it is rotated and/or translated away from its preferred location upon replay, then all the blue content in the observed holographic image is similarly rotated and/or translated (though the precise extent of the rotation and/or translation in the image may not in general exactly match the physical rotation and/or translation of the component hologram because of the z-axis scaling and potentially other optical aberrations and distortions). In this example, the rotation and/or translation of the blue content of the final image is visible as a general miscoloring and as generally incorrect intensities of every point or region in the image which had or now has blue content, and in particular a blue ghost image is generally visible towards one or more sides (such as the left side or front side) of the image with an approximately corresponding region on generally the opposite side or sides in which the complete or partial absence of blue is perceived as a ghost of an optically complementary color. The present inventors have determined that small amounts of such misregistration may be visually unnoticeable or tolerable, especially for images in which this behavior has been anticipated and allowed for, for example by a judicious re-coloring or de-coloring of the edges of an imaged object or scene, or for images in which this behavior appears natural or aesthetically or artistically desirable. In general however such misregistration should be minimized or eliminated and this can be achieved, for example, by a mechanical or optical means which provides a rotation and/or translation of one or more of the component holograms so as to bring its replayed image back into adequate registration. For example, an individual component hologram may be slid in its plane or twisted or displaced out of its plane during assembly. If for whatever reason a misregistration is predictable, such as, for example, if the discrete or approximate nature of points and coordinates in computer data does not permit an adequately precise registration to be achieved otherwise, then an optically substantially corresponding but opposite misregistration can be deliberately introduced in the component hologram during its recording. Thus adequate registration may be achieved optically or mechanically and either by design or by subsequent adjustment. Such adjustments can be guided visually by an observer of the composite color image, or fully or partially automated by for example machine-vision equipment such as for example a camera and an image processing system. To avoid or minimize such registration adjustments, the component films may be manufactured with and/or using or incorporating mechanical registration means such as registration pins and surfaces. To simplify or speed any such registration adjustments, or to indicate or determine the degree to which any such adjustment is desirable, if at all, additional points, marks, or structures may be included in or adjacent to the object or data recorded in any two or more of the component holograms, such points, marks, or structures acting as fiducials to visually or optically reveal the approximate extent, nature, and degree of misalignment.

The multiple-slice hologram recording method of Hart used in our demonstration example typically results in holograms with discrete gaps between each slice, though this effect can be reduced or eliminated if the diffuse image recorded in this method has itself a depth along its axis of translation, such as for example by using a volume of diffusing material rather than an essentially two-dimensional diffuser. Such gaps may be visually distracting or unpleasing or otherwise undesirable in the component hologram or in the color holographic image formed by the color aspect of the present disclosure. The occlusion aspect of the present disclosure, as described below, can be used to reduce or eliminate such gaps. However, the present inventors have determined that in the absence of sufficient occlusion the visibility of such gaps depends upon, among other variables, the number and distribution of slices, the z-discrimination ability of the observer, and the z-resolution achieved in the replayed holographic image which in particular is generally increased as the bandwidth of the replaying light is reduced so that for example in the present disclosure the z-resolution and hence the visibility of inter-slice gaps is increased if narrow-bandwidth laser sources are used rather than broader bandwidth LED sources or broadband filtered white light.

Since generally it is desirable for other reasons to retain high z-resolution and hence sharpness, and is thus desirable to use narrower bandwidth replay sources such as LEDs or in particular lasers, it is generally desirable to reduce or eliminate the visibility of such inter-slice gaps. In addition to or instead of occlusion, one method the present inventors have used to achieve this is to reduce the actual gap between slices by increasing the number of slices used. Similarly, the location at which an inter-slice gap occurs may beneficially be adjusted on a slice by slice basis so that, for example, slices are spaced closer together where the visibility of their inter-slice gaps is predicted or observed to be greater, for example on areas or in regions of the image which are comparatively smooth, uniform, or un-textured. Further, if the z-axis longitudinal color correction of the present disclosure is in practice imperfect, as it generally is, their may be regions within the final holographic image where the correction is worse and hence inter-slice gaps are less visible and hence coarser slicing may be used in such regions. In particular, if the reconstructing source or sources has or appears to have a finite extent (as is generally the case, especially for non-laser sources) rather than appearing to originate from an effectively infinitesimal point source, then the resolution of the reconstructed holographic image falls off in approximate proportion to the distance of image points from the holographic film which replays them, so that in effect the hologram is or appears to be sharper and more contrasty (and is, or at least often is described by observers as looking, brighter or otherwise better) closer to the replay film and hence more closely spaced slices may be used advantageously for image regions and volumes which appear to be or are closer to the component film or films. However, it may be advantageous to reduce the total number of slices, or to avoid locating slices in certain positions, for example to reduce the cost and time of hologram production, in which case a visually and economically satisfactory balance should be sought.

These and other effects and techniques can be used to reduce (or if so desired to enhance) the number, visibility, or visual importance of these inter-slice gaps, and these effects and techniques can beneficially be combined with each other. For example, the chosen position of slices in each of the component holograms may be selected so that, after allowing for the z-axis scaling effect and any z-axis offsets, the slices of one or more color are positioned upon replay between the slices of one or more other colors. As another example, slices may be positioned or repositioned to reduce undesirable visible effects in specific regions or volumes of the holographic image where they would otherwise be more visible or more visually significant. Such repositioning may be achieved by manual adjustment of slice positions during hologram recording or by manual adjustment of the computer data or processing which would otherwise determine the position of slices or by automatic or manually-guided processes which use, for example, edge, texture, or thickness determination to select where within the image the slices may most advantageously be positioned.

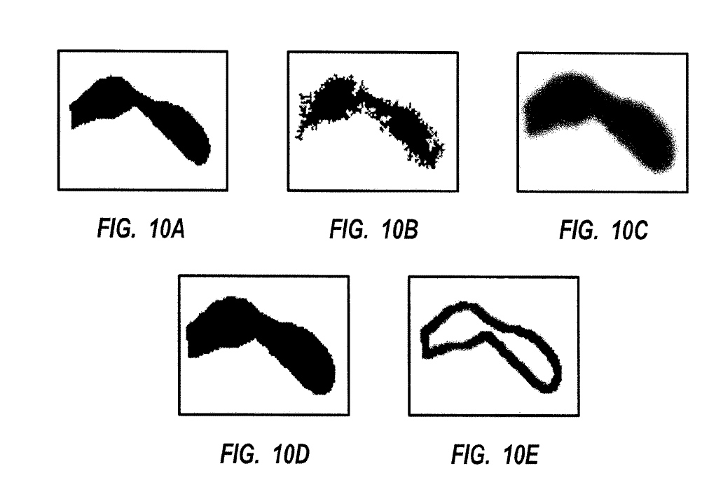

Further, the precise shape and size of recorded slice images, or of recorded objects if the DTM approach is used, may be adjusted to optimize the appearance of the composite holographic image. For example, the edges of regions of an image to be recorded in an individual slice (FIG. 10A) may be “feathered” (FIG. 10B), softened/diffused, (FIG. 10C), or “grown” or extended (FIG. 10D) so that upon replay in conjunction with the other slices in this and the other component holograms the visual undesirable effects of slicing are reduced (or if so desired enhanced). The present inventors have observed, for example, that if lit image areas in each slice are grown by a suitable amount then inter-slice gaps become visible as an apparent or actual overlapping of slices in which the light from two of more slices partially or completely adds to give an increased brightness in the overlap region, and this increased brightness, which can be quite a subtle visual effect if several slices contribute light to it, is generally less noticeable and less visually disturbing or distracting that the dark gaps which otherwise appear between slices, especially when the hologram is observed from an off-axis position. In either case, the dark gaps or the regions of enhanced brightness appear to move about the replayed holographic image as the observer's viewpoint changes, widening and narrowing as the angle at which the observer observes them changes, and since most observers have and use two eyes there is a stereoscopic disparity in the noticeability of, and the visual disturbance or distraction caused by, such gaps or enhancements.

The steps of edge growing, feathering, diffusion, etc may be achieved by optical effects such as selective or overall defocus or diffusion, or may be practiced as a two-dimensional procedure applied automatically or with manual guidance in, for example, an image processing or manipulating program such as ImageJ or After Effects [Adobe Systems Inc., San Jose, Calif.], by, for example, averaging adjacent pairs of images. The three-dimensional analogy of these two dimensional image manipulations may be achieved in programs such as ImageJ which can process a volume or three-dimensional array of data. The inter-slice variation in image content in the z-axis may be calculated or otherwise determined and used to achieve a shelling or hollowing out of volumes within the data, object, or scene represented by the original slices (FIG. 10E). And the thickness of the shell so retained may be adaptively adjusted, manually or automatically, to reduce (or if so desired to enhance) the inter-slice effects. Generally, a thicker shell also results in more volume pileup (described below) along and around the edges and surfaces of objects in the scene and hence generally increases the brightness, sharpness, and contrast of the edges and surfaces in the resulting hologram. Further, by increasing the overlap, a thicker shell generally also reduces the number of slices desired to maintain an appearance of smoothness and continuity, and the use of fewer slices generally also results in brighter, more contrasty holograms.

Where three-dimensional data is synthesized or is manipulable in the form of CAD or surface or solid modeling, such as in rendering programs such as Maya [Autodesk Inc., San Rafael, Calif.] or modeling programs such as SolidWorks [Dassault Systemes SolidWorks Corp., Concord, Mass.], it is possible to obtain suitable manipulations of the underlying models or of their representations or renderings to achieve the desired effects to reduce (or if so desired to enhance) slice and inter-slice gap visibility, so, for example, the surface of a Maya model may be roughened or distended in a suitable fashion and/or direction, or it may be rendered with soft surfaces. In such cases, or in any circumstance where the desired holographic image is represented by a model, mathematical representation, or data set which is not itself in the form of, or simply transformable in to the form of, a set of two-dimensional images as envisaged by Hart, it is desirable to have a method to obtain a “slicing” or “slabbing” into the two-dimensional images or into an intermediate representation which is simply transformable in to the form of a set of two-dimensional images as envisaged by Hart.

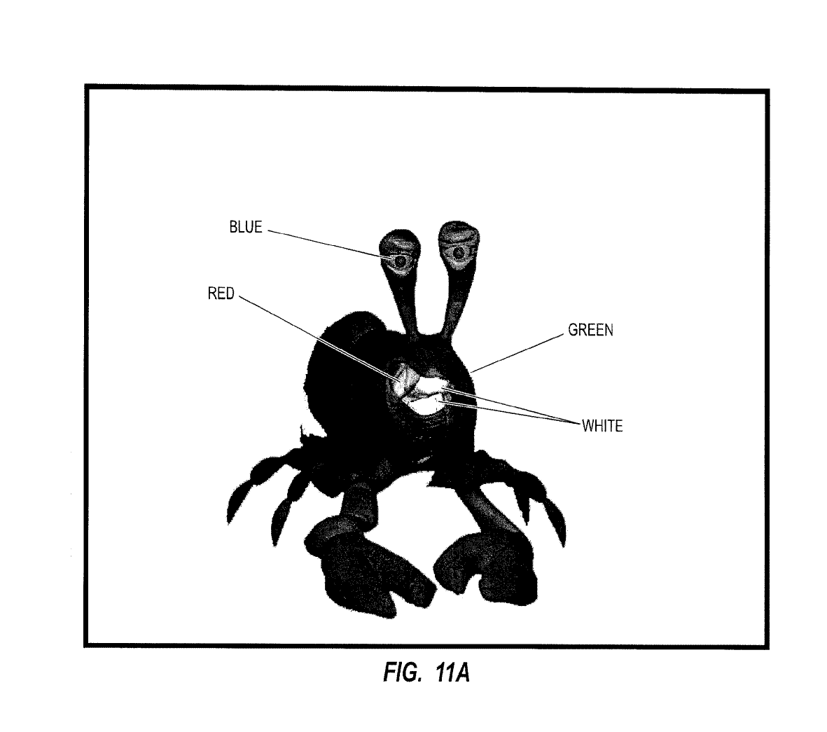

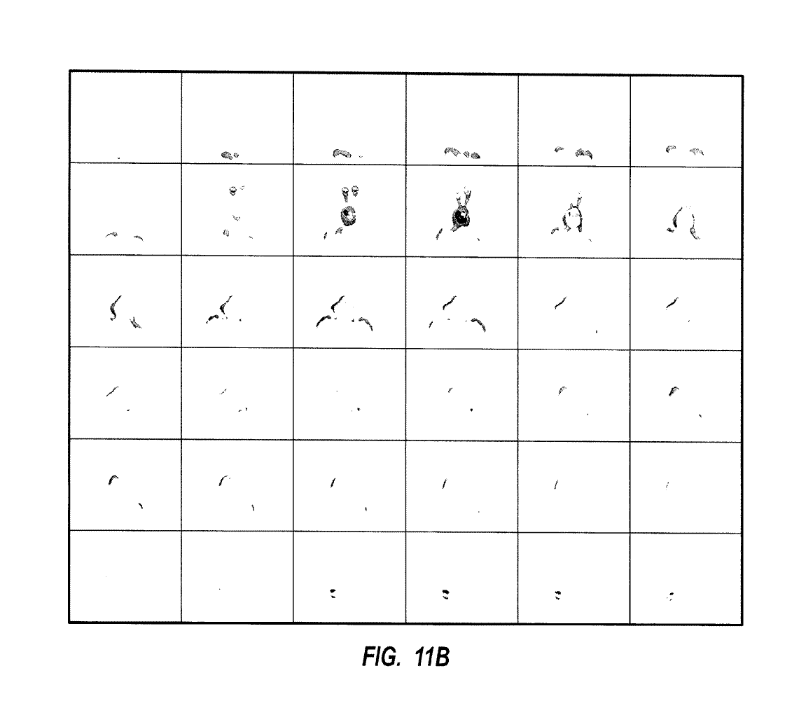

A suitable method for such slicing is to model in the program a slab or wall of finite thickness which can be rendered within the program along with the intended model, data, or other three-dimensional information or description, and to use the program's capabilities, or suitable add ins or services, to render the common sub-volume of three-dimensional space occupied by the slab or wall and by the part or parts of the model, data, or other three-dimensional information or description that is or are represented as being within substantially the same sub-volume. This may be thought of, and in some cases may be implemented as, a constructive solid geometry (CSG) intersection operation. This operation, whether via a CSG process or otherwise implemented, is repeated for a set of slab or wall positions that may be thought of as sweeping out the entire three-dimensional volume, or at least selected parts of the entire three-dimensional volume which are occupied in part or in full by the model, data, or other three-dimensional information or description. Each such intersection operation results in a rendering, or a renderable sub-volume, representative of a sub-volume of the model, data, or other three-dimensional information or description. This may be thought of as analogous to a process of Computer Tomography in which a real object, such as the body of a patient, is sliced into data images by being intersected with and moved through a rotating beam, fan, or ray of x-rays which in effect sample the object's spatially varying influence on the x-rays (and hence, approximately, the object's density distribution). Another implementation of slabbing yields the desired effect using a ramped renderer which renders a series of adjacent or somewhat overlapping soft-edged planar sub-volumes of the scene or object: this has the advantage of providing the slabbing functionality and achieving a controllable degree of edge softening, and for example the present inventors have implemented this method as a short (approximately 20 lines of code) MEL (Maya Embedded Language) script. For a shelled object, which in a program such as Maya or SolidWorks can be generated by, for example, subtracting or deleting or otherwise removing a somewhat shrunken version of the original model, data, or other three-dimensional information or description, this slabbing process naturally results in sliced images which can have the desired slice-to-slice overlap described above. FIG. 11A illustrates an exemplary cartoon crab “character” modeled and rendered in Maya, and FIG. 11B illustrates an exemplary set of green slices derived from this model using the ramped renderer technique. FIG. 11C shows the character reconstructed as a color hologram.

An alternative approach to this method of slabbing is to use front and back clip planes, a common feature in programs such as Maya, which are software adjustments which direct the program to render only those elements which are found between two defined planes. However the detailed implementation of this feature in specific programs, including, in the present inventors' experience, at least certain versions of Maya, may make it unsuitable for the purpose of slabbing as described herein for at least two reasons. Firstly, some implementations provide a ragged treatment of elements which are found partly but not wholly between the two planes: such elements may be excluded from rendering or may be included without clipping at the clip planes. Secondly, the rendering of the clip planes (or of one of them) may be unsuitable, for example if their use allows the inside of a clipped object to be viewed. A custom or semi-custom implementation of the clip-planes concept may be used to overcome such limitations, or the CSG method or ramped rendering described above may be preferred. In either case, or via any other method of slabbing, the shelling described above can be used to obtain the desired slice-to-slice overlap described above or this overlap can be achieved by causing the slabs so generated, whether defined by parallel front and back surfaces or by non-parallel front and back surfaces, to overlap partially in three dimensions so that, for example, the front and rear surfaces of slab n lie at approximately the centers of respectively slab n−1 and slab n+1.

As an alternative to computational slabbing or slicing to obtain substantially parallel flat slices (or to obtaining substantially parallel planar slices via a scanning means such as a computed tomography scan or a physical slicing means such as the collection of a series of images each one recording a microtomed or confocally scanned section of a sample), it is also possible to obtain computationally (or via a suitable scanner or physical or optical sectioning) a series of images which are not substantially parallel and/or not substantially flat. Such images may still be used to make holograms for the present disclosure following substantially the methods of Hart if either they are first computationally resampled as substantially parallel flat slices or (in the case of substantially non-planar slices) the planar (flat) diffusion screen of Hart is replaced with a not-flat diffusion screen in substantially the same shape as the not-flat slices and/or (in the case of substantially non-parallel slices) the track or motion of the diffusion screen in Hart is modified to produce a series of corresponding non-parallel screen positions which the positions may even cause the resulting sequence of screen positions to intersect at one or more points or along one or more lines or planes.

For example, to record a hologram of a cylindrical object (such as a soda can) in accordance with Hart, a computer model of the can (or the can itself) would be sliced into numerous images each representing one parallel cross-section of the can, each of which would be recorded holographically in series as portrayed on Hart's planar diffusion screen. Alternatively, a diffusion screen may be used which is indented in the shape of the front of the can (much as though such a can had been pushed into a softened plastic sheet diffuser which upon hardening retains the imprinted shape of the can) and a suitably warped image of the front surface of the can may be projected upon this can-shaped diffuser such that a single holographic recording would suffice to record holographically both the shape (“geometry”) of the can (i.e., the geometry of the can-shaped screen) and the can's surface detail (its “photometry”) (i.e., the image of the can's surface). A hologram so produced would generally not use multiple holographic exposures and would generally not show the effects of slice overlap. A hologram so produced can in effect be shelled for greater brightness using a thick diffusion screen as described above or by using two or more nesting screens wherein, for example, the second such screen has a smaller indent upon which is projected a smaller image. This process is particularly advantageous for recording holograms in the context of the present disclosure of objects which share one of a small set of shapes and sizes, such as for example different brands of soda can or cereal packet, so that a small set of standard screens can be retained and used as necessary.

As another example, planar but non-parallel slices are commonly collected in a fan-like fashion by medical ultrasound scanners, and the fan-disposed images may be printed holographically in the context of the present disclosure using a diffusion screen which can itself be positioned in a similar fan-like series of positions. In the more general case, a planar or non-planar diffusion screen may be affixed to or otherwise positioned by a general positioning device such as a robot arm or a hexapod mount so that the screen may be positioned in space with up to six degrees of spatial freedom, and such a screen may advantageously be illuminated by imagery in the manner described by Hart using light from a pulsed laser routed via fiber-optics.

Prior to or after slicing/slabbing it is advantageous to perform a back-face culling operation to remove those bright areas, if any, of each resulting two-dimensional image which would otherwise in the resulting hologram fall behind other bright areas in nearer two-dimensional images recorded in the hologram. This is not generally desired for the clinical data anticipated in Hart (and is not described in Hart); a ghostly appearance (in which inner objects and details and the rear parts of objects and details may be seen through outer and front objects and details) is generally advantageous for radiological data. For other kinds of image content this may not be so, and hence this removal of bright rear areas may be advantageous in preventing such ghostliness and the effects of volume pileup described below. In general this back-face culling is not a process which can be performed perfectly because what is viewed by an observer as being behind something else depends on the observer's viewpoint into the hologram, and changes as the observer (and/or the content in the hologram in the case of a holographic movie) moves and is in any case generally different for each eye in stereoscopic vision. However in practice a visually satisfactory result may generally be obtained by eliminating rear areas that would otherwise be seen by an observer observing monoscopically down the central axis of the holographic image (the z-axis), and this may be achieved using a simple painters' algorithm, which, for the demonstration holograms made by the present inventors was implemented as a macro in ImageJ supplemented by a small amount of manual adjustment (painting in or out seemingly undesirable gaps or bright areas by hand, guided by Simgram images (simulations of such holograms, as described below) also implemented as an ImageJ macro as per Dalton as described below. Examples of this may be seen in FIG. 10B in slices where, for example, the crab's body would be visible through its legs.

Maya and SolidWorks (and other similar programs and development environments) both contain and support tools and methods for rendering and modeling, either directly or via available plugins or additional complementary programs or services. The names “Maya” and “SolidWorks” used herein should not be understood to imply the exclusive use of these or other similar or specific tools and methods and are not an endorsement or recommendation, though Maya was used for some of the demonstrations of the disclosures described herein, including the ramped-renderer style of slabbing via a custom script.

It is desirable to provide or have access to a previewing environment in which operations such as the slabbing, back-face culling, and feathering described above can be simulated or executed with visual feedback to an operator, designer, or client desirous of a hologram such that the operator, designer, or client can control, steer, guide, or judge the effect upon the eventual hologram of executing the operation in different ways or with different control parameters. Alternatively, numerical metrics of quality may be defined such that they can be determined or estimated for any particular choice of algorithm or control parameter, and an optimization or search procedure can be executed automatically or with manual guidance to find a best, preferred, or satisfactory choice.

Ideally such a preview environment or metric-based optimization should be implemented within or as a plugin or service for Maya or SolidWorks or whatever other programs or development environments are convenient for, or familiar to, the operator, designer, or client so that they can be productive without excessive training or familiarization with new programs or development environments or features thereof.

Ideally such a preview environment or metric-based optimization should further incorporate all or most of the other holographic and optical effects described herein (including optionally occlusion) or otherwise determined to be present or likely or possible, such as, for example, the limited viewing angles of the component holograms, their limited or imperfect color rendering, the green mirror effect described above, colored ghosts and shadows and other artifacts predictably resulting from, likely to result from, or to the maximum extent possible or anticipated to arise from, misalignments of and inter-reflections between optical components, the bandwidth of the color reconstruction sources, ambient light sources, the slabbing process, other necessary or desired approximations to or modifications of representation of the subject of the hologram, errors, simplifications, or modifications in the z-axis scaling and offsetting calculations, wobbling or other motions, deliberate or otherwise, of any of the mechanical or optical components used for recording or reconstructing the holographic image, the limited angles subtended by the holographic image which results from its actual size and extent when compared with the size and extent of the space within which the observer can or may chose, be required, or be able to move within, including stereoscopic effects resulting from the different locations and performance characteristics of the observers' eyes, and any degree of holographic targeting as described in Hart2 [U.S. Pat. No. 6,441,930] which provides a process and apparatus for reducing or eliminating this particular effect. For example, the operator, designer, or client may be provided or equipped with stereoscopic viewing capabilities, such as for example, a stereoscopic LCD display such as the iZ3D [iZ3D, LLC, San Diego, Calif.], and their head and/or eye position may be tracked, known, or estimated using, for example, an ultrasonic tracker such as a UM-5 tracker [RuCap, Moscow, Russia].

A particular optical effect which can beneficially be incorporated in a preview environment or metric-based optimization is the way in which light from different slices in Hart's method combines visually, and a method and apparatus for so doing is provided by Dalton [U.S. Pat. Nos. 6,748,347 and 6,123,733] which describe the generation and use of “Simgram” images and movies which simulate the appearance of the kinds of hologram used in the present disclosure. Dalton also includes the effects of superblacking per Hart. This is particularly useful when shelling (as described herein) is used to effect slice-to-slice overlapping, to increase brightness, or for any other reason.

The present inventors have observed that holographic targeting as described in Hart2 is generally reduced or even eliminated by the combined effect of using more than one hologram film in the present disclosure, as is the case for other holographic and production artifacts such as dirt and physical damage to films, filters, and other optical components which, unless similarly present on the corresponding films, filters or components of another color, often only influence the content of a single color which the color may not even be generated by the region suffering such dirt or damage.

The present inventors have observed that holographic targeting as described in Hart2 is general stronger and more clearly visible for data where two or more slices overlap and hence especially so for thickly-shelled data in general. In practice the methods and apparatus of Hart2 can substantially eliminate even this degree of targeting: for example, the present inventors have determined that targeting can be made essentially invisible even in holograms of thick-shelled data, and even under laser illumination (where targeting is far more prominently visible than under broader-band illumination), if for slice spacings of, for example, approximately 2 mm in the z or depth axis, incremental screen translations in an x- or y-axis (axes substantially parallel to the plane of the diffusing screen in Hart2) of approximately 4 mm are made between slice exposures such that the screen returns to substantially its original x location only after a change of approximately 4 mm or more. An example of such a sequence would be z:x pairs (given in mm and relative to an arbitrary origin) following approximately the sequence 4:0, 2:8, 0:16, −2:−16, −4:−8, −6:0 for which any given x value only repeats after a change of z value of approximately 10 mm.

The preview environment or metric-based optimization should further incorporate or be supplemented by a set of design rules, which may be application-specific, to permit, encourage, and enable the operator, designer, and client to create a holographic image or images optimized for the intended usage. For example, a surgeon, radiologist, or researcher may be advised, guided, or compelled to render arterial blood flow in shades of red and venous blood flow in shades of blue. As another example, a geophysicist may be advised, guided, or compelled to render different rock types in commonly accepted and understood colors. As another example, an advertiser may be advised, guided, or compelled to avoid certain colors or shades, or to make compensating adjustments to the coloration, design, or placement of a logo, because otherwise they cannot be produced satisfactorily in the holographic image. As another example, an architect may be shown in simulation the appearance of a holographic image as it would appear with specific replay hardware (or an approximation thereof) in a given location or building under specified, typical, or known or anticipated lighting conditions, such as for example inside a hotel lobby or on a sunlit wall outside a cinema, or with the display device positioned behind a shop window and the holographic image partially or fully on the other side of the window, so that they may, for example, specify a suitable battery power supply or select display hardware including multiple laser sources for extra brightness, or design or select a shade or shades to be used to prevent strong lights in the surrounding environment from overwhelming the holographic image. As another example, a packaging or consumer-products designer may evaluate in simulation whether a specific hologram is too large or too small for its intended observer. As another example, an artist or interior designer may be shown in simulation the size of an image achievable with specific replay hardware so that they may chose to use multiple display devices in an arrayed or tiled or arbitrary combination to produce a larger overall image or to fill or otherwise use a display environment more fully or more effectively (for example by using a series of separate holograms to display each of the characters, symbols, or glyphs of a message, sign, or logo) or so that they may hide the holographic image or images or part or parts thereof from certain locations, positions, or zones within the display environment for aesthetic or artistic reasons or to create visual surprises or excitement on the part of the observer or to fully or partially prevent a certain observer or observers in certain locations from viewing all or part of the holographic image or images or of the display hardware, such as for example by concealing or buying the hardware or some part or parts of it within a wall, ceiling or floor, or an existing or additional housing such as a plinth, cabinet, or display wall or a product or its packaging or a fixture or fitting.

Further expanding this last example, and more generally whenever or wherever more than one hologram is used or a single hologram or hologram series is divided or activated in whole or in part or in parts, it may be desirable to synchronize or relate the operation of one or more hologram or parts of one or more hologram. For example, in a room with two or more holograms it may be desired to turn them on or off or vary their brightness or move them or activate or deactivate ancillary mechanisms or devices to hide them or to modify their appearance in predictable, predetermined, or random or pseudo-random or semi-random patterns or schemes either over time or in response to external triggers such as sound, light, temperature, or humidity or motion sensors which respond to, for example, the presence or location of an observer or observers, or the degree or character of ambient light or noise. For example, a hologram may appear to react to the presence of an observer as a result of a camera or motion tracker, switch, capacitive sensor, or microphone which detects the presence, proximity, orientation, or activity of the observer or of another target or of an action such as speech or a hand motion or head motion. As another example, an intermittent motion hologram (as described below) can be changed from one image to another in response to, for example, an external temperature sensor, and can thus in this example act as a visual thermometer showing a numeric or analog readout of the temperature accompanied by scenes ranging from a wintery landscape with snow to a pictorial representation of a summer heatwave. Since each such hologram is (or can be) fully three-dimensional, they can also be sequenced or controlled to illustrate a non-scalar phenomenon or measurement, such as, for example, the ambient magnetic field, with holographic content chosen to point with or otherwise represent both the magnitude and the direction of a measured parameter, in this case acting as a holographic compass or magnetometer. As another example, such a hologram series can be triggered by the detected presence or absence of an object in the volume of the holographic image, so that, for example, the holograms could show imagery representing the flow of data back and forth between a bank ATM and an NFC “cash card”, the holograms projecting from the ATM into the vicinity of the card held by a bank customer and portraying, in effect, the flow of money (credit) from the customer's account into the card.

Such activation sensors or triggers may also be used to deactivate the same or other holograms or parts of holograms, for example when an observer is detected to have departed, and may also be used to trigger and control the state or outputs of other devices that are desired to behave in conjunction with the hologram or holograms, such as, for example, a sound track or sound effects, other visual displays or indicators, room lighting or temperature or humidity, or the release or removal of certain smells such as, for example, a scent matching or suiting the subject of the holographic image such as a perfume or fresh-baked bread. In a further example, a haptic mechanism may be used to provide force feedback acting against part or parts of an observer's body, so that for example the visual appearances of three different cloth samples may be replayed, one in each color all together, or in combinations such as one color at a time, and with haptic feedback an observer who touches the holographic image feels the appropriate texture of the corresponding cloth type.

In addition to or in combination with the use of multiple display devices in an arrayed or tiled or arbitrary combination to produce a larger overall image or to fill or otherwise use a display environment more fully or more effectively as described above, such multiple devices can also be used to provide a wider viewing angle, by, for example, arranging two or more displays facing in somewhat or substantially different directions. This may comprise, for example, a polyhedral arrangement, regular or irregular and consisting of substantially similar units or a collection of dissimilar units such as a surface filling or tiling arrangement of larger and smaller polygonal displays. Such a polyhedral arrangement may approximate a cylindrical or semi-cylindrical or spherical or semi-spherical display surface which is convex or concave to the observer so that, for example, it may partially or fully enclose an observer. Similarly, images or partial images from two or more hologram devices may be combined optically, by, for example, a beam-splitter, to produce a larger or more complex hologram: for example, using the motion aspect of the present disclosure, two short motion sequences may be combined as one longer sequence by viewing the two motion displays (as described below) in sequence through a beam-splitter so that they appear as a single hologram of greater duration. As another example, a hologram of a substantially unchanging part or scene can be shown using one such hologram device, and one of an interchangeable set of other holograms can be superimposed via a beam-splitter or other opto-mechanical means on the unchanging part or scene so that, for example, a “stage” (within which a “play” is seen by the observer) can be displayed with one device, and the beam-splitter can superimpose upon part or all of this holographic image a second holographic image in which a character is seen to move and “act” upon the stage to convey the “action” of the play, and by interchanging holograms in such an arrangement a more lengthy or complex “story” may be told.

In general, design and use of truly three-dimensional holograms shares some features with theater design, sculpture, architecture, stereoscopic cinema and video, and the layout of commercial and other spaces, in that there can be more than one observer and the observer or observers can generally move to some extent in three dimensions so that it may be wise to pre-visualize and design for different observers of different heights following different paths in space and time.

Design rules to parameterize and help simulate these and other variations may be provided in verbal or graphical form, via education or training of operators, designers, clients and other interested persons, or may be incorporated as constraints, rules, or guidelines within a preview environment or metric-based optimization. Such rules may include, for example, that it may be undesirable for certain subjects to include shadows (including self-shadowing) or enclosing or offsetting surfaces or environments because they can provide a visual interruption, disruption, or artifact to a certain observer or observers from some or all positions or under certain or arbitrary viewing conditions. For example, frame violation or “window violation”, as stereographers call it when an object becomes partly invisible at the edge or edges of a limited stereoscopic viewing region, is generally inadvisable, but may be exploited for aesthetic or artistic effects.

Following, or incorporated with, or instead of or in addition to a preview environment or metric-based optimization, it may also be found advantageous to provide a production environment to assist an operator, or a defined or exploratory process to convert the design or selection of the desired holographic image or images into specific data, instructions, and settings for the hologram production and replay systems and apparatus. This production environment can be used, for example, to actually slab, cull, and feather a model or design from Maya or SolidWorks, such operations having perhaps been only partially or imperfectly simulated or executed in the preview environment or metric-based optimization. Other necessary or desirable conversions can also be accomplished in this production environment (including the calculations for any desired occlusion), even if perfectly simulated beforehand, including such steps as superblacking, filtering out of isolated distracting pixels, elements, or sub parts of a data set, color correction and balancing, and two-dimensional and three-dimensional compositing, blending, or morphing of different designs or data, including for example stored representations of graphical elements such as logos or scene objects which may be repeated from one hologram to another and which may conveniently be archived, cached, indexed, and promoted to clients. The preview and production environments may be very similar or even identical, or they may have significant differences, such as, for example, in that the preview environment may render using linear perspective to more faithfully simulate the appearance and use of a three-dimensional hologram, whereas the production environment may use orthographic rendering because the resulting hologram, as a truly three-dimensional distribution of light in space, is perceived in natural perspective if created using an orthographic geometry.

The designs, selections, modifications, and renderings performed in Maya or SolidWorks need not be constrained to polygons or other kinds of planar surfaces. Volumetric effects such as fogs may be included and rendered for holographic display, as may abstract data, mathematics, observations, measurements, or computations which may be spatialized or colorized for display even if they do not contain three dimensional or color components per se. Surface and near-surface effects such as specularity and sub-surface scattering may also be included and rendered for holographic display. Effects, features, and details which cannot conveniently or efficiently be included in renderings prior to their slicing/slabbing can nevertheless be reintroduced into the resulting slices as 2D effects using typical post-production tools and software such as, for example, Adobe After Effects. Depth may be obtained from point-cloud data or measurements or may be derived from stereoscopic imagery or via motion flow or image-to-image variations as a camera or simulated camera pans past or moves around or through a scene or as the scene itself changes or evolves over time. Even simple vector graphics may be suitable or advantageous for some applications. The present inventors have observed that when one vector is seen to pass in front or behind of another vector in such a hologram viewed monoscopically, the light from the two vectors adds to produce a somewhat or significantly brighter point or region. When viewed stereoscopically, each eye may see these enhanced points or regions at different locations, and this can act as a useful additional depth-cue to indicate to the observer the relative locations of the vectors within the holographic space and in relation to the observer. Dalton has termed this “volume pileup” by analogy with the term “vector pileup” which has been used to describe an analogous effect in computer graphics displays where using certain technologies and algorithms the brightness of intersecting or overlapping vectors is seen to be enhanced. Such volume pileup is an underlying cause of the banding seen when the edges of slices overlap in holograms per Hart as described above, and is the primary effect simulated by Dalton's Simgram images.

Motion

Summary: Embodiments include achieving moving holographic imagery by the angular multiplexing of a collection of “frames” each comprising a single hologram.

The replay of holograms is generally an angle dependent process, with Bragg selectivity preventing efficient reconstruction if the replay reference beam is incident at too great or too small an angle. This angular selectivity may be exploited to permit two or more recorded holograms to be replayed independently from one recording medium.

For example, if a suitable unexposed holographic recording material is subject to a first recording exposure using a reference beam incident upon it at a certain angle R and an object beam incident upon it at angle O1, next is rotated by approximately 90° in its own plane, and next is subject to a second recording exposure using again the same reference beam incident upon it at substantially angle R and a different object beam incident upon it at angle O2 (where angle O2 may be substantially the same as angle O1), and next is processed (if the use of the material includes processing to develop latent holographic images recorded during these two exposures), then two sets of holographic fringes can be recorded within or upon the recording material, and, if the recording material is thick enough, Bragg selectivity will ensure that if held in substantially the first recording position and re-exposed to a reference beam at substantially angle R (or at a suitably different angle if in processing the thickness of the recording material has increased or decreased significantly) the first recorded object beam replays and the second object beam does not replay, or at least replays substantially fainter than the replay of the first object beam, and if the material is now rotated by approximately 90° in its own plane and held in substantially the second recording position and re-exposed to a reference beam at substantially angle R (or at a suitably different angle if in processing the thickness of the recording material has increased or decreased significantly) the second recorded object beam replays and the first object beam does not replay, or at least replays substantially fainter than the replay of the second object beam.

Holographers generally use the terms “orthoscopic” and “pseudoscopic” to refer respectively to images which appear normal and images which appear to be inside out. Such pseudoscopic images may generally be created by inverting a recorded hologram. So, for example, the hologram copied in the copy geometry of Hart is a pseudoscopic reconstruction of the originally-recorded screen-positions. Most display holograms are replayed in an orthoscopic mode because it is generally highly undesirable to see objects inside-out. For the multiple-slice holograms of the present disclosure the front and back of the “object” can be interchanged by interchanging the positions of the recording screen. This achieves, in effect, a reversal of the z-axis of the recorded object or scene, permitting the reversal of the normal relationship of inside to outside for orthoscopic and pseudoscopic views.

In the context of the present disclosure, the holographic “window” (i.e., the recorded edge of the master hologram as seen in the copy hologram) may advantageously be positioned closer to the observer than is the holographic content they are observing so that the window's presence is less noticeable to the observer because the observer's eyes are focused deeper into the holographic space and because in this situation the window is further from the replay film and hence is less sharply replayed. Because the present disclosure's multiple-slice recording permits the reversal of the normal relationship of inside to outside for orthoscopic and pseudoscopic views (as described above), the holographic window can be positioned closer to the observer without replaying the object or scene “inside-out”.

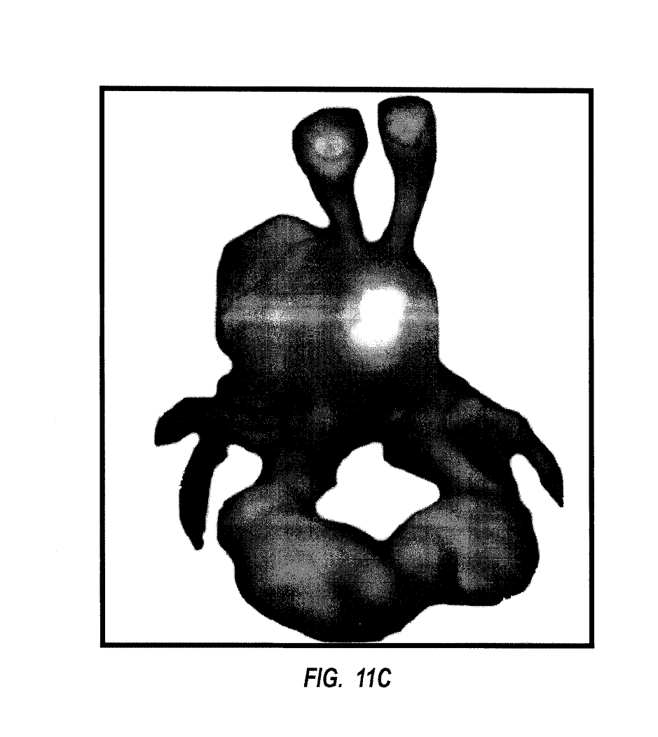

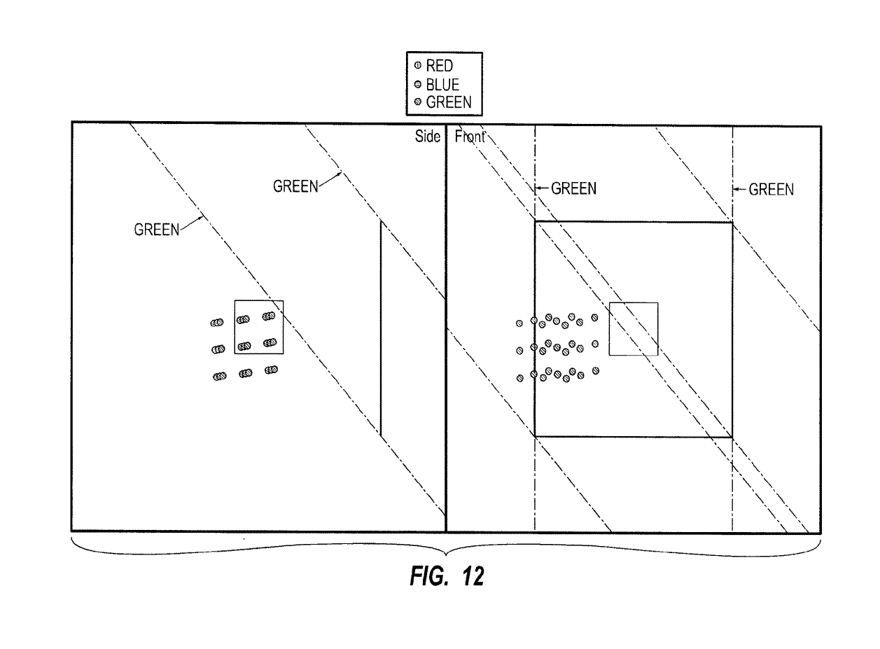

Two further effects can work together with Bragg selectivity to further control the visibility of holographic content recorded and replayed at adjacent angular positions. Firstly, the distortion mathematics of Bazargan/Champagne show that as the replay material is rotated the holographic image it replays rapidly distorts and swings-out away from the observer (FIG. 12), a combination of effects referred to herein as “swing-out”. Secondly, the holographic window may be sized and positioned to provide a rapid termination of visibility as the recording angle changes. For example, a circular or elliptical window may be created, either by recording the master hologram on a circular or elliptical film, or by masking it to a circular or elliptical shape upon replay for copying. Such a circular or elliptical window can cut-off visibility upon rotation more rapidly than a square or rectangular window. Further, with this window closer to the observer than is the holographic content they are observing (as described above) the window is positioned further from the replay film than it otherwise would be and hence it distorts and swings-out more rapidly upon rotation, further helping to isolate frames.

This procedure (sequentially recording a series of holograms within one recording material using angular rotation between exposures, and using Bragg selectivity, swing-out, and the holographic window to allow the subsequent replay of any one of the recorded holograms essentially in isolation without substantial visibility of any of the other so recorded holograms) may be repeated with another approximately 90° of rotation for a third recording exposure, and again rotating a further approximately 90° for a fourth recording exposure. If a fifth exposure is attempted at a further approximately 90° of rotation the system would be returned to substantially its original position, and hence any such fifth exposure would be recorded in substantially the same geometry as was the first exposure and hence would not be uniquely replayed during subsequent replay.

If a hologram prepared with four exposures as described above at approximately 90° separations is gradually rotated while exposed to a suitable replay reference beam as described above, then the four recorded holograms replay and are visible to an observer in series as the recording material reaches approximately the 0°, 90°, 180°, and 270° angles in its rotation. At rotations between these four values one or two holograms are visible, but are geometrically distorted and generally fainter than the correctly reconstructed holograms at the approximately 0°, 90°, 180°, and 270° angles. Typically, the greater the thickness of the recording material the greater is its Bragg selectivity, so that for sufficiently thick recording materials no holographic image is replayed or visible at the intermediate rotation angles of, for example, approximately 45°, 135°, 225°, and 315°. For an even thicker material, generally there is a range of angles about these approximately 45°, 135°, 225°, and 315° rotation values for which substantially no reconstruction is visible.

Rather than rotating the record/replay material as described above and elsewhere herein, it is instead possible to rotate the replay reference beam while the recording material stays generally stationary during recording (FIG. 4C) and during replay. This can be achieved by, for example, rotating the replay reference beam's optics, or by providing a plurality of replay reference beams disposed angularly around the replay material. If this is done, to maintain the correct rotational relationship between the recording material, the reference beam or beams, and the observer, the holographic content should undergo a rotation about the same axis as the replay reference or references rotate about or are disposed about, otherwise the holographic content will rotate (relative to the observer) between frames by the inter-frame angle. For example, if eight replay reference beams are provided at approximately 45° rotations about the z-axis, each of which can be turned on/off in sequence (FIG. 13) then in this manner an animated hologram can be produced which corresponds visually to the animated hologram which would have been seen using a single stationary replay reference beam and rotating the replay material 45° between frames. Potential disadvantages of this scheme include the cost and complexity of providing multiple replay reference beams or a rotating replay reference beams, and the greater volume occupied by the beams or beam (this disadvantage can be reduced by folding the paths of the beams or beams using one or more flat or curved mirrors in a manner analogous to the folding of a Model-22 Voxbox display as described herein). Advantages of this scheme include the lack of moving parts, especially if multiple replay beams are used. Even if a rotating replay reference beam is used, this can be achieved by providing a comparatively small rotating light source which is reflected off stationary folding optics, and in either case the replay holographic material itself can be substantially stationary which can avoid the complexities (described below) of bringing replay light and sensing and control signals to a rotating holographic material.

A further advantage of multiple replay references is that the on-duration of each such reference can be longer than for a pulsed reference used with a rotating hologram because (as described below) such rotation results in a radially-dependent extra blurring of the holographic content: as a result, replay with multiple replay references can be much brighter and/or can use much dimmer light than replay with a rotating hologram.

A further advantage of multiple replay references is that frames of the recorded hologram can more easily be replayed in reverse order, random order, or other cyclical orders (such as, for example, frames 1, 2, 3, 4, 4, 3, 2, 1) for a variety of aesthetic, artistic, or story-driven effects.

A potential disadvantage of rotating replay references and of multiple replay references is that the angular relationship between the observer and replay reference is different for each frame. As a result, the window as described above rotates between frames (though this is not noticeable if the window is substantially circular). Further, if as a result there is a mismatch between the vergence of the recording reference beam and one or more of the replay reference beams then a degree of the swing-out effect described above is observed for each such replay reference beam, and in general this will cause a cyclical rotational offset in the position of, and a cyclical distortion of the shape of, the replayed holographic content: these swing-out effects can be substantially eliminated by pre-distortion of the holographic content as described herein.

A further potential disadvantage of rotating replay references and of multiple replay references is that the residual reference (as described above) respectively rotates or exits in multiple directions rather than always exiting in one direction. This can still be blocked by the Sa filter as described above, or by suitably placed baffles or occlusive surfaces, or can be used for aesthetic or artistic effect.

These two motion scenarios—rotating hologram, and rotating/multiple replay reference beam(s)—are visually equivalent. A third scenario is also possible in which the observer rotates between frames, the singular replay reference is stationary, and the holographic material rotates to match the observer. Again, the equivalence is obvious, and generally all replay scenarios depended on maintaining a substantially fixed angular relationship between the orientation of the observer and the orientation of the holographic content while changing the angular relationship between the active replay reference and the holographic content. Hybrids of these scenarios are also possible and can be advantageous, for example, the observer can be stationary while the hologram oscillates back and forth through a range of rotational angles and a plurality of angularly disposed replay references is used. Hereafter for simplicity, generally only the scenario of the rotating hologram is described and the equivalent scenarios involving rotating replay reference, multiple replay references, and rotating observers are not further described but will be understood by those skilled in the relevant art via their obvious rotational equivalences.

For example, the present inventors have recorded series angularly multiplexed holograms of this nature in Agfa 8E56 recording material (which has an approximately 6 μm emulsion thickness) at approximately a 532 nm recording wavelength with approximately a 56.3° reference beam angle, and have observed that a rotation of approximately 30° between exposures is sufficient to allow a series of twelve such holograms to be recorded and replayed with substantial or complete independence. If this hologram is spun slowly around an axis perpendicular to its plane and continuously exposed to a replay reference beam at approximately a 532 nm replay wavelength with approximately a 56.3° reference beam angle then the twelve holograms are seen in the series of their recording (or in reverse series if the spin is in the reversed direction), with each hologram fading and twisting out of view before the next (or prior) in series fades and twists into view. If now the replay reference beam as described is interrupted except when the rotating holographic material is close to the rotation angles of 0°, 30°, 60°, and so on through 300°, and 330° then the twisted and fainter views of the series of holograms are not seen and instead a series of twelve discreet clear and independent holograms is seen with no holographic reconstruction visible between these angles when the replay reference is not present.

In certain embodiments, a short repeating holographic movie may be achieved by spinning such a recording (or its replay reference beam) at an increased speed while flashing short pulses of replay reference in synchronization. So, for example, if the material is spun at a constant rate of, for example, approximately 2 Hz and the reference is pulsed in synchronization at the same rate and with short pulses of approximately 1 ms duration and each hologram in the recorded series represents the same scene or object but with the scene changing or object moving such that the twelve recorded holograms represent or depict twelve sequential steps in a cyclical motion or other smooth looping change of the scene or object depicted then a moving holographic image of the scene or object is perceived, approximately ½ second in duration and repeating approximately every ½ second. Flicker fusion prevents the appearance of flicker, and short-range apparent motion provides smooth motion.

By the term “short-range apparent motion” we mean the phenomenon commonly referred to as “persistence of vision”; see “The Myth of Persistence of Vision Revisited”, Joseph Anderson and Barbara Anderson, Journal of Film and Video, Vol. 45, No. 1 (Spring 1993), 3-12.

At an insufficient replay rate, flicker and a jerkiness or lack of smooth motion becomes evident. The present inventors have demonstrated that this is tolerable (in that a satisfactory illusion of continuous motion is perceived) even at rotation rates as low as 16 holograms-per-second (i.e., a 16/12≈1.3 Hz net rotation rate for the 12 hologram demonstration discussed herein), and that at sufficiently high rotation rates no flicker or discontinuity or jerkiness is perceived: experimentally, anything in excess of 24 holograms-per-second, or z a 2 Hz net rotation rate for the 12 hologram demonstration discussed herein, is generally sufficient. The present inventors have determined that the minimum desired frame rate depends somewhat on the image content (larger and brighter areas and volumes within the holographic image generally benefit from higher rates), the overall or average brightness of the holographic image relative to ambient light, if any, and to some extent the color or colors of the holographic image and the duration of the replay reference pulses. The minimum and desirable rates are found to vary somewhat between observers and even for a single observer under different observing conditions.

This is not “pulsed holography” as that term is generally used, in which very short, typically sub nanosecond, pulsed exposures are used to record holograms of moving objects. In the present demonstration, with, for example, an approximately 1 ms pulse duration and an approximately 2 Hz net rotation rate, the rotating material rotates through an angle of approximately 0.72° during each pulse. This would be far too much motion to permit the recording of a hologram, but such a magnitude of motion during the replay of a hologram produces only a mild blurring of the replay such that points in the holographic image which are reconstructed by areas of the hologram which are away from the center of rotation are blurred by about 0.72° which, experimentally, has been found by the present inventors to present little or no visual disturbance and in fact may even contribute to the desirable sense of smooth and continuous motion.

In the present inventors' 12-frame exemplar, reference pulses of 1 ms duration at a repetition rate of 16 pulses per second represents a pulse duty cycle of 16/1000 or approximately 1.6%, so the holographic movie using these parameters is on average only about 1.6% as bright as is any one of the constituent holograms continuously replayed with an otherwise similar but continuous reference beam. In practice the present inventors have observed that this hologram appears somewhat brighter than expected.

It is advisable to avoid at all times (including during idle periods and spin-up and spin-down periods) flicker rates which risk inducing epilepsy in susceptible observers.

Thicker holographic recording materials generally exhibit greater Bragg selectivity, so that more rotationally multiplexed holograms can be recorded within thicker materials at correspondingly reduced inter-hologram angles. For example, a recording material with an approximately 60 μm thickness permits approximately 120 holograms to be recorded and replayed at angular separations of approximately 3°. Such a material can replay a movie at 24 frames-per-second even when spun at a net rotation rate of just ⅕^{th} Hz or 72° per second. In this case a replay reference pulse duration of 10 ms at a rate of 24 pulses per second produces the same 0.72° of rotational blur which has been determined experimentally to be tolerable or even beneficial, and this corresponds to a 24% duty cycle so the moving holographic image appears approximately one quarter as bright as would a single continuously replayed image and has a net duration or cycle time of approximately 5 seconds.

This brightness estimation assumes that 120 such holograms are recorded such that each is approximately as bright and approximately as contrasty as would be one hologram recorded in the same material and with substantially the same recording, processing, and replaying parameters. Thick holographic materials are available, for example in the form of DCG and photopolymer materials, or may be created by swelling the gelatin emulsion of a silver halide emulsion of a material such as Agfa 8E56, and in certain cases such materials offer an available index modulation capacity which far exceeds that desired or even usable for a single holographic recording so that series of tens, hundreds, or even thousands of such exposures can be recorded using such materials. Further, the recording geometry and other parameters used for such a series recording can be optimized experimentally or by design to maximize the brightness and contrast of each hologram in the series, and to minimize any undesirable trend for the average brightness or contrast of such holograms to vary through the series: this may include determining formulae or empirical relationships via which one or more of the recording parameters, such as beam ratio or exposure duration or the delay between exposures, is or are varied through the exposure series.

By such methods and using such materials as described above it is possible to produce holographic movies containing as many as 1,000 frames corresponding to movies or movie loops with total durations of approximately one minute at acceptable (in terms of flicker) frame rates and with acceptable brightness given the availability of sufficiently bright reconstruction sources as, for example, the laser sources incorporated in Mitsubishi's aforementioned L65-A90 RPTV (approximately 3.8 average Watts of red at approximately 640 nm, approximately 3.0 average Watts of green at approximately 532 nm, and approximately 4.85 average Watts of blue at approximately 447 nm). Such reconstruction sources are eminently suitable for the replay of color holographic stills and movies made using the color aspect and the motion aspect of the present disclosure.

The present inventors have demonstrated an exemplar of such a color holographic movie loop by generating component red, blue, and green holograms using the color aspect of the present disclosure wherein each the component color hologram also implements the motion aspect of the present disclosure with 12 holographic images or frames, and replaying this color motion film/filter stack by mounting it in a rotating holder in the replay geometry previously described for color hologram replay via the means of the present disclosure and using the aforementioned Samsung/Luminus LED-based reconstruction source operated in pulsed mode.

In generating holographic images for high-frame-count movies it may be advantageous to use refreshable, erasable, reusable, or real-time holographic recording materials such as thermoplastics, certain photopolymers, or electro-holography materials and to then copy these multiple single hologram images into an angle multiplexed composite recorded in a more permanent holographic material such as a silver halide or DCG which may itself then optionally be recopied any number of times into any suitable holographic material to produce multiple final holographic films for the motion aspect of the present disclosure. This two or three step procedure avoids the expense of using large numbers of pieces (or large areas) of holographic material for recording first-generation master images because the refreshable, erasable, reusable, or real-time material may be reused for a subsequent movie, yet its second-generation copy image can be stored long-term for direct use or for re-copying into usable third-generation parts on demand. Another circumstance where a refreshable, erasable, reusable, or real-time holographic recording material, or a rapidly photo-processable holographic recording material, may be desirable is when the on-site production of holograms via the systems and methods of the present disclosure is desirable for speed or economy, for example if rapid turn-around of such holograms is beneficial, for example to enhance their utility in a surgical procedure where, for example, recently acquired tomographic scan data, such as interventional magnetic resonance or computed tomography scans, may be viewed as one or more holographic virtual images superimposed upon the corresponding scanned regions of the patient's anatomy and pathology.

There is also utility to a low-frame-count (e.g., two to ten or a few tens) angular multiplexed series hologram, such as for example the twelve frame demonstration of the present inventors, even if it is rotated slowly or is rotatable between image positions but is generally left in one such position for a comparatively long period (seconds through minutes or even months for example). Such a intermittently rotated hologram can display a number of independent (or related) holographic images in arbitrary order, such as for example four different advertisements each of which is visible to an observer or to observers for a period of a few seconds or a few minutes (sufficient time to perceive and absorb the message, meaning, or other intent of the image), with the four advertisements being shown one at a time, in any preferred or random order. Commercially, this example permits one holographic advertising device to portray four different advertisements, sharing the capital and operating costs of the display device between four different advertisements or advertisers. As another example, a twelve image version may contain one holographic image for each month of the year and may be switched to the appropriate image each month either via a timed rotational mechanism controlled by a calendrical clock or via manual intervention in the form of, for example, an on-site store employee who can unlock, remove if desired, rotate, replace if desired, and relock a cartridge, holder, or cassette as previously described the cartridge, holder, or cassette including the film or films carrying the twelve different holographic images. The monthly alterations in the displayed holographic image so achieved may involve the use of entirely different images each month, or some part or parts of the images may be made to be the same in each monthly image while some other part changes, such as for example text spelling out the name of the month.

More generally, such hologram alternators containing as few as two holographic images or as many as tens, hundreds, or thousands, wherein the changes between images are slight or complete, have utility for a multitude of applications. In the case of such alternators including tens or more of images, the mechanical and other implementation details used for motion holograms (which is expanded upon below) may beneficially be used, or other means may be substituted recognizing that intermittent or slower rotation or angular repositioning may be all that is desired. In the case of such alternators including small numbers of images, such as two through a few tens, it may be satisfactory to provide a manual means of rotating or repositioning the film/filter (or in the case of single color versions, film or films alone) such as, for example a rotatable front mechanism with index marks, ratcheting, or other registering means to indicate or enforce the correct angular positioning. Alternatively a jukebox-style or similar mechanism may be provided to store a plurality of cartridges, holders, or cassettes as previously described, and exchange them as and when desired on the front of an illumination mechanism as previously described, or, if flexible holograms are recorded on a roll, or are attached to a belt or carrier roll, the holograms may be spooled through a loose assembly of filters in a multiple-film film gate incorporating the filters. If flexible angle-dependent filters, such as holographic dichroic filters, are attached to or spooled with the flexible holograms they may be spooled through a more conventional film gate which does not itself contain the principal angle-dependent filters of the present disclosure.

In general, any of the features described herein for the color aspect of the present disclosure may also be used with the motion and/or the occlusion aspects of the present disclosure, and vice versa. For example, combining other elements or effects (such as, for example, flickering light sources or combining with shaped surrounds, other holograms, text, graphics, mists, static or moving objects, etc) may be achieved with a motion hologram or a static hologram. A particular example is combining a permanently or intermittently moving hologram or holograms with one or more non-moving or substantially static holograms, so that, for example, a large non-moving hologram may fully or partially surround or enclose or be spatially associated with one or more smaller moving holograms so that the moving or changing aspects of the resulting composite display are embedded within a larger stationary but potentially still holographic region.

For example, in the case of movies, or in the case of alternators in which a series of related images are shown comparatively rapidly, the intent is generally to tell a “story” or otherwise communicate to the observer a sequential development of the content of the imagery as the movie plays out or loops or the alternator switches images: to achieve such an aim, the previewing environment previously described should ideally be extended to include motion content so that, for example, an operator, designer, or client using such a previewing environment and desirous of telling such a story or making such a communication in a certain way can preview or “storyboard” how their story or communication develops when, for example, seen by different observers at different viewing positions or following different paths through space. This goes beyond the general experience (as previously referred to) of theater designers, sculptors of static sculptures, architects of static structures, and stereoscopic cinematographers and videographers in that the scenes and objects to be created or imaged and the observer viewing the created scenes or objects may move or otherwise change.

As another example, all the systems and methods previously described to control such image variables as brightness, color balance, white point, and contrast, and to activate, deactivate, or otherwise control or modify additional elements incorporated within, around, or adjacent to the holographic image or images, may advantageously in the case of a movie or alternator as previously described be extended or adapted to incorporate the element of time so that, for example, each frame of a movie can have its brightness adjusted relative to other frames in a progressive, planned, environment-driven, or arbitrary manner so that the movie or other story or communication flows smoothly or with such gradual or sudden changes as may be desired. This can be achieved by including mechanisms which store or generate suitable control values or states for whatever in the display device controls or causes each such image variable or additional element. Such stored values, or the procedures to generate them on the fly, can be communicated to the display device via any conventional data communications means such as, for example, via a USB data storage device or a WiFi communication, and such communication means or devices can be incorporated within or can accompany or be delivered with or for use with interchangeable films, cartridges, holders, or cassettes as previously described. And all such movie-related image variables and additional elements can be simulated or otherwise incorporated in the aforementioned preview environment so that the operator, designer, or client using such an environment can judge and influence their various effects.

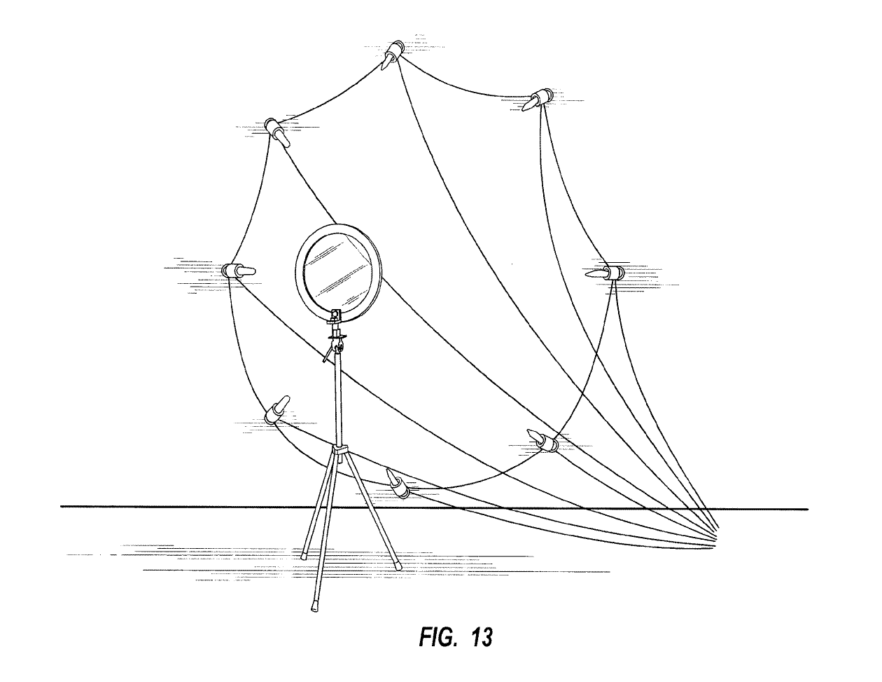

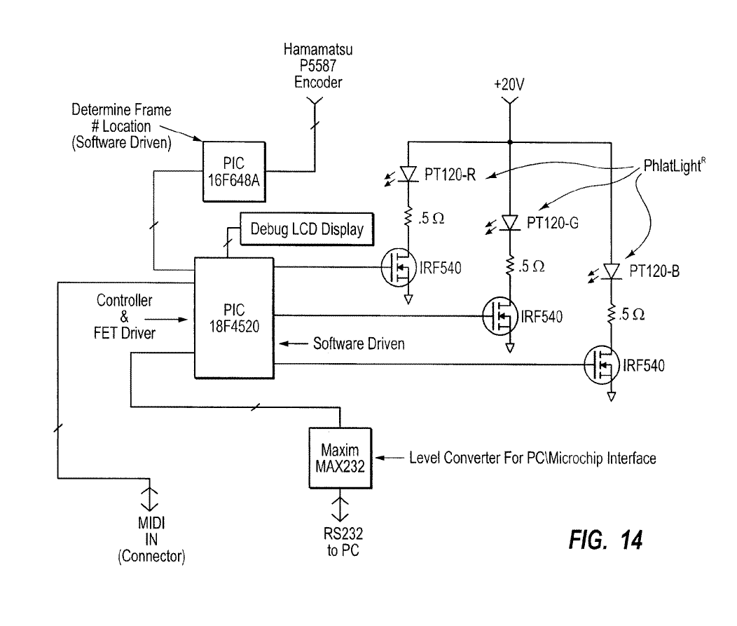

For example, in the present inventors' color motion demonstration (FIG. 14) a serial communication from a control computer via an RS232 port is used to deliver on-the-fly brightness control parameters for each frame of the movie loop, and a pattern or twelve black (absorptive) and twelve white (reflective) approximately evenly-spaced marks is applied around the periphery of the rotating mechanism with a stationary infra-red opto sensor [P5588, Hamamatsu Photonics, K.K., Hamamatsu City, Japan] positioned to read these marks as they fly by (one white mark being approximately twice the length of the others to act as a zero or home indicator) and a single chip microcontroller [PIC18F4520, Microchip Technology Inc., Chandler, Ariz.] is used to switch on and off the Luminus LEDs in response to the detection of the peripheral index marks (including the zero marker), for motor-speed estimation and slip detection, and for LED PWM durations and timings derived by the microcontroller from brightness and phase values provided for each color of each frame by the control computer which are buffered (along with MIDI note and volume triggers for pre-generated custom sound files each of which is stored in and replayed by an external Roland Fantom X6 Workstation Keyboard [Roland Corporation U.S., Los Angeles, Calif.]) from the control computer by the microcontroller using a ring buffer and a CTS/RTS communications protocol. Similarly, one or more additional or alternative peripherally distributed control track or tracks may optically, mechanically, or magnetically store and provide control values or signals for the control of other image variables or additional elements as described above.

While a sound track or triggers for sound effects may be provided in this manner, or may be delivered by other means and synchronized by control signals derived in this manner, if the rotation mechanism undergoes significant changes in angular velocity, either variably within acceptable limits or as a result of a controlled increase, decrease, or modulation in rotation rate, then the sound track or the sound effects triggered by the triggers generally benefits from retiming, for example in the case of a sound track by being pitch shifted so that even though played slower or faster it does not appear to undergo undesirable changes in pitch, or in the case of the triggers by having the current, desired, or anticipated rotation rate communicated to the sound source or its controller so that the sound effects can similarly be shortened or lengthened (and if desired pitch shifted) to maintain the desired synchronization of sound and image.

It is advantageous in the case of motion holograms for the provided sound, if any, to be spatialized at least in stereophonic sound but preferably in a surround-sound like system such as 5.1 or better theater sound. This is incorporated in the present inventors' motion demonstration, and even quite small inconsistencies between the visual movie action and its corresponding sound track or sound effects can detrimentally reduce the observer's perception of continuity, smoothness, and consistency. For this reason, the previewing environment previously described can also incorporate the simulation of the sound environment of the intended movie including its own spatialized sound and any known, predicted, or anticipated environmental or ambient sounds at the eventual location of the motion display device.

Other effects which can advantageously be incorporated in the display device, and hence for the previously described reasons in the simulation environment, include: running all or part of a movie in reverse (which can include a different sound track or sound effects, not just a reversal or repeat of the corresponding forwards sound track or sound effects); pre-rolling and post-rolling sound or other non-holographic effects or holographic effects exploiting one or more of the individual movie frames or one or more additional frames which are used for this purpose instead of or as well as forming part of one or more movie sequence where such pre/post-rolling may for example be used to extend the perceived duration of a movie or movie loop by extending the story or other communication beyond the limited actual duration of the holographic movie; reusing one or more frames of a movie or movie sequence (or even an entire movie or movie sequence) with altered timings, coloring, or other such modifications as can be obtained through alterations to the illumination sequence or the brightness (including PWM) values used for each color illuminant or the additional elements including, for example, the use of different sound tracks so that for example a “talking head” with certain lip motions and facial expressions can be synchronized with one of several different sound tracks and hence can be perceived as making one of several different speeches or other utterances; deliberately introducing flicker, pulsation, or other modulation or instability in one or more of the frames, either through the use of an additional element such as, for example, an effects wheel placed in the optical path which can be rotated to introduce one or more modifying elements into the optical path between the illumination source or sources and the holographic images (such modifying elements and resultant effects can include, for example, diffusers to soften the holographic image, prismatic elements to distort or move the holographic image, and arrays of such optical elements to alter different regions of the holographic image in different ways or to different extents), and any such modifying elements can comprise an array or progression of sub-elements or can consist of an array or progression of a mixture of such elements so as to achieve either a gradual modification to the holographic imagery or a modification which varies spatially within the holographic image) or through the modulation of the brightness of the illumination source or sources (LEDs and in general lasers can typically if necessary or desirable be intensity modulated or pulsed at rates which exceed the flicker-fusion rate).

In the case of a rapidly rotating holographic motion display implementing the present disclosure it is advisable to ensure that the front cover window on the film/filter stack is replaced or supplemented by a stationary safety window which is spaced in front of the film/filter stack or otherwise provided front window and which is of sufficient rigidity and strength as to prevent the safety window itself from contacting the rotating mechanism or any other rapidly moving element of the display device even if subjected to accidental or deliberate pressure, blows, shocks, or impacts so that the observer and other people, animals, and moving objects cannot too easily damage, or stall the rotation of, the display device or themselves be damaged by it. The optical and acoustic effects of any such safety window can be incorporated in the aforementioned simulation environment.

In unsupervised or exposed locations, such as in a bar, it is also advisable to house or package the entire display device (whether a motion device, an alternator, or a simple still image device) in such a fashion that it cannot easily be harmed by exposure to liquids or projectiles likely to be found in such environs or, when contacted by such liquids or projectiles, present any significant risk to other people, animals, materials, or objects in the environs such as for example any electrical risk, and it is also advisable that in such environs the display device (of whatever kind) should be immobilized, for example by being anchored or attached at least temporarily to walls, floors, ceilings, or other substantially immobile objects so it can neither be easily moved without authorization and tooling, nor easily stolen, nor easily be used as a projectile or other manner of weapon.

Rotation of the film/filter stack or other elements (such as the aforementioned cartridge, holder, or cassette) of a motion hologram display as envisaged by the present disclosure can be achieved in several ways. Generally slow rotation, as is generally desirable for higher-frame-count (and hence comparatively slowly rotating) movies or by simple image alternators, can easily be achieved using for example some combination of driven-roller mechanisms or belt drives (toothed or plain) or gearing mechanisms or idler rollers making contact with one or more external or internal surfaces of the rotating part.

For such rotational mechanisms it is generally difficult to support and drive the rotating mechanism upon an axis passing through its rotation axis because in general for a compact display this location is occupied by the illumination source and by associated beam folding and forming optics (it is possible to include all (or a sufficient subset of) such components within a drum-like rotating mechanism which may have a rear axle or other mounting mechanism in-line with its axis of rotation, however such an approach typically increases the rotating mass, and hence the angular momentum, which can be a disadvantage, and in such approaches it is typically difficult to bring electrical connections, for power, control, and sensing, into the inner volume of the rotating drum unless slip connectors are used, which can be costly and unreliable, whereas bringing light into such a drum from external illuminants can be achieved using windows or gaps within the body of the drum-like mechanism). Rather, it is generally advisable to provide both support and drive mechanisms disposed around the periphery of the rotating part of the device such that they do not substantially occupy, block, or otherwise interfere with the space on and around the rotation axis.

An exemplary demonstration of the slow-rotation version of the present disclosure (or of the non-rotating still image or the alternating image version), can be achieved by modifying a commercially available RPTV, such as the aforementioned LED-powered Samsung HL-T5087S or the aforementioned laser-powered Mitsubishi L65-A90, making minimal modifications to the RPTV's front screen materials so as to incorporate the film/filter stack and optionally the rotation mechanism of the present disclosure. Specifically, such an RPTV provides a scanned and color modulated spot which sweeps out a large collimated beam following a Fresnel lens immediately prior to a diffuser which diffuses light from this spot-formed beam to a wide horizontal and vertical distribution of potential observer positions. If a hole is cut in this diffuser, and the present disclosure's film/filter stack is inserted into the hole then the film/filter stack, instead of the normal diffuser is, over the area of the hole, and is illuminated by the collimated scanning-spot derived beam. The illumination then forms the desired illuminant for the present disclosure's holograms, including the movie version if suitable films and a rotation mechanism are inserted in to the hole in the RPTV's diffuser. Outside this hole, normal television images can be seen in the normal way: inside this hole the holographic image (or, in the case of the movie or alternator versions, holographic images) is seen and its (or their) brightness, white point, and color balance depend on what video signal would otherwise have been shown across the the hole. For example, if that portion of the video signal is caused to be pure white (by, for example, inserting a suitably shaped and positioned white area into the video signal feeding the RPTV) then all the component color holograms are replayed resulting in the originally intended composite color holographic image (or movie). If instead of a white area the insertion into the video signal is an area of pure red, blue, or green then only the corresponding color holographic imagery is seen. Other colors in the video signal result in altered color balances in the holographic imagery, and black corresponds to no holographic imagery. A wide range of special effects may be created in the holographic images so produced by varying the color and brightness of the insert into the video signal (which may easily be achieved using recorder pre-generated video signals, or by generating the insert signal on the fly) both temporally and spatially.

Rapidly rotating devices, as are generally desirable for low-frame-count movies, may be supported and driven by such elements as have previously been described for slow-speed rotation, but at such higher speeds other elements may be advantageous such as for example supports in the form of air bearings, electromagnetic lifting devices, or high-speed ball-bearings or roller-bearings, and driving elements such as surface acoustic wave (SAW) drives, air jets acting upon turbine-like blades or flat surfaces of the kind and disposition which are used for air-turbines of various sorts, or electromagnetic devices such as for example linear induction motors. Any such high speed rotational driving and support mechanism may be designed to fail safely if, for example, its electrical or air supply fails, is interrupted, or disturbed, or if wear and tear leads to damage or significant changes in operating parameters. Allowance may also be made for accelerating any such mechanism up to speed before use, and for decelerating it to a stop or to a slower maintenance speed after use, and for restraining any rotation during for example shipping, assembly, and storage. The large angular momentum of a rapidly rotating device can be reduced by the use of counter-rotating balance wheels or weights, or by spinning some functional components clockwise and others counterclockwise.

A low-frame-count holographic movie display which benefits from a high-speed rotation mechanism has been demonstrated by the present inventors. As described above, the component color holograms for this demonstration each included twelve holographic images at 30° angular increments. Twelve images would generally be considered too few for a movie or even a loop, however by mounting the the film/filter stack in a rapidly rotating mechanism the present inventors have created a device in which any one of the twelve images may be brought into the correct position for holographic replay in at most 1/16th of a second and hence a 16 holograms-per-second average frame rate may be achieved with the frames being displayed in any order rather than just in the sequential order of their actual angular disposition within the films. In other words, random access to each frame is provided, and via the aforementioned control computer, RS232 communication path, and on-board microcontroller with its CTS/RTS protocol and ring buffer, movie sequences may be selected in which frames were shown in specially selected orders to achieve a visually meaningful and entertaining story (FIG. 15).

Some exemplars of the present disclosure contemplate many more holographic exposures than a single instance of a hologram recorded per Hart would generally involve. Typically for the color aspect of the present disclosure, each slice as envisaged in Hart is exposed three times, once for each primary color, though in practice the present inventors have determined that some scenes or objects may contain certain colors in certain regions only so that fewer exposures may be sufficient for certain colors, especially when the occlusion aspect of the present disclosure is used. Typically for the motion aspect of the present disclosure tens or hundreds of frames are recorded, each involving tens or hundreds of slices. It is desirable to implement certain improvements and modifications to the apparatus and method as taught in Hart to better accommodate the use of larger numbers of exposures, and to improve production speed, capacity, and reliability. Several examples follow.

For example, roll film and roll holders/dispensers or cut sheet dispensers can be used in place of manual film handling. Printed labels bearing human-readable or machine-readable identifiers can be attached to films and log books to permit film tracking and to reduce the likelihood of mix ups. Such film identifiers in a visual form may also be exposed as part of a slice (or as an additional exposure) recorded in each composite hologram photographically or holographically as a reliable identifier which cannot easily or accidentally be removed. If recorded as an additional exposure, this holographic or photographic record of the identifier can fall within part of the area which otherwise could be occupied by image content in one or more recorded slices, or it may fall outside this area in an adjacent area otherwise not used for recording slice data. Automation and programmable hardware can be used to reduce the likelihood of operator error and to detect incorrect, undesirable, or unexpected system states. A “script” defining the positions, exposures, beam ratios, and other operating parameters for each exposure in a composite hologram can be automatically generated, for example by the software system or systems used to generate slice images, and such scripts and log files can be maintained with the slice images to permit accurate repetition of hologram generation and can be archived and analyzed for QA/QC purposes and to facilitate the preparation and comparison of holograms produced with different parameters. Quality and reliability can further be enhanced by incorporating an on-line densitometer or densitometer array into the film processor following its developer tank, stage, or bath to monitor the optical density (transmission or reflection) of the developed film: unexpected variations in this density can be diagnostic of, and can be used to monitor and control, under/over exposure, developer exhaustion/contamination, and incorrect developer formulation or replenishment. A similar densitometer or densitometer array following the bleach tank, stage, or bath (if used) can similarly monitor, control, and diagnose over exposure, bleach exhaustion/contamination, and incorrect bleach formulation or replenishment; or films can be removed from the processor between tanks, stages, or bath and checked with a separate densitometer.

As another example, fringe-sensing techniques generally can permit the detection of excessive motion or other disturbances during exposures, and can detect laser mode-hoping even when this is not accompanied by significant laser power changes. Fringe-locking techniques (and pulsed holography) generally can permit exposures to be made despite the presence of otherwise excessive motion or other disturbances.

As another example, some or all of the various beam-blocks, shutters, and shunts of Hart can be replaced or augmented by optical power meters which can be used to establish correct settings to achieve desired beam ratios and exposure durations prior to (or during) each exposure, which the settings may otherwise be pre-computed from power measurements taken prior to the introduction of or uncovering of unexposed recording materials, or may be pre-computed or computed as needed from pre-measured or otherwise calibrated characteristic curves for the optical, mechanical, and electrical/electronic components involved and knowledge of the pixel content and disposition of each slice. It is advantageous to use three or more shutters in the kind of system described in Hart, such that one shutter is placed soon after the laser and is usually closed except during exposures, and other shutters are placed in locations where they can be used to block or unblock a specific beam, such as the reference or the object beam, so that, for example, ratios between beam powers can be measured conveniently. Only one of these shutters needs to be able to achieve accurate exposure durations so long as at least this shutter is in a location where it can be used to block or unblock the laser beam before it has been separated into reference and object beams. If multiple shutters are used in this manner in such a system with limited or no computer automation so that the shutters are generally opened and closed manually, then it is advantageous to wire the shutter controllers together and to a switch (such as for example a foot switch) so that each click of the switch cycles the shutters between useful states such as all-open, all-closed, open for reference only, and open for object only, and this can conveniently be achieved with the Uniblitz D122 and T132 shutter controllers [Vincent Associates, Rochester, N.Y.] used by the present inventors in a hologram copying system generally as described in Hart.

The step of copying a master hologram, as taught in Hart and in the present disclosure, includes that a suitable beam ratio and exposure time be determined and approximately achieved for each exposure. The present inventors have determined that, for example, the following empirical values work well for the beam ratio and the exposure energy for copying into materials similar to Agfa 8E56: Beam ratio k=2, Exposure energy E=70 μJ/cm². The present inventors have determined that these values can be used in conjunction with a measured or estimated reference beam power at (and normal to) the recording material Pr (in μW/cm²) and a measured or estimated object beam power at (and normal to) the recording material Po (in μW/cm²) to calculate a suitable effective exposure duration t_{effective} (in seconds) for each sequential exposure recorded in materials similar to Agfa 8E56 using, for example, the following formula: t_{effective}=E/(Po+Pr).

In the case of an image-planed or nearly image-planed copy (i.e., one in which the recorded holographic image straddles or is closely adjacent to the copy film plane) these object and reference beam power values should ideally be determined for the “hot-spot” (i.e., that point or vicinity on or near the surface of the copy recording material at which the highest object beam power is found). The object light generally recorded during mastering is more diffuse and is generally much more uniform at the recording film plane, and can generally be adequately characterized at the center of the film plane or at any other convenient location where the power of the diffused object light has a reasonably constant known or calculable relationship to the power at the center of the film plane. Similarly, the reference light recorded during mastering is generally quite uniform at the recording film plane and can generally be adequately characterized at the center of the recording film plane or at any other convenient location where the power of the reference light has a reasonably constant known or calculable relationship to the power at the center of the recording film plane.

For power measurement, one or more photosensors such as photodiodes or other light measuring or estimating devices or mechanisms may conveniently be located at convenient locations in the immediate vicinity of the recording film plane. A particularly advantageous such location is directly behind the recording film at or close to the center of the platen or other film holding device or mechanism: a photosensor in this location can be used prior to the introduction of photosensitive material, or, if the photosensitive material has a reasonable degree of transparency to the recording light (as does Agfa 8E56), such a photosensor may be used during a exposure as a power monitor or to rapidly set the beam ratio at the start of an extended exposure or to determine the desired exposure duration or cut-off time. Any such photosensor may be filtered so that it has little or no sensitivity to light not used to record the hologram (such as, for example, a photographic safelight) while retaining sufficient sensitivity to measure or estimate the power of the recording light: for example, the present inventors have determined that the photodiode from a Newport 918-SL sensor [Newport Corporation, Irvine, Calif.] placed behind an VG-14 filter [SCHOTT North America, Inc., Elmsford, N.Y.] and attached to a Newport 853 optical power meter works well for materials like the Agfa 8E56 recording material in conjunction with R20 safelights [Encapsulite International Inc., Sugar Land, Tex.], and any slight leakage sensed through the VG-14 filter can be allowed for as a calibration-offset when using metered values. Photosensors may also be located around the periphery of the recording material, where they may be used to check the pointing/uniformity of the reference beam, and the object and reference powers if the readings from two or more such photosensors are suitably averaged and calibrated.

The present inventors have determined that a suitable actual exposure duration t_{tactual} (in seconds) for copying to materials like Agfa 8E56 may be calculated using, for example, the empirical fifth-order polynomial formula disclosed above for mastering on Agfa 8E56 which compensates for reciprocity failure over approximately the range from t_{effective}=0.02 seconds to t_{effective}=50 seconds. As with mastering, excessive exposure durations may be limited using reference-boost, and the other noise-reduction techniques described herein for mastering may also be used for reduced-noise copying.

The present inventors have also determined that for sequential multiple-exposure mastering in materials like Agfa 8E56 as disclosed in Hart and herein these measurements, calculations, and related steps should generally be conducted with accuracies in the range of 5 to 20% to avoid undesirable effects such as significantly reduced signal or signal-to-noise ratio, whereas for single-exposure copying in materials like Agfa 8E56 greater leeway may be assumed such that copy beam ratios of as much as 4 or as little as 1 and copy beam exposure energies between 25 and 100 μJ/cm² generally produce acceptable results in the context of the present disclosure. Multiple-exposure copying, as disclosed herein for the motion aspect of the present disclosure, is in many ways similar to multiple-exposure mastering and generally similar accuracies are desirable, and the best results have been obtained with ratios of approximately 2 and energies of approximately 70 μJ/cm².

The present inventors find it advantageous to use vacuum platens to hold holographic recording materials during their exposure. For the color and motion aspects of the present disclosure, but also more generally, such platens or other film holding mechanisms are advantageously fitted with registration pins or surfaces or other means to achieve the accurate and repeatable positioning and orientation of recording material. For the motion aspect of the present disclosure such platens or other film holding mechanisms are advantageously fitted with rotating and indexed mechanisms such as pointers, indents, guides, cams, kinematic mounts, and motor-driven or manually driven rotating mechanisms to facilitate the accurate and rapid and reliable rotation, positioning, and orientation of recording materials.

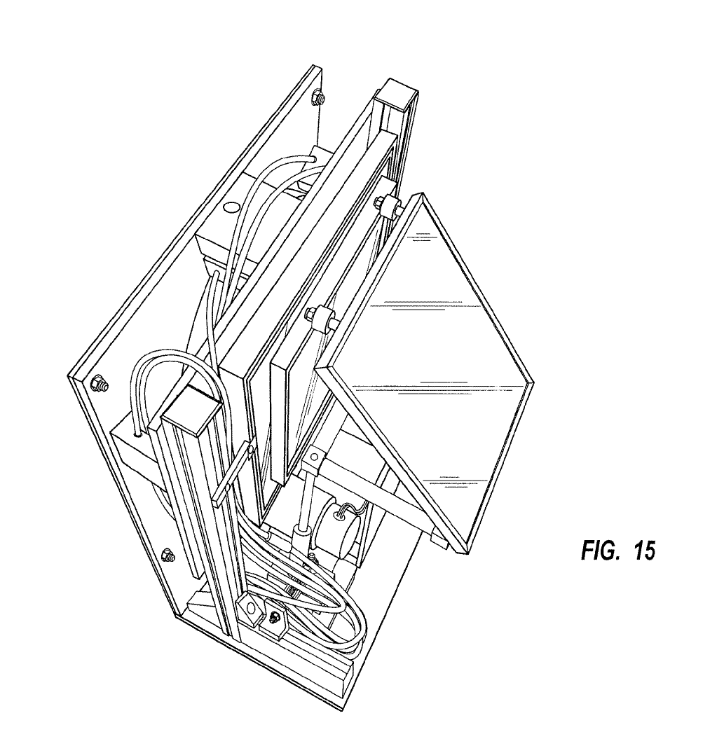

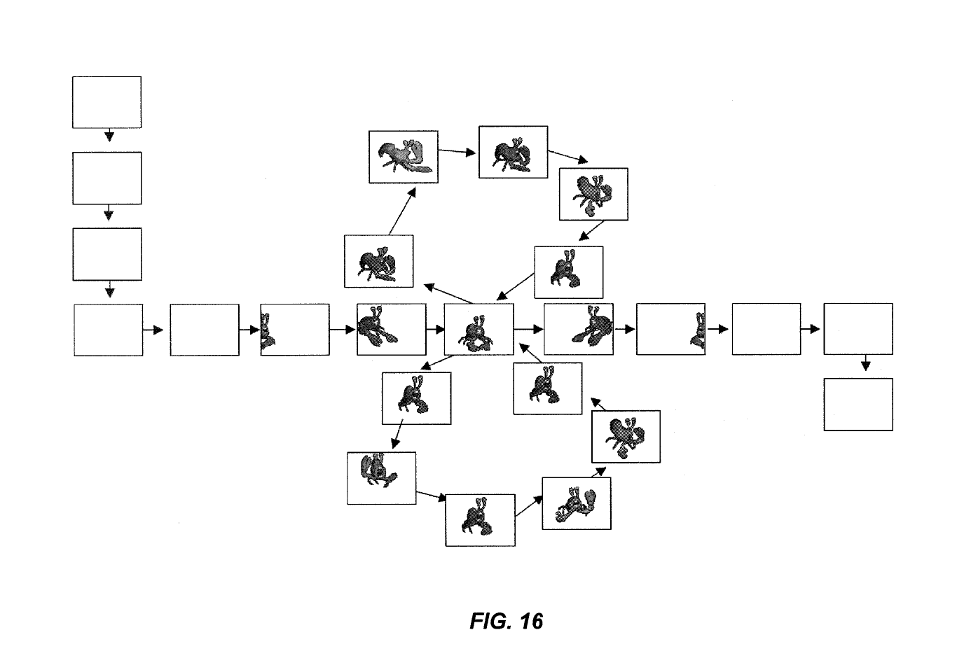

As an exemplary motion demonstration, the present inventors created a colorful animated crab-like character (FIG. 11), a three-dimensional cartoon character created and animated in Maya using about 5,500 texture-mapped polygons orthogonally rendered without specularity in a diffusely-lit environment without a background) and selected a series of eleven poses (FIG. 16) for this character which may be strung together in a number of different orders to cause the character to appear to make meaningful actions. For example, one such string of frames starts with the crab character in a neutral pose, facing forwards with claws lowered. This image is followed by one in which the crab appears to have started to jump upwards and swung his or her claws outwards with corresponding semi-realistic changes in the orientation and position of the crab's other bodily parts including the mouth, tail, and eyes. A further image in this series has the crab at the top of its jump. This image is followed with one more image as the crab descended back towards the neutral pose, and the overall sequence is completed with a repeat of the neutral pose. Similar sequences have been stitched together in a simulation environment which included stereophonic sound effects, enabling the crab character to perform a variety of actions such as, for example, entering or exiting stage left or stage right, twisting, jumping, and performing a karate chop. Short sequences of just three or four frames like this don't look choppy because for a credible motion (such as a character jumping) there is frame-to-frame content coherence (“coherence” in the Computer Graphics sense rather than the optical sense) to a sufficient degree that the visual perception is generally that of motion-blur rather than looking strobe-like.

Each of the eleven images was slabbed, sliced, feathered, shelled, had its back-faces culled, and was otherwise prepared for holographic recording as described above.

After recording, processing, and assembly into a suitable film/filter stack and display device, the holographic images are replayed in scripted or pseudo-random orders under the control of the external computer to tell respectively either a canned story or to show an arbitrarily active crab for an indefinite duration. The twelfth hologram position is used for an introductory/credit image with three-dimensional text and is shown at the start and end of the story or arbitrary crab-like activities.

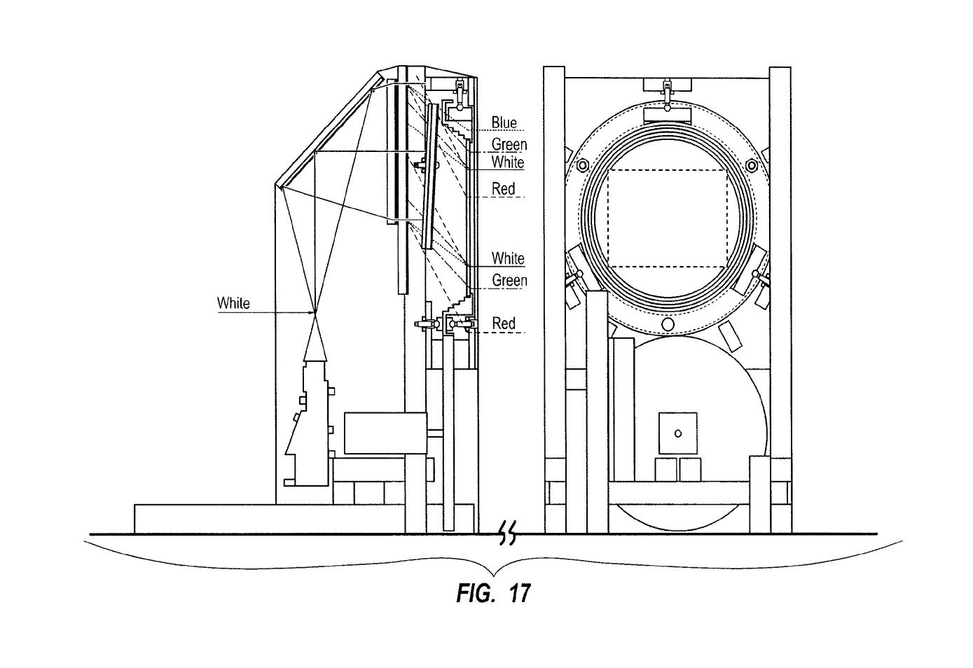

For this motion demonstration's rotary motion mechanism the present inventors designed and had fabricated a high-precession “wheel” (FIG. 17) of approximately 18.2 inches diameter CNC milled out of a 2 inch thick plate of 6061-T6 aluminum with smooth radial and axial bearing surfaces which were post-polished and hard-anodized and mated to three radial air bearings [C325003, New Way Air Bearings, Aston, Pa.] and six axial air bearings [S102501, New Way Air Bearings] to provide stiff support with very little friction when operated using dry filtered compressed air at approximately 80 psi from a Husky Q19 compressor [Campbell Hausfeld, Harrison, Ohio] fed through a filter chain consisting of an SMC AW20 moisture/particle filter, an SMC AFM20 bulk oil filter, and an SMC AFD20 fine oil mist filter [SMC Corporation of America, Indianapolis, Ind.]. A further radial bearing surface is incorporated in this wheel which is used to drive the wheel's rotation via friction contact with a custom-made large smooth plastic drive wheel of approximately 12 inches diameter (FIG. 17), itself driven by a variable speed DC motor [59835K62, McMaster-Carr Supply Company, Los Angeles, Calif.]. Speed of rotation is monitored with a peripheral track of black and white marks as previously described, and controlled by varying the current to the drive motor using a variable DC power supply [Mastech HY3050E, Acifica, Inc., San Jose, Calif.] operating in constant-current mode at approximately 8 Amps. Contact force between the aluminum wheel and the drive wheel is adjusted via a lockable turn-buckle mechanism. Spin-up and spin-down times are on the order of minutes, and operational speed may thus be monitored and maintained manually without significant deviations from the intended speed, any slight variations being sensed via the microcontroller through the monitoring mechanism so that it adjusts the illuminant flash timings to match. A circular hole was cut through the center of the wheel with provision made (in the form of a lip and holding blocks) to retain a film/filter stack at the wheel's front, sandwiched between two approximately ⅛ inch thick transparent acrylic disks, and the rear inner side of the wheel was given a stepped profile to permit angled replay reference light to illuminate a significant portion of the central region of the film/filter stack (FIG. 17). It may however be more advantageous to design such a wheel so that its film/filter stack can be removed and replaced from the front.

Care is taken to achieve good registration between the images on each film as they were holographically recorded, and between the films as they were assembled into the film/filter stack: any significant misregistration in the case of a motion hologram as described in the context of the motion aspect of the present disclosure can lead to a noticeable and generally detrimental visual oscillation in which as the wheel spins the artifacts due to misregistration vary cyclically from one edge of the imagery to the opposite edge, and if the center of rotation in the wheel is not well aligned with the center of rotation in the holograms then the entire imagery has superimposed upon it a circular translation in the plane of the films (though this later effect may not be particularly noticeable for rapidly-animated parts of the imagery, it may cause a potentially significant blurring of any stationary or slowly-animated parts).

The wheel with its bearings and drive is mounted substantially vertically onto a framework of custom cut 45 mm square-profile aluminum extrusion [FMS, Bosch Rexroth Corporation, Hoffman Estates, Ill.] to which also is attached the Samsung/Luminus illumination source (as previously described, but with the LEDs operating in series, pulse-width modulated at approximately 23.2 Volts provided by a Mastech HY3050E DC power supply [Precision Mastech Enterprises Co., Kowloon, Hong Kong] operating in constant-voltage mode) and a fold mirror to direct light from this source on to a stationary assembly of a 10.5 inch square 19 inch focal length acrylic Fresnel lens [catalog item #51, Fresnel Technologies, Inc., Fort Worth, Tex.] and other materials repurposed from a Model-22 Voxbox display including a holographic grating and two sheets of 3M LCF all substantially as previously described above in the discussion of the demonstration of the color aspect of the present disclosure (FIG. 17). The whole optomechanical assembly is normally enclosed within black-painted approximately ⅛ inch plywood skins attached to the FMS framework, with an approximately circular hole in the front skin into which is fitted the front of the aluminum wheel behind a ¼inch thick transparent acrylic plate for safety. Two sheets of LCF are used with an air gap of approximately ¼inch between them because the present inventors have observed that a single sheet of LCF used in this manner is often inadequate due to the presence of pinholes and other defects and non-uniformities (problems which are easily avoided in the manufacture of Voxblock material as described below) and because if 3M LCF is adjusted to optimally transmit the green replay reference then the red replay reference, which in this demonstration device generally passes through at a steeper angle, is in part reflected off the top side of the slats within the LCF and propagates towards the hologram observer resulting in a comparatively bright red background upon which the hologram is observed (this problem does not occur with Voxblock material): a second sheet of LCF is disposed to catch this reflected red light and it is unlikely that pinholes or uniformities in one sheet are aligned with similar defects in the other sheet so that the combination of two sheets can render such defects substantially less significant. The LCFs, the grating, the Fresnel, and the fold mirror were all held in tiltable frames (black Sectional Metal Frame Kit [Michaels, Irving, Tex.]) so that the effect of tilting them in various combinations can be investigated and a satisfactory optimum tilting was determined experimentally. In a design such as this the different dispersion-compensated reference angles for each color reference beam cause the area over which all such beams are available to light hologram films to shrink as any gap between the diffraction grating and the films is increased. Hence it is advantageous to minimize any such gap, which in this demonstration is achieved by inserting the entire LCF assembly into the wheel's central opening and positioning the diffraction grating as close to the rear of the wheel as is felt to be adequately safe.

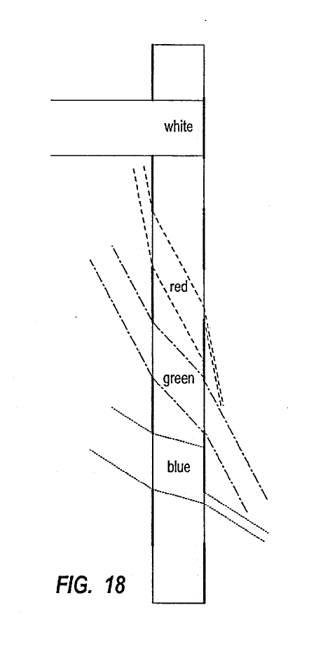

The inherent advantages of Voxblock material when compared with 3M's LCF arise because of their very different internal structures. LCF is constructed somewhat like a miniaturized venetian blind. The slats of this internal structure are substantially opaque (though often inadequately opaque due to inadequate optical density within the slats and the occasional presence of pinholes, rips, or other defects in these slats) and, in 3M's angled LCF materials, these slats are positioned at a somewhat tilted angle (and, unfortunately, generally rather an inconstant angle, typically specified as ±8°) with respect to the outer surfaces of the LCF sheet so that light can pass through at an angle between the slats relatively unimpeded, but light which falls substantially normally incident upon the sheet is intercepted by the slats and is substantially absorbed (though a portion of it, especially of the red component of such light in the case of LCF used to implement Bazargan's device, reflects and scatters off the slats and escapes through the LCF sheet at unintended and somewhat scattered angles). Voxblock material consists of two planar layers, which are separated by a thin and substantially constant thickness of substantially transparent material, and which each bear a pattern of parallel opaque lines with substantially transparent spaces between these lines (FIG. 18 shows an example in cross-section). The opaque lines on each layer run substantially parallel to those on the other layer but are offset so that when the combined layers are viewed normally (i.e., from a direction perpendicular to their plane) the opaque lines in one layer lie over and thus cover the transparent lines in the other layer, and vice versa. The opaque lines are slightly wider than the transparent lines, so the combined effect of the two layers is to block essentially all light incident normally upon either layer (ignoring a very small proportion of such light which diffracts around the edges of the lines), whereas light incident on either layer at off-normal angles can in part pass through the transparent lines of both layers and thus be transmitted through the Voxblock. The average transmittance of light through a sheet of such Voxblock cannot exceed one half because at least one half of it may be intercepted by the opaque lines. But in practice Voxblock suitable for the present disclosure is very easy to make (as is described below) whereas 3M's LCF appears to be very difficult to make to the extent that when one allows for its variations inter-sheet and intra-sheet, and the resulting use of two sheets in the context of certain embodiments, it is the experience of the present inventors that the actual transmittance of Voxblock in the context of the present disclosure is generally quite similar to that of LCF.

Voxblock may easily be manufactured by first using a conventional printing or photographic technique, such as, for example, inkjet printing or laser printing, to print or record on to a thin substantially transparent plastic sheet a first pattern of parallel substantially opaque lines. A suitable sheet thickness is, for example, approximately 6/1000 inch, and sheets of suitable polyester of this thickness are easily available with high uniformity and excellent optical quality [e.g., Mylar®, DuPont Teijin Films U.S. Limited Partnership, Hopewell, Va.]. A suitable width for the opaque lines is, for example, approximately 12/1000 inch, and a suitable width for the transparent spaces between the opaque lines is also, for example, 12/1000 inch. Next, under photographic darkroom conditions, a sheet of photographic film is laminated or otherwise fastened or sandwiched on to the un-printed side of the first sheet, using, for example, an optical quality lamination adhesive which is pressure or thermally activated or optically activated by a wavelength range of light which does not create a latent image in the photographic film, and with the photosensitive layer on the outside. A suitable photographic film is a very high-contrast (“lith”) negative film coated on an approximately 6/1000 inch thick polyester substrate such as, for example, Camera 2000 CGP [Eastman Kodak Company, Rochester, N.Y.]. Next, the opaque lines printed upon the first sheet are contact printed into the photographic film using substantially collimated light incident substantially normally upon the first sheet, and the laminated sandwich comprising the first sheet and the photographic sheet is photochemically processed so that the exposed areas of the photographic sheet become substantially opaque and the unexposed areas of the photographic sheet stay substantially transparent. The desirable small overlap between the printed lines on the first sheet and the photographically created lines on the second sheet naturally occurs due to diffraction of a small proportion of the collimated light around the printed lines, but the photographically printed lines have quite sharp edges because of the inherent high contrast of lith film. Any pinholes or other somewhat transparent defects in the printed pattern are automatically matched to slightly larger corresponding substantially opaque areas in the photographically created negative image of the printed pattern, and similarly any substantial deviation from parallelism in the printed lines is automatically substantially matched in the negative image: hence substantial errors and defects in the original line pattern can be tolerated. If the optical density of the original line pattern is unsatisfactory an intermediate contact copy of it can be made in positive or negative lith film without the lamination step, and the copied pattern (or negative thereof) on this intermediate film exhibits the high optical density characteristic of lith films so that this intermediate copy can be used in place of the first film.

The angle dependent behavior of Voxblock made in this way can easily be calculated, allowing for the refraction of light into and out of the various layers, and can be tuned for a wide range of performance characteristics by varying the line width and spacing and by selecting photographic films, plastic sheets, and lamination materials of different thicknesses, or, if desired, by reversing the first sheet so that its printed surface is towards the inside of the sandwich. An experimental sheet of Voxblock can easily be manufactured in which the performance varies across the sheet, and such a sheet was used to select optimal Voxblock manufacturing parameters for the present inventors' applications.

More generally, there are benefits to be obtained by controlling the propagation of visible light or other types of radiation as a function of angle within such fields as, for example: displays, holography, illumination, lighting, aperture coding, analog, digital, and computational photography, integrated optics, light-field imaging/display, metamaterials, transformational optics, window dressings, automotive, marine, and aerospace lighting and indicators, microscopy, the control of scatter, security and privacy shields and treatments, HUDs, signage, copy/counterfeit control, prevention, and detection, and optical effects for artistic and scientific endeavors, entertainment, education, decoration, and research.

One way in which this may be achieved is to allow or cause radiation to interact with a material, structure, or assembly bearing upon one face or internal surface a pattern and upon a second face or internal surface a second pattern wherein the patterns comprise arrangements of sub-elements which affect the propagation of radiation in different ways or to differing degrees and wherein the effects of the first pattern when combined with the effect of the second pattern produces a combined effect which is different in kind or degree to that produced by either pattern alone.

For example, if the radiation comprises visible light, and a first pattern comprises a regular interleaved pattern of transparent lines interspersed with opaque lines upon a first surface of a transparent material, and a second pattern is substantially similar to the first pattern and is positioned upon a second surface of the transparent material such that the light initially is incident upon the first surface and is hence partly blocked by and partly transmitted by the first pattern and then after further propagation is incident upon the second surface where it is partly blocked by and partly transmitted by the second pattern, then components of the light which are incident upon the first surface at or near a certain angle may be transmitted through the two surfaces to a degree whereas components of the light which are incident upon the first surface at or near a second angle may be transmitted through the two surfaces to a different degree.

The net effect of two or more such patterns on two or more surfaces, wherein each pattern alters the propagation of radiation, may be the result of the combination of such classical and quantum phenomena occurring at, within, or adjacent to sub-elements of one or more of the patterns as, for example, refraction, reflection, transmission, absorption, diffraction, scattering, speckling, changes in the state or degree of polarization, spectral or temporal filtering, spontaneous or stimulated emission, fluorescence, redirection, and rotation, and may further be affected by coherence, entanglement, resonances or other interactions between the radiation and/or the patterns and/or between their sub-elements or other materials upon which or within which the patterns occur.

While the overall effects have so far generally been described assuming transmission through both patterns, similar effects may be obtained in reflective and transflective modes. Similarly, in place of visible light, other forms of penetrating or reflective radiation may be employed including broadband, narrow band, or monochromatic electromagnetic energy from sources such as one or more LEDs, lasers, quantum dots, arc lamps, incandescent lamps, fluorescent lamps, or gas-discharge lamps and of any frequency or wavelength, partially or fully polarized or unpolarized, including wavelengths generally referred to as ULF, radio, microwave, terahertz, infrared, ultraviolet, x-ray, and gamma-ray, and other energies or particles such as are used in, for example, electron-beam imaging and lithography, projection and tomographic imaging including ultrasound, CT, MR, PET, and SPECT, and radiation treatment including x-ray, e-beam, and proton therapy.

An example which has been found useful in the context of display holography consists of a thin, substantially planar and flexible material, such as a sandwich of substantially coplanar layers of substantially transparent plastic materials, upon one surface of which sandwich is formed a pattern of substantially parallel substantially opaque lines interspersed with substantially transparent lines of approximately equal width to the opaque lines, and upon another surface of which is formed a substantially similar pattern. If in such a material the lines in the first pattern run substantially parallel to the lines in the second pattern and a substantially collimated beam of light is incident upon the surface bearing the first pattern at or near a certain angle such that parts of the beam pass through the first pattern and other parts are blocked by it and the transmitted parts then pass through to the second pattern which is disposed relative to the first pattern such that its opaque lines substantially blocks the parts of the light transmitted by the first pattern then for that angle the patterns will substantially block transmission of light, whereas light in a beam at a different angle may pass through the transparent lines in both front and rear patterns and hence be substantially transmitted therethrough. In effect, such a material forms an anisotropic transmitter for which the degree of transmission of an incident beam will vary in a substantial manner depending upon the angle of incidence in a plane perpendicular to the patterns' lines while varying to a lesser degree depending upon the angle of incidence in a plane parallel to the patterns' lines.

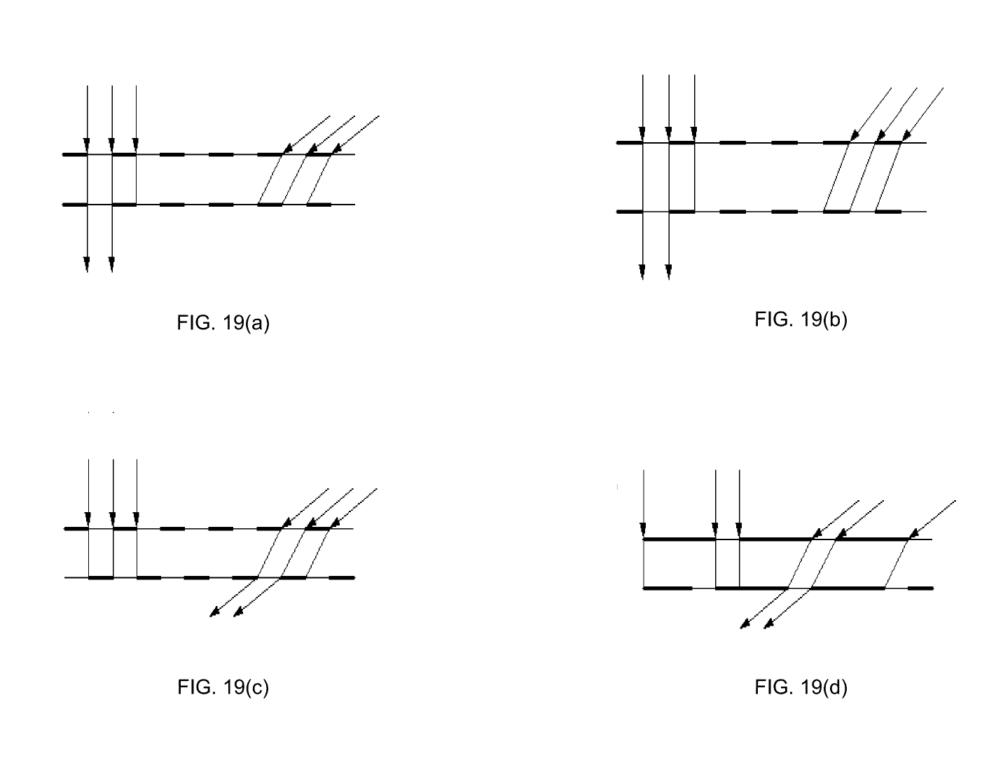

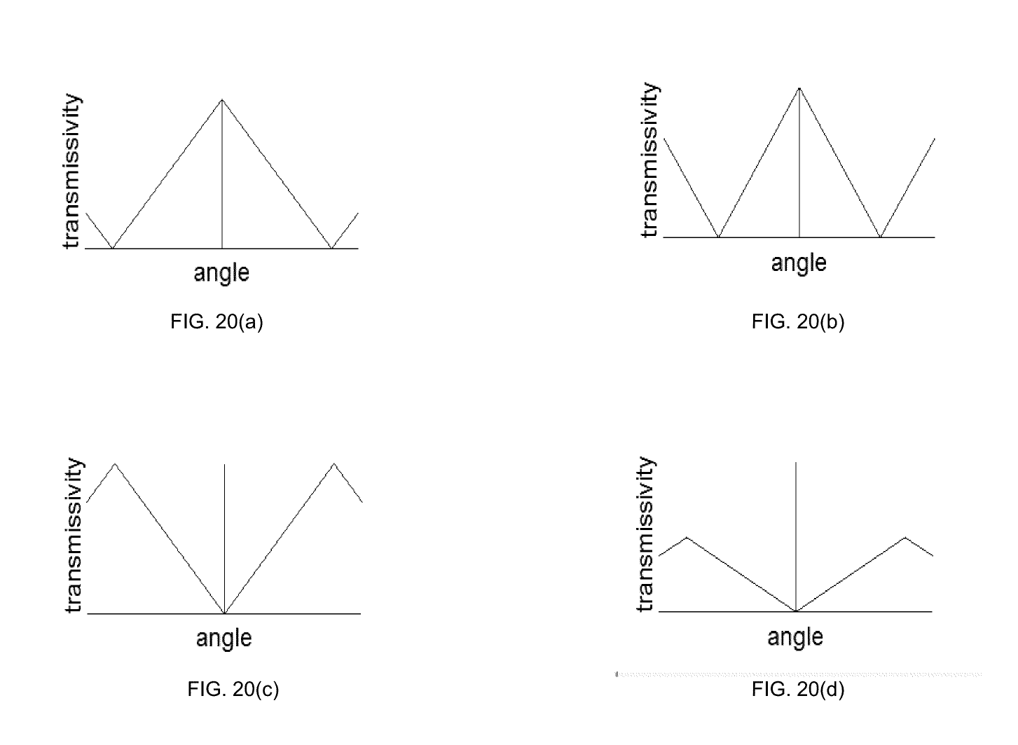

An example of two such beams incident at different angles upon such a material is illustrated in cross-section in FIG. 19(a): one beam in this figure is almost entirely blocked by the combined effects of absorption at the two surfaces, whereas the second beam at a different angle is partially blocked and partially transmitted such that up to one half of its energy is transmitted. FIG. 20(a) illustrates the net transmission of a structure such as that in FIG. 19(a) as a function of the incident angle of the beams for a certain range of incidence angles. A second example illustrated in cross-section in FIG. 19(b) has a greater spacing between front and rear surfaces and transmits a narrower range of angles than the structure of FIG. 19(a), as shown in FIG. 20(b). A third example illustrated in cross-section in FIG. 19(c) has the same front-to-back spacing as the structure of FIG. 19(a) but the back pattern is arranged with an offset with respect to the front pattern [there is essentially no such offset in the structure of FIG. 19(a) or FIG. 19(b)], resulting in a shifted angular dependence of transmission as shown in FIG. 20(c). A fourth example illustrated in cross-section in FIG. 19(d) uses the same manner of offset as the structure of FIG. 19(c) but with opaque lines which are wider than its transparent lines [the opaque and transparent lines have substantially equal widths in FIGS. 19(a) through 19(c)], and in comparison its angular transmissivity as shown in FIG. 20(d) features reduced transmissivity where it does transmit and ranges of angles of substantially blocked transmissivity.

A wide selection of angular anisotropies can be achieved by suitably selecting the relative widths of transmissive (clear) and opaque (dark) lines in each pattern and the spacing between the two patterns, either as a result of experimentation or calculation or a combination of both methods.

If in these examples the patterning elements are sub-areas which rather than differing in net transmission (i.e., opacity or optical density) instead differ in some other property or properties such as for example spectral transmission or polarization dependence then the angular variation achieved may be a modulation of this property or properties rather than of net transmission. For example, if the patterns consist of lines of red filter interspersed with lines of blue filter then at any particular angle different proportions of red and blue will be transmitted: at some angles neither may be transmitted, at others primarily or exclusively red, and at others primarily or exclusively blue.

While the overall effects have so far generally been described assuming transmission of a substantially collimated or parallel beam, such materials may also be used with divergent or convergent beams or with light directed in more complicated spatial manners such as, in extreme cases, wavefront reconstruction (holography) or diffuse or pseudo-diffuse light. Even in such cases, benefits may be derived from modulating the radiation as a function of angle using suitable pairs or series of patterns either through the interaction with the patterns in a fashion which varies across the profile of the incident radiation or by varying the patterns spatially so that their effect is substantially constant across the resulting beam or varies in a desired way as a function of position.

For example, a divergent beam may be blocked with an angular dependence similar to or identical to that for a collimated beam if the patterns used vary in size, shape, offset, phase, or some combination thereof across the patterned surfaces. In this and other cases, including the simple examples already given, the localized patterns and their variations across their surfaces can be designed and optimized by intuition, especially in simple cases, or by using such tools as CAD or optical design programs and mathematical optimization techniques, optionally combined with or supplemented by experimental verification and feedback.

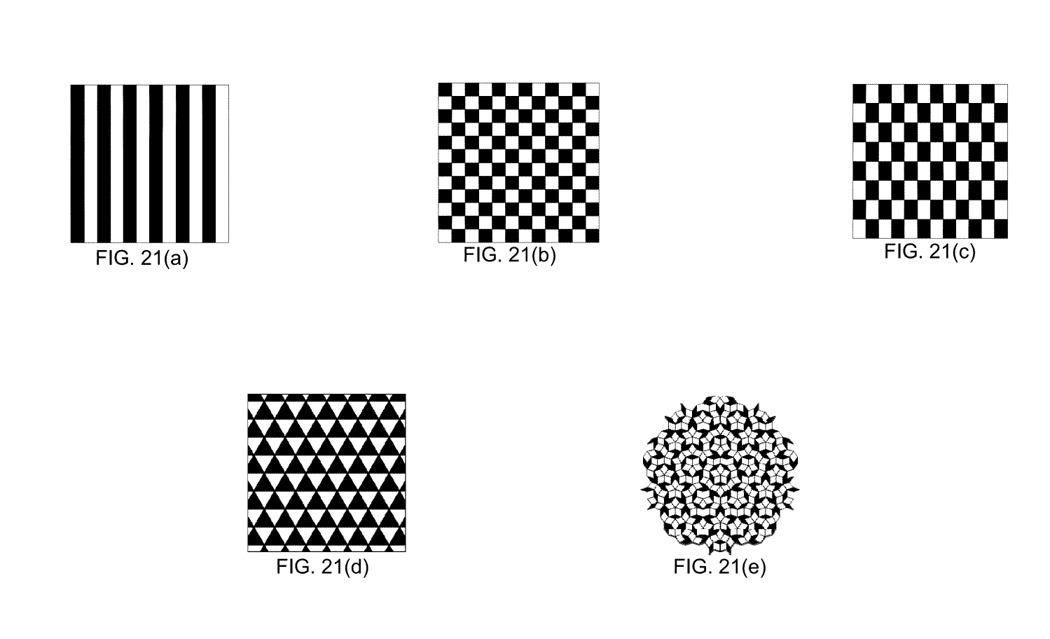

Further, the useful patterns may be arbitrarily complicated rather than the simple patterns of opaque and transmissive parallel lines as used in FIG. 19(a) through FIG. 19(d) and shown (not in cross-section) in FIG. 21(a). For example, the parallel line patterns described of FIG. 19(a) through FIG. 1(d) and FIG. 3(a) provide an angular dependent blocking in one direction (perpendicular to the lines), but in the other direction (parallel to the lines) they introduce no angular dependence, and at directions between these two extremes they introduce a proportionately lesser angular dependence. Substituting checker-board patterns changes this angular dependence to a two-dimensional dependence with substantially similar performance in the parallel and perpendicular directions if a checker-board of squares is used as in FIG. 21(b), or with a different angular dependence in the parallel and perpendicular directions if rectangles are used as in FIG. 21(c).

This can be extended from a one-dimensional dependence using parallel lines, to two-dimensions using a checker-board pattern, to, for example, a triangular tiling as in FIG. 21(d), or other regular tilings such as triangular or higher orders of Archimedean tiling, periodic and aperiodic, edge-to-edge or not, and even on planar surfaces, more complicated patterns may be used, such as Penrose tilings as in FIG. 21(e), fractal tilings, and stochastic, semi-stochastic, or pseudo-stochastic patterns, and the range of available patterns increases even further if one or more of the patterned surfaces is curved or otherwise non-planar such as for example in the form of or combining forms of conical sections, general aspheres, NURBS, and stepped profiles such as a Fresnel element or a one or two-dimensional lenslet or mirror array.

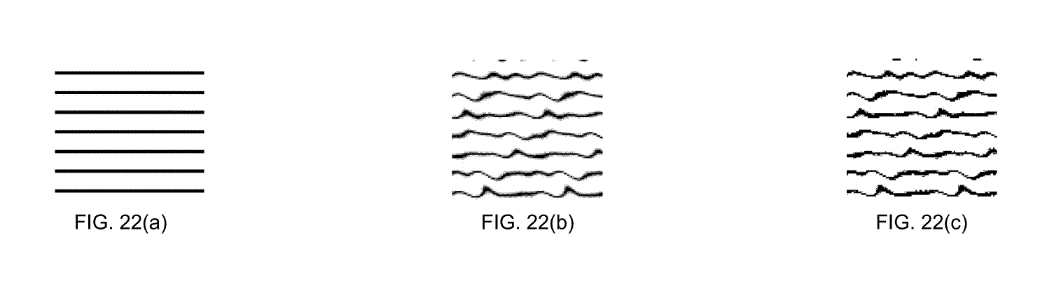

Such more complicated patterns may be used to achieve or fine-tune the desired angular effects, but they may also be used decoratively or to reduce the effect or visibility of periodic or random errors in one or more patterns (such errors being either correlated between the patterns or independently varying), or to accommodate production limitations or inconveniences such as the physical capabilities for pixel- or dot-placement and size, absolute or relative, of the printing mechanisms or systems used to produce or reproduce the patterns, or to achieve an average performance across some area of the patterned surface. For example, in place of the parallel lines shown in cross-section in FIG. 19(a) through FIG. 19(d) and shown not in cross-section in FIG. 21(a) and FIG. 22(a), a rippled pattern may be used such as in FIG. 22(b), or a step-wise approximation thereof as in FIG. 22(c), producing a spatially-varying angular dependence in transmission which may differ in detail, even in the non-perpendicular direction, from that which would be produced by any straight-edged pattern including for example the pattern of FIG. 22(a) which has approximately the same average line width as the patterns in FIGS. 4(b) and 4(c).

Further, it is not necessary that the patterns used be purely or substantially binary in nature (that is, for example, substantially transmissive areas combined with substantially opaque areas). Rather, a gray-scale patterning may be used, as in FIG. 22(b), either deliberately to achieve specific desired effects or because perfectly-sharp transitions cannot in practice be achieved (or cannot be achieved at an acceptable cost and yield) because, for example, the pattern is created using a mechanism which, at the required feature scale, creates imperfect transitions (e.g., an inkjet printer will produce a slightly soft edge because some ink droplets will fall where ideally they should not, and because such droplets produce rounded rather than square-edged features) or the material the pattern is created within itself has a sub-structure (such as the grain structure of a photographic film or the addressing structures of an active-matrix electro-optical device). And if opacity is not the sole or predominant or actual modulated function of the pattern, but, for example, color is used instead, then the pattern may contain intermediate values of this function such as color hues which lie between two predominant colors.

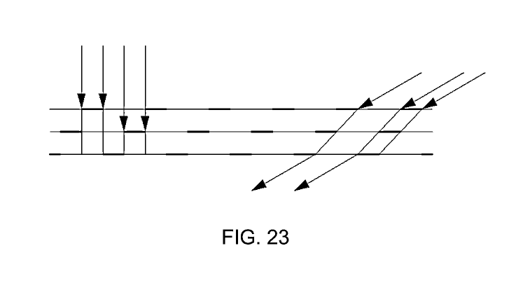

The examples given above generally have involved two patterned surfaces, but three or more patterned surfaces may be used to produce the desired effects or to achieve performances which cannot satisfactorily be achieved using two layers. For example, FIG. 23 shows a cross-section of a three-layer structure which, for the angle at which it achieves maximum transmission, can have a significantly higher net transmissivity than the two-layer structure of FIG. 19(c) but which blocks normally incident light substantially as well as, or even better than, the structure of FIG. 19(c).

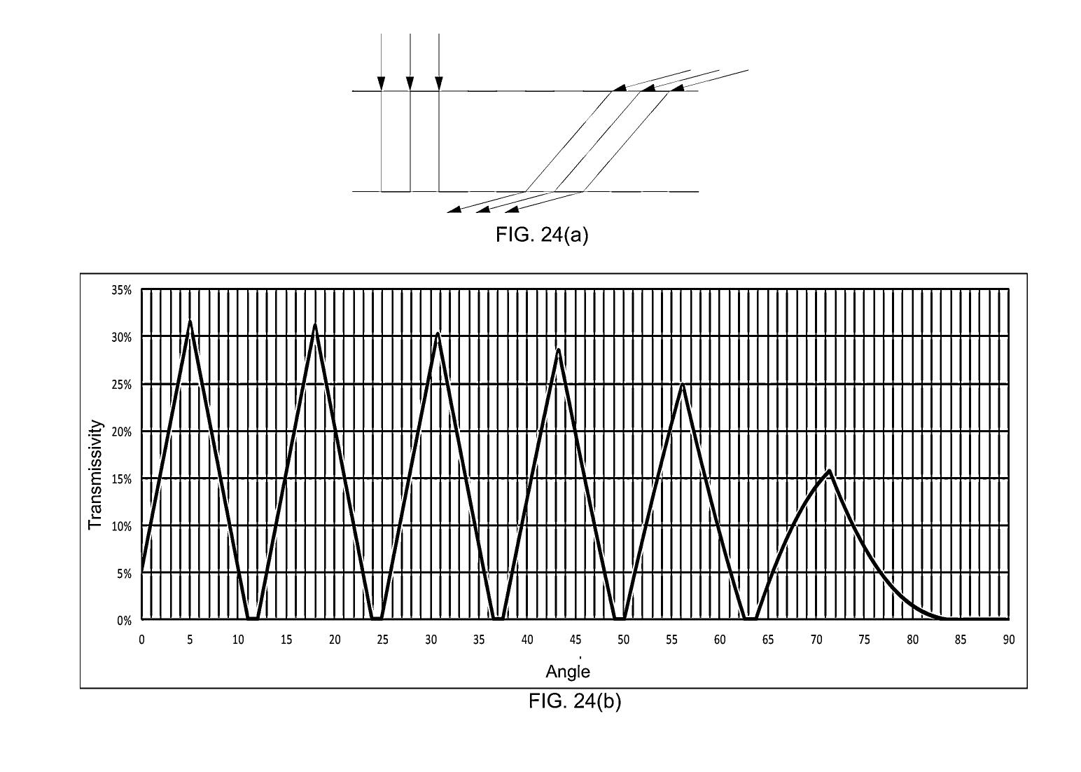

The patterns of FIG. 19(a) provide an angular dependence of transmission (or of some other property or properties) as shown in FIG. 20(a) which exhibits a peak, providing substantially greater transmission, for example, at and around one angle [approximately 0° in FIG. 20(a)] when compared to the transmission, for example, at other angles. Herein such a feature is referred to as a “passthrough”, and FIG. 20(a) through FIG. 20(d) show passthroughs centered at approximately 0° or double passthroughs symmetric about approximately 0°. However if the beam is tilted to even greater angles it becomes possible for it to pass through another gap in the second pattern as shown in FIG. 24(a), resulting in a second passthrough. In fact such a material will feature a symmetry, with a first passthrough or pair of passthroughs for which a transmitted beam passes through a transmissive area of the first pattern and then passes through the closest transmissive area or areas of the second pattern, and potentially with secondary passthroughs to one of both sides of the first passthrough or passthroughs for which the beam passes through the next closest transmissive areas of the second pattern, followed by potentially tertiary passthroughs for the transmissive areas beyond these, and so forth for higher-order passthroughs, and the number, strength, and angular position of series' of such further passthroughs will depend on the line widths and spacings of each pattern and the spacing between the patterns in a predictable manner [e.g., as illustrated in FIG. 24(b)] and may be different for series on each side of the first passthrough or passthroughs.

In general, these secondary, tertiary, and higher order passthroughs will be decreasingly transmissive for geometric reasons which will be evident from examining the figures herein, and because energy passing through them must generally travel through greater amounts of transmissive material which, in practice, will be imperfectly transmissive. And passthroughs which might be thought to occur on purely geometric grounds, may in fact provide negligible transmissivity because of the effects of Total Internal Reflection (TIR) at one or more surfaces of or within the material upon which or within which the patterns occur. The occurrence of this TIR limit may be used to terminate or interrupt an otherwise overlengthy series of passthroughs: in particular, if by design or by accident or by a necessary or convenient feature of manufacture the material upon which or within which the patterns occur contains a transition from a region with one refractive index to a region with a substantially different refractive index then the TIR limit can occur for quite shallow angles. For example, the inclusion of a thin air or vacuum gap within the material upon which or within which the patterns occur can eliminate unwanted passthroughs. Such a gap may be made mechanically stable by the inclusion within it of fixed support structures, such as columns or pillars or walls, or of loose materials such as spheroids. If such a gap includes an active electro-optic or thermo-optic layer, such as a liquid crystal, its TIR inducing effects may be selectively enables or disabled to a greater or lesser degree in a permanent or adjustable manner.

Secondary passthroughs may be used to serve purposes analogous to the first, central, or primary passthrough or passthroughs, or may be put to other uses. If the presence of one or more such secondary passthroughs is disadvantageous for a particular purpose it may be blocked partially or fully by TIR or by one of several other means, permanently, occasionally, cyclically, or temporarily: for example, a second bi-patterned material of the nature herein described may be placed before, after, or within the first such material (including potential between the patterns of the first material), with or without intervening air, vacuum, or material gaps, such that one or more passthroughs (including potentially what has been described as the first passthrough or passthroughs) is or are blocked permanently, occasionally, cyclically, or temporarily and partially or fully by this addition or additions. Suitable such second materials include the patterned materials described herein, and other anisotropic transmitters such as louvered films, wire grids, fiber-optic arrays, hole or tunnel arrays, and materials bearing or containing a single pattern rather than the two or more patterns of the materials herein described.

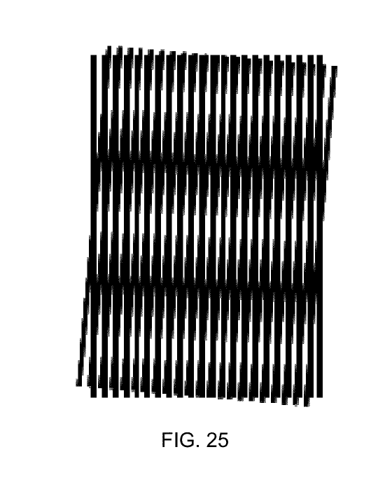

When two patterned elements are used in combination it is possible for moiréing to occur, as illustrated in FIG. 25, especially if they contain features of similar or identical size or with repetitive features which occasionally occur in actual or near synchrony between the two elements. Moiréing may be used beneficially: for example, it may provide a visually interesting optical effect, and it can be a sensitive indicator of the exact positioning of the elements and of their physical state, such that it can be used as a position, stress, strain, or rotation sensor or as an indicator or meter of some physical variable or of one or more threshold values or ranges of such a variable, as, for example, a thermometer, pressure meter, microphone, accelerometer, or smoke detector.

Moiréing may generally be reduced or eliminated by one of several means: for example, the dimensions of one or more of the patterns of one or more of the materials may be changed, their spacing may be changed, and their positions or spacings may be rendered with slight periodic or random offsets. Increasing the spacing between the elements will usually reduce the appearance and strength of moiréing, as may the introduction of a rotation between them, and any of these changes or modifications may be caused to vary in a time-dependent or spatially-dependent manner, so, for example, one or both elements may be vibrated or otherwise displaced in a random, pseudo-random, or periodic manner.

Moiréing may also occur between one material of the kind described herein and any other repetitive or regular feature of another element or other elements of the system within which such a material is present. For example, if such a material is overlaid on a pixelated display, such as an LCD screen, moiréing may be observed, and may be used, reduced, or eliminated, for example in one or more of the ways described herein.

To produce materials such as those described herein it is generally necessary to achieve a certain pattern on a first surface, a related pattern on a second surface, and if necessary one or more further such patterns on one or more further surfaces, all with sufficient positional accuracy and with the necessary degrees of transmission and absorption or scattering properties to achieve the desired angular variation in transmission (or, mutatis mutandis, reflection, transflection, or scattering). If the feature size of the patterns is large and a simple variation in for example net transmission is desired then this may be achieved in a variety of ways: for example, black lines may be printed on one side of a sheet of transparent glass, and a substantially identical pattern of black lines may be printed on the other side in approximate spatial registration with the first lines. If the lines are broad their registration may generally be achieved with sufficient accuracy, and if they are printed using dense printing inks or dyes then sufficient opacity and clarity may generally be achieved in respectively the opaque and the clear regions. In practice it is generally more difficult to achieve sufficient registration accuracy if a pattern of thinner lines, or more generally a pattern with smaller feature sizes, is required: as registration accuracy is lost the calculated, anticipated, or desired angular dependence will change in detail, and eventually if the registration is poor enough the principal features of the angular dependence will change substantially and may even be lost.

Similarly, it may be difficult to create the patterns with sufficient quality, and effects which are proportionately inconsequential for a large feature size (or for a simple function) may grow in significance as the feature size shrinks (or the subtlety of the desired function increases). For example, the simple geometrical paths shown in FIG. 19(a) through FIG. 19(d) assume that the feature sizes are large compared to the wavelength of energy used: if the feature sizes are considerably reduced they may become so small that diffraction and other physical-optics effects such as speckle become significant.

In particular, it is commonly desirable that the feature size be small enough to impart no significantly discernible spatial variation across all or some part of the beam: for example, in a display application it may be desirable that the patterns be made so small that they effectively cannot be seen by the unaided eye even at their anticipated closest viewing distance: adequate performance in such applications may, for example, demand feature sizes and pattern separations on the order of a few 1/1000″ (tens of μm), registration accuracies of a few percent of this feature size, and opaque lines featuring transmission densities of 1.5 or more combined with clear spaces with transmission densities of 0.1 or less. For a given angular performance, a smaller pattern size requires a smaller inter-pattern gap and hence may be achieved with a thinner material, which may itself be advantageous. But at these small scales diffraction and scatter can be significant at the edges of the patterns and may reduce the effectiveness of the pattern elements, and the physical thickness of the patterns themselves may become a significant proportion of the overall thickness of the structure.

It has heretofore proven difficult to achieve the combination of small feature sizes, high registration accuracies, and strongly different properties in the different parts of each pattern (such as both low and high densities) using equipment, materials, and processes of adequate reliability and yield and at acceptable costs. For example, most printing mechanisms print one side at a time, and invert the material for a second pass if they are capable of two-sided printing, but achieving accurate registration of small features with such an inversion process can be difficult; perfecting printers print both sides without inversion, but generally are used for opaque inks on opaque materials and also cannot generally achieve sufficient front-to-back registration; mechanical methods such as scribing, stamping, and cutting are typically applied one-side at a time and generally are similarly limited in registrational accuracy; laser etching or ablating can achieve suitable accuracy on one side at a time, but generally cannot be through-focused to mark the other side and generally at the feature sizes of interest cause damage to the unmarked regions, much as inkjet printers tend to deposit some ink in the gap between narrow lines; micro-printing, as is sometimes used for bank-notes, can achieve high degrees of accuracy, but with limited front-to-back registration, and is generally used on opaque materials. Hart and Mailand (U.S. Pat. No. 5,675,437) teach methods for stacking and aligning multiple sheets each one of which bears a suitable pattern as a result of a printing or photographic process including contact-copied photographic patterns.

One aspect of the present disclosure provides a solution to this problem by, in general, using photographic or similar copying means to make one or more replicates of an existing, potentially imperfect, pattern such that its replica or replicas is or are inherently well-enough aligned and may have reduced or otherwise altered imperfections. For, whereas for the purposes of providing an anisotropic material it may be difficult, costly, inconvenient, or even practically impossible to manufacture independently two related patterns of sufficiently high quality and accuracy or to align and affix them positioned relative to one another with sufficient accuracy, yet it may be comparatively easy in practice to manufacture one such pattern and then via photographic, mechanical, or other reproductive means generate a second (and potentially a third, fourth, etc) substantially matched pattern from the first the pattern, depending on features of the reproductive means to achieve a satisfactory degree of correspondence between the patterns and a satisfactory degree of registration between the patterns.

These replication methods may also be applied when the desired feature size and inter-pattern performance variation are not so small. They enable certain other advantages in that, for example, they may be applied for elements with large overall dimensions, such as thin sheets with dimensions on the order of a meter or more (and since clean edges may be achieved, even larger areas may be covered via tiling), and in their compatibility with cost effective and rapid production configurations such as roll-to-roll production. And they may involve low-cost and quite easily designed or selected and fabricated or procured tooling, materials, and setup procedures so that custom, special, or short-run materials may be made with reduced lead-times and costs.

For example, a desired “mask” pattern may be created by some means (examples of which are described below) upon a surface of or within a material which may then be positioned (temporarily or permanently) relative to a recording material upon a surface of or within a material, and radiation may be transmitted through (or reflected or transflected off) the mask to the recording material and if such radiation is modulated spatially by the mask and causes a latent or immediate change in the recording material such that a substantially matching pattern (or its inverse or complement) is created in the recording material, then the desired effect of producing two patterns (the mask and the recording thereof) can be achieved, and the two patterns will inherently exhibit a high degree of registration and will be close or closely-complementary copies of each other except in so far as the recorded pattern exhibits differences from the mask due to such effects as diffraction and scatter of the radiation as it propagates from the vicinity of the mask to the vicinity of the recording material and in so far as nonlinearities in the recording process may sharper, smooth, or otherwise locally change its spatial distribution.

As so far described the process is one in which the mask may generally in practice be used for the production of one piece of material only, because it bears the first of the two patterns and if it is removed or displaced the registration between the patterns may be lost and may be difficult to reestablish: this may be acceptable if the mask itself is produced at an acceptable cost and has satisfactory performance, or if such re-registration is achievable at an acceptable cost, or if only a single piece of material is desired. However, as an alternative, the mask may be used in conjunction with two or more recording surfaces, each of which records the mask's pattern in registration. For example, a stack may be prepared consisting of two layers of recording material, potentially separated by a gap, such that after recording the mask on or within each of the two layers, the mask may be removed or its pattern substantially or wholly erased, and the two recordings of the mask themselves form the required two patterns with any intervening space or material between the recordings forming the required gap, if any, between the two patterns. To prevent subsequent loss of registration between the recordings of the mask, the stack of the two recording materials, or the carriers and any other layers upon which or within which they exist, may be attached either across the entirety of one or more of their common surfaces or at one or a set of points, lines, or areas sufficient to adequately restrain them in registration or restore their registration if it is disrupted. By such means a mask which is costly, delicate, irreplaceable, or otherwise desired to be retained, perhaps for reuse, need not be consumed in the production of a single piece of anisotropic material. Also, the mask and its recordings may be optimized differently so that one or more of the recordings provide in practice an isotropic material which is superior to what would have been achieved had the mask itself been used directly: for example, by the use of a high contrast (or lith) photographic process, a low contrast mask may be recorded as a higher contrast pattern, and a mask with soft edges may be recorded as a pattern with harder edges.

Some, but not all, of the recording processes which may be so employed require that a chemical or physical treatment be applied to the recording medium before, during, or subsequent to its exposure. For example, if a photographic emulsion is used as the recording material, it generally will record only a latent image which must in practice be developed using photochemical means to convert it into a usable recording of the mask. This requires either that the recording material or materials is or are on the outermost surface or surfaces of the stack, or that whatever lies over it or them is permeable to the developing agent or agents. Similarly, if, for example, the recording process consists of the energetic decomposition or disordering of a material, such as the thermally-induced release of or generation in-situ of an opaque or transparent state or material then it may be necessary to remove, for example, a carrier matrix or a byproduct of the recording process, either via physical access to the unobstructed surface or through transmission of the matrix or byproduct through an outer surface or removal of it along with a detachable, dissolvable, or otherwise temporary covering. These requirements for access to the recording material may in some processes limit the duplication to a pair of recordings of the mask, one on either outer surface of a supporting material or materials.

A suitable mask may be created in many ways. For example, it may be printed upon a surface of a material using such printing processes as, for example, inkjet printing, laser printing of a direct or a Xerographic nature, impact printing, offset or lithographic printing, silk screening, dye diffusion, or any other printing process capable of achieving the necessary feature sizes and accuracies, which the sizes and accuracies may respectively be greater and lesser than the desired feature sizes and accuracies of the recording of the mask because the recording may be achieved using a minified (or magnified) projection, shadow, hologram, or image of the mask or may exploit nonlinearities or other features of the recording process or of the propagation of radiation from mask to recording which act to sharper, smooth, or otherwise locally alter the otherwise substantially one-to-one mapping from mask to recording.

Other means of creating a mask include laser etching, mechanical scribing, cutting or abrading, electron-beam lithography, photolithography with resists or selective etching or deposition using liquid, gaseous, or plasma agents, micro- or nano-scale self-assembly, recording of interferometric patterns, and biological or biochemical pattern growth. Alternatively, an addressable electro-optical device such as an LCD panel may be used as a mask, which may have the further advantage that the masking pattern can be changed rapidly and at low cost as needed.

Masks as described above are generally two-dimensional and in use are exposed across all or part of their surface to generate a two-dimensional replica or replicas, however such masks can also be scanned with energy during their replication so that at any instant only a sub-part of the mask is used and only a sub-part of the recording material is exposed. This can be advantageous if, for example, the power available for replication is insufficient to expose a larger sub-area or the full area of the recording material in a certain time, or if its uniformity in space or time is insufficient to create such a larger area in one exposure but can be improved by averaging across several exposures or scans, or if the masks properties vary undesirably in a known manner which can be compensated for by modulation the reproduction spatially or temporally so as to modify, reduce, or eliminate the variation or variations. Further, an essentially one-dimensional mask or one-dimensional region of a two dimensional mask may be used to produce patterns such as those of FIG. 21(a) which vary substantially in only one dimension by scanning the mask or region across the recording material. Or, for example, a two dimensional mask can be applied to or created upon or within a disk, drum, or belt which is rotated, driven, or spun such that at any moment a sub-area of the mask may be replicated into a sub-area of the recording material.

By these and other means masks can be prepared which incorporate the desired pattern, or from which the desired pattern or patterns may be generated, wherein in the mask the pattern is represented by sub-areas of different transmissivity (equivalently, different opacity or optical-density). However the mask pattern can also be formed from sub-areas differing in any other property which can then be replicated as a patterning of the desired property. For example, a mask formed from sub-areas with differing directions of polarization can be used to produce a recording of the pattern in which the differing areas of polarization in the mask correspond to different colors in the recording if the recording process is polarization sensitive and results in differing colors. As another example, a mask containing areas of high optical-density and areas of low optical-density can be recorded using a negative photographic process so that areas of high optical-density in the mask generally produce areas of low optical density in its recording or recordings and vice versa, or using a positive or reversal photographic process in which areas of high optical-density in the mask generally produce areas of high optical-density in its recording or recordings and areas of low optical-density in the mask generally produce areas of low optical-density in its recording or recording.

These two classes of photographic process (or other processes which have both a positive and a negative version) can be combined, using one process for one recording of the mask and the other process for a second recording of the mask. For example, the patterns of FIG. 19(c) may be produced using a positive mask, a positive photographic process for the pattern closest to the mask, and a negative photographic process for the pattern further from the mask, or by using a negative mask, a negative photographic process for the pattern closest to the mask, and a positive photographic process for the pattern further from the mask. Further, since the lines and spaces in FIG. 19(c) are of substantially equal width, the positive and negative masks of the previous sentence may be interchanged, resulting again in the patterns of FIG. 19(c) but with a spatial shift of one half cycle.

If different processes are used for each pattern then certain steps of each process may be confined to substantially effect one pattern but not substantially the other by, during the application of such a step, preventing the active feature of the step from reaching the other pattern, which may be achieved because the bulk of the material or materials forming the stack within which or upon which the two patterns are being created may itself act as a barrier. For example, if one process requires a photographic bleach which the other does not require and which would be detrimental to the other process then during the application of this bleach the outer surface of the stack to which it is not to be applied can be covered by a coating, which may be temporary or removable, and which is substantially impervious to the activity of the bleach, or a split processing tank may be used wherein the stack itself forms a mechanical barrier with bleach present in one side of the tank while the other side of the tank is either empty or contains another fluid to prevent deformation of the stack by the liquid pressure of the bleach.

Certain mask-making processes, such as ink jet printing, can more accurately produce narrow or small features than they can wide or large features; other mask-making processes have the opposite property: hence, positive masks or negative masks may be advantageous with such processes such that the features which are more easily or accurately produced in the mask are replicated appropriately. Similarly, certain recording processes can more accurately reproduce narrow or small features than they can wide or large features whereas other recording processes have the opposite property: once again, an improved result can be obtained by suitably choosing combinations of positive or negative masking and positive or negative processing for each of one or more recordings made from a mask.

As has been described, for photographic processes it is generally necessary to develop or otherwise photochemically process the recorded pattern: some other recording processes, such as recording in lithium niobate, liquid crystals, and certain photoresists and photopolymers, are fully or partially real-time or self-developing in that their recorded pattern appears spontaneously during or subsequent to exposure, fully or in part, without application of a development step. Photographic and other recording processes may also require or benefit from further processing. For example, the direct result of a recording may be patterns of different roughness, with comparatively smooth and comparatively rough areas. These different areas may act suitably as diffusers or scatterers without further processing, or they may be converted or modified to be suitable, for example by applying an ink or other substance which binds to or remains upon the rough areas but may be wiped or washed off the smooth areas. The direct results of photographic recording processes may also advantageously be post-processed, for example by using toners or other selective agents to enhance, modify, stabilize, or replace the patterning phenomena caused by the original recording: a photographic fix or hardening fix is an example.

Similarly, certain recording processes may be enhanced or made possible by the use of pre- or post-treatments (for example, the sensitivity, reciprocity, and contrast of a photographic process may be altered by the use of hypersensitizing or desensitizing techniques such as pre- or post-exposure to light, drying or wetting, cooling or heating, or treatment with physical or chemical sensitizing or desensitizing agents), and less direct recording processes may be used such as dual-photon recording or selective erasure of an actual or latent image via for example the Herschel effect.

Anisotropic materials produced by the methods described above or otherwise may beneficially undergo further processing or converting including, for example, slitting, dicing, slicing, cutting into specific sizes and shapes, embedding within or attachment to or use in combination with elements such as windows, visors, screens, and shields, immersion, insertion into, or submersion in a gas, liquid, gel, solid, plasma, or, vacuum, use as a barrier between two gasses, liquids, gels, solids, plasmas, or vacuums, surface or body treatments or transformations such as annealing or tempering, or flattening, curving, or twisting to adjust, establish, or alter its anisotropic performance or to conform it to the shape of another element. Their original edges, or edges created or revealed by such further processing or converting, may be blackened or otherwise treated to alter, reduce, or eliminate such effects as, for example, scatter, refraction, reflection, diffraction, total-internal-reflection (TIR), emission, or transmission from or at such edges. And their edges and faces may be covered with or have laminated or attached upon them coatings or other materials or treatments for, for example, mechanical, chemical, thermal, or optical protection or enhancement.

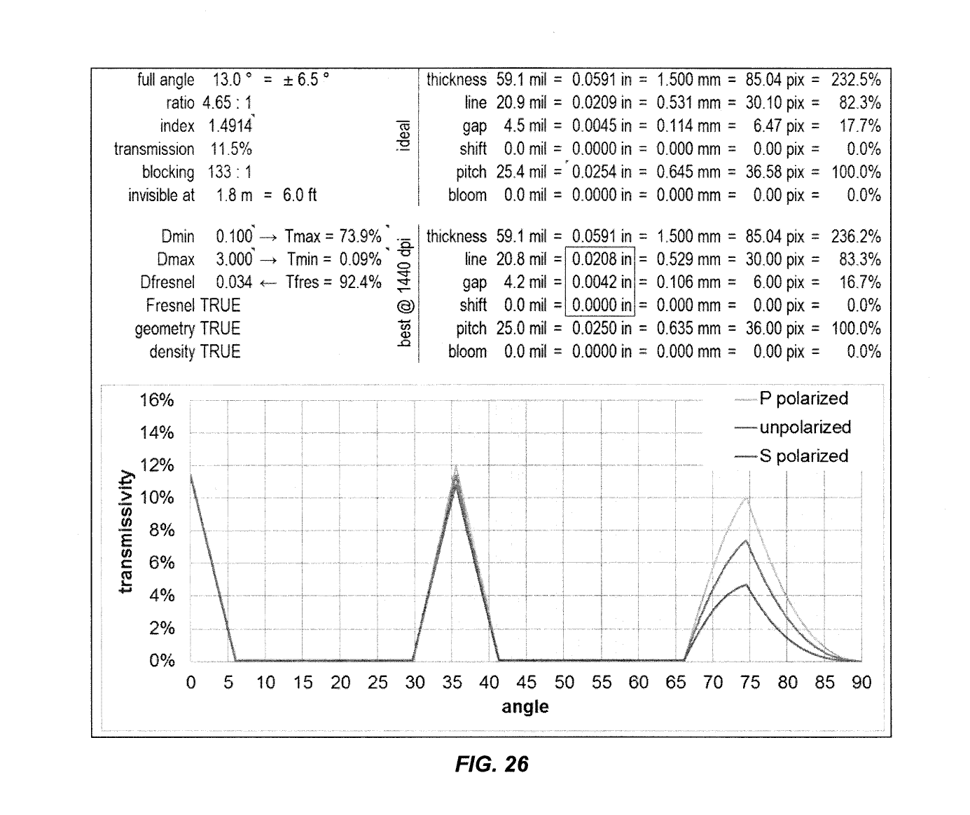

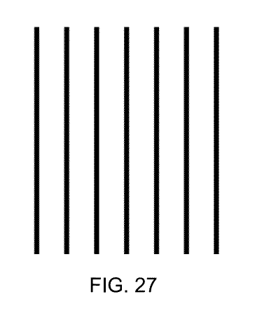

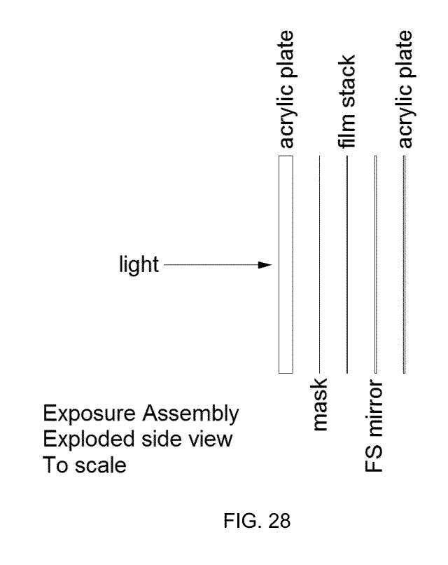

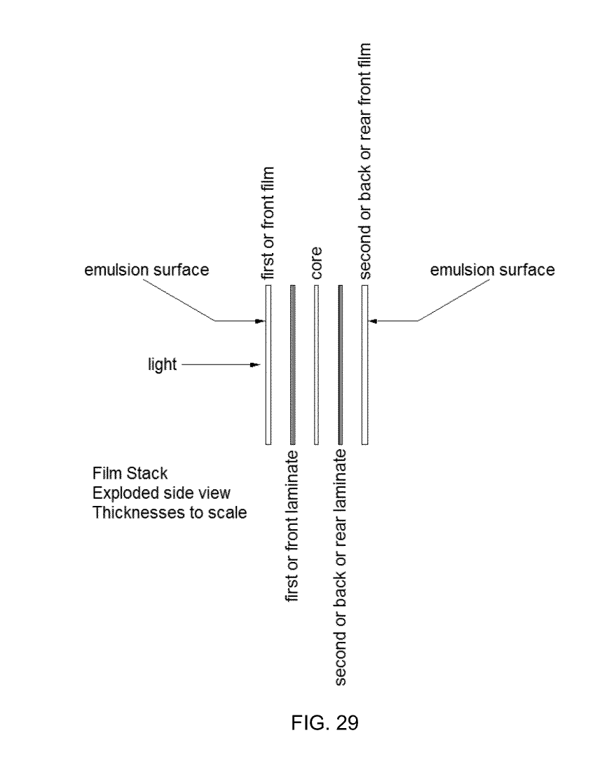

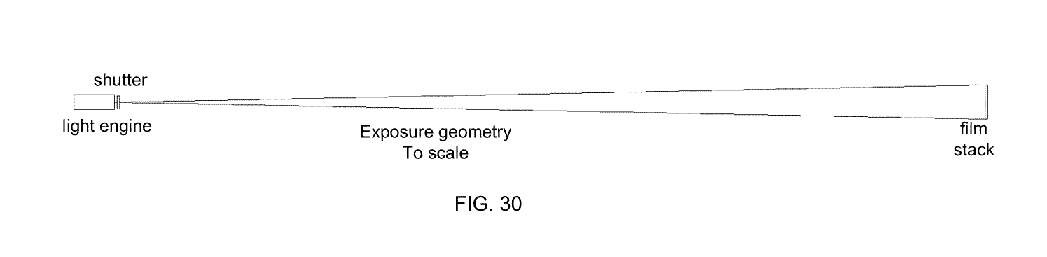

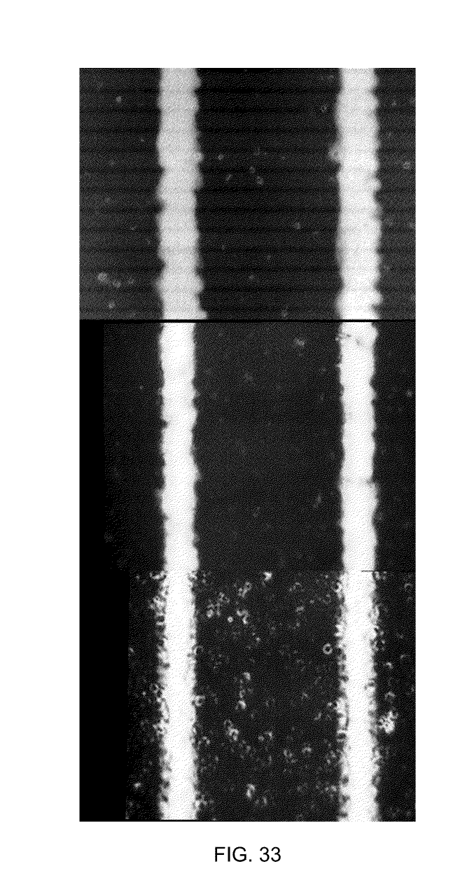

The present inventors have considerable experience with high-resolution black-and-white photographic processes, and chose to use such a photographic process to produce test and example materials. The following detailed descriptions of an embodiment are by way of illustration and best mode, and as has been described above, each aspect of this overall method may be executed in a number of different ways and, in some cases, in different orders. 1) a mask was designed using a spreadsheet implementation of a geometrical optical model [FIG. 26], 2) the mask design was printed on a flexible transparent plastic sheet using an ink jet printer [FIG. 27], 3) the mask was assembled in front of a stack (with the mask's printed side facing the stack), both held in a mechanical holder which retained them together between an acrylic slab in front of the mask and a front-surface mirror behind the stack [FIG. 28], 4) the stack consisting of two sheets of green-sensitive high-contrast high-resolution black-and-white photographic film attached together using a removable pressure lamination film with a core in the center consisting of a flexible transparent plastic sheet [FIG. 29], 5) the stack was exposed through the mask using a distant (hence substantially collimated) green LED under red safelight darkroom conditions [FIG. 30], 6) the stack was removed and then photochemically processed in a series of steps consisting of development, rinsing, fixation, and washing, 7) the stack was visually examined and measured with a transmission densitometer and a custom-built spectro-goniometer and compared with the design model [FIGS. 13 and 14], and 8) the stack was disassembled and the mask and the two films were digitally photographed with a microscope, evaluated using image processing, and further compared with the design model [FIG. 33]. Greater detail of these steps is provided below.

For process verification and validation and to prepare test samples, a mask was designed using a custom-written Excel (Microsoft, Redmond, Calif.) spreadsheet implementing a geometric model of hard-edged straight-line equal-width opaque and transparent mask regions of given widths and geometric propagation of collimated beams through this mask and into a stack consisting of a first photosensitive material of a given total thickness (emulsion and substrate) attached using a first laminating film of given total thickness to a transparent core material of given thickness which itself is attached using a second laminating film of given total thickness to a second photosensitive material of a given total thickness (emulsion and substrate), wherein each photosensitive material was arranged with its sensitive (emulsion) surface on the outside of this stack, and allowing for the refraction due to the different approximate respective refractive indices of the stack materials and of air which was presumed to surround it during its recording and during its use.

The selected photosensitive material was available in the form of an emulsion of approximately 6 μm coated on one side of an approximately 0.007 inch (7 mil) polyester substrate, and was modeled as having an overall thickness of 7 mil for each such layer. The selected laminating material was available in the form of an approximately 3 mil acetate core carrying an approximately 1.5 mil thickness of acrylic based adhesive material on both faces, and was modeled as having an overall thickness of 6 mil for each such layer. Polyester films in a wide variety of thicknesses are available, and the core was modeled as a single sheet of such a material with a thickness iteratively adjusted to provide a satisfactory calculated performance for the finished material. For example, a 5 mil core was used and modeled for the materials the evaluations of which are presented below.

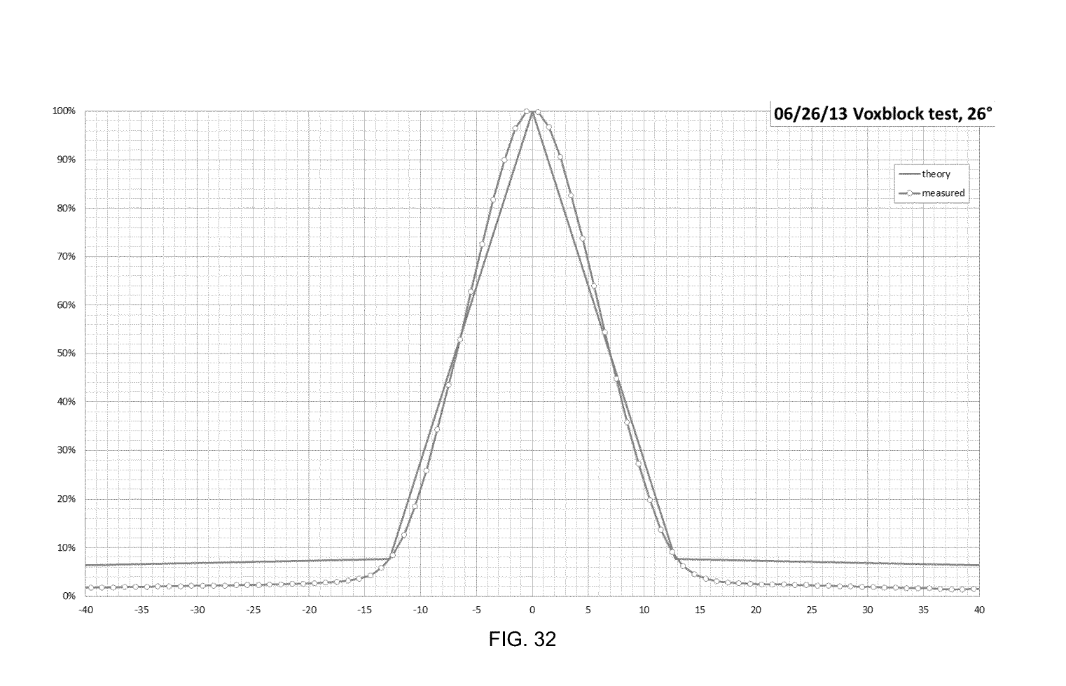

Given these materials stacked in these thicknesses, the model predicted [FIG. 32] that a passthrough centered at approximately 0° and with a width of approximately 26° could be achieved using a mask consisting of opaque lines of approximately 2/600 inch width spaced approximately uniformly with gaps of approximately 10/600 inch, these being convenient values in practice given that the available mask printer offered a manufacturer-stated printing resolutions of either 1/600 inch or 1/1200 inch, so that multiples of 2 and 10 (or 4 and 20) times this basic resolution were expected to be reasonably achievable, and assuming that the chosen printing mechanism would be able to print such a mask pattern with adequate accuracy and density/clarity and that the chosen photographic processes would be able to replicate this printed pattern (or its inverse) with adequate accuracy and density/clarity estimated in the latter case to be a maximum density Dmax of approximately 2 and a minimum density Dmin of approximately 0.03, which Dmax and Dmin are known to be achievable for the chosen photographic process when applied to large areas of high or low density.

Generally, printers capable of printing patterns achieve only a certain degree of fidelity when instructed to do so. Typically they use an underlying physical print mechanism which is actually capable of making marks with sizes, shapes, and positional accuracies which may not be perfectly controlled or repeatable and which may not bear a convenient relationship to the sizes, shapes, and positional accuracies intended for elements in the desired pattern. Further, they are generally configured to receive printing instructions encoded in a language or system which attempts to encapsulate or abstract their actual native capabilities in a form more convenient for programmers and which simulates a degree of commonality between different makes and models of printer, which language or system may itself be translated or converted into one or more intermediate languages or systems before reaching a level of specificity which the print-mechanism itself requires.

For example, the image of an intended printed page may be represented on computer screen by a program such as Photoshop (Adobe Systems Inc, San Jose, Calif.) and may be translated automatically to a language such as PostScript (Adobe Systems Inc, San Jose, Calif.) for transmission to a printer, and software within the printer or its control system may further translate the PostScript description to some internal representation from which control signals for the print mechanism are eventually derived. The final printed pattern may lack fidelity to its designer's intentions because of accumulated discrepancies, approximations, substitutions, mismatches, and errors between the various intermediate representations of the page and because of the physical limitations of the actual print mechanism. In particular, regular fine repeated patterns, such as those generally desired for the masks described herein, are quite likely to suffer moiréing under such circumstances unless special care is taken to avoid this.

In the present case, the patterns represented by the mathematical modeling were generated by writing a comparatively small program in PostScript and saved either in a compact procedural form in the format known as Encapsulated PostScript (i.e., as an eps file) or in a much less efficient form in the format known as Page Description Format (i.e., as a pdf file). Photoshop can import an eps file and can export a corresponding pdf file. The correctness of the handwritten PostScript description was verified by examining its rendering after importing it into Photoshop, and was sufficiently well retained when exported from Photoshop in the PDF format, as was verified by examining its rendering after importing it back into Photoshop and into other PDF rendering software such as Foxit Reader (Foxit Corp, Fremont, Calif.). Certain features of the PostScript language allow a PostScript program to create descriptions of to-be-printed features which, at least in theory, will be well registered with the underlying capabilities of a printer, hence avoiding the introduction of moiréing and other misalignment artifacts at the mask printing stage. Use of this feature is illustrated in the following PostScript code which was used to print a mask in the present case.

%!PS-Adobe-2.0 EPSF-1.2

| | |
|---|---|
| %%Title: | pattern.eps |
| %%Creator: | Stephen J Hart |
| %%CreationDate: | 06/07/2013 |
| %%BoundingBox: | 0 0 576 720 % 8″ x 10″ @ 72 dpi |

%%EndComments
<<

/bar 2 % bar width in printer-native dots
/gap 10 % gap width in printer-native dots
% ensure dot-accurate rendering
/pl { % x y pl x y

transform

0.25 sub round 0.25 add exch
0.25 sub round 0.25 add exch

itransform

| } def | |
|---|---|
| /setstrokeadjust where { | % if RIP knows how to strokeadjust |

| | |
|---|---|
| pop true setstrokeadjust | % strokeadjust |
| /l { lineto } def | % x y l - |
| /m { moveto } def | % x y m - |

| | |
|---|---|
| }{ | % else redefine the absolute polyline ops |

| | |
|---|---|
| /l { pl lineto } def | % x y l - |
| /m { pl moveto } def | % x y m - |

| | |
|---|---|
| } ifelse | % end if |
| /inch { 600 mul } def | % device native resolution in dots-per-inch |
| /height { | % current height as fraction of 10.0″ page |

currentpoint exch pop +10.0 inch div

} def
/helv { % n-point Helvetica

inch 72 div /Helvetica findfont exch scalefont setfont

} def

>>
begin

| 0 setgray | % all in black |
|---|---|
| 72 1 inch div dup scale | % scale so 1 unit equals 1 dot |
| % draw the bar+gap pattern | |
| newpath | % start a new path |
| bar setlinewidth | % set line-width |
| +1.0 inch +0.0 inch m | % move to 1.0″ x 0.0″ |
| { | % repeat |

| | |
|---|---|
| currentpoint | % note where we are |
| currentpoint exch +6.0 inch add exch 1 | % draw a 6.0″ line |
| m | % move back to line start |
| currentpoint bar gap add add m | % move up for next line |

| | |
|---|---|
| height 1.0 ge { exit } if | % until at or past top of page |

| } loop | | % end repeat |
|---|---|---|
| stroke | | % draw the lines |
| % draw a 1.0″ x 10.0″ black strip (for density measurements) | | |
| newpath | | |
| +7.0 inch +0.0 inch moveto | | |
| +0.0 inch +10.0 inch rlineto | | |
| +1.0 inch +0.0 inch rlineto | | |
| +0.0 inch −10.0 inch rlineto | | |
| closepath | | |
| fill | | |
| % sign it | | |
| newpath | | |
| 3 helv | | % 3-point Helvetica |
| 0.05 inch 0.15 inch m | | % move to 0.05″ x 0.15″ |
| (06/07/13, ) | show | % text |
| (600 dpi, ) | show | % text |
| 2 3 string cvs | show | % bar |
| (-dot bars, ) | show | % text |
| 10 3 string cvs | show | % gap |
| (-dot gaps. ) | show | % text |
| 0.05 inch 0.10 inch m | | % move to 0.05″ x 0.10″ |
| (Unpublished work copyright ) | show | % text |
| /copyright | glyphshow | % (c) |
| ( by Holorad, 2013. ) | show | % text |
| 0.05 inch 0.05 inch m | | % move to 0.05″ x 0.05″ |
| (All rights reserved. ) | show | % text |
| (Patents pending.) | show | % text |
| showpage | | |

end
%%EOF

In addition to printing a representation of the opaque lines of the designed pattern, this PostScript program also commands the printer to draw along one edge of the mask an approximately one inch wide strip of uniform black (opaque), and to leave along the opposite edge an approximately one inch wide strip of uniform transparent (clear), these comparatively large uniform areas of high and low density serving as test areas to evaluate and confirm the capabilities of the printer and of the process used to replicate it, using transmission densitometry as described below. And along one edge of the clear strip is included some identifying text in a small black font. These additional strips and text illustrate how masks can be printed incorporating other useful features such as text and graphical elements which may, for example, be used to identify individual masks or to assist in the alignment or conversion of the mask or of a replica or replicas thereof or to serve other purposes within the system which incorporates the mask or a replica or replicas thereof.

The resulting eps and pdf files were transmitted to the control computer of the chosen inkjet printer, an iPF750 (Canon Inc, Tokyo, Japan), on a USB memory stick. Test prints were made of both types of file onto 3 mil polyester roll film, and it was found that with the chosen printer the two file types resulted in prints which could not be distinguished by visual examination on a lightbox (501D DualBrite, American Medical Sales, Los Angeles, Calif.) using an 8X hand loupe (Agfa-Gevaert, Mortsel, Belgium) or in a transmission densitometer (Model 301, X-Rite, Grand Rapids, Mich.). Thereafter, at the request of the printer's operator, files were provided in the PDF format, this being an example of how the print operator may make choices about how to print the mask: as a further example, the printer operator took care to ensure that the areas of the polyester roll upon which the patterns were printed was relatively clean and free from such defects as fingerprints, scratches, bends, kinks, and dust.

Despite this care all masks produced did suffer from one or more of such defects to some degree, but this was found, in the present case, to generally be acceptable. In general, dark (opaque) defects are not particularly noticeable when light is observed transmitted through such an anisotropic material, especially if they are of a size comparable to the feature size of the patterns used. Defects which occlude exposure of the film closest to the mask (such as dust and fingerprints in or on the mask) will in general produce substantially transparent (clear) artifacts in that film's pattern unless it is reversal processed and in the second film (unless it is reversal processed) and hence are desirably avoided or eliminated. However, defects which allow exposure of the first film (such as scratches and pinholes in or on the mask) will in general produce substantially opaque (dark) artifacts in that film's pattern unless it is reversal processed and in the second film (unless it is reversal processed) and hence, while ideally they should be avoided or eliminated, in practice their effects are generally not particularly noticeable as described above. In practice it is comparatively easy to remove dust and fingerprints, and comparatively difficult to fill-in scratches and pinholes, so that class of defect which causes the more visible artifacts is also the class which is most easily removed.

A further defect observed at the mask printing stage was that occasionally, roughly every six linear inches or so, the print mechanism, or some part of the software feeding or driving it, would make a mistake and either omit a line or print a double line or fill-in a gap. Such printer errors may occur predictably or randomly or both. Better printers may exhibit fewer such errors. It was also found that the present mask printing system produced better results for patterns printed with lines substantially parallel to the axis of the print roll than it did for patterns printed with lines substantially perpendicular to the axis of the print roll: in other words, portrait mode prints were acceptable whereas landscape mode prints not. This may have occurred because the mechanical mechanisms which translate the printer's inkjet mechanism in the two directions are different, and one such mechanism may have been more accurate than the other. Further, testing revealed that the chosen printer could render thin black lines with wider clear spaces with greater clarity than it could render thicker black lines with correspondingly thinner clear spaces: as a result, and since the mathematical modeling called for 10 mil lines with 2 mil gaps, a negative mask was printed and used with a negative photographic process.

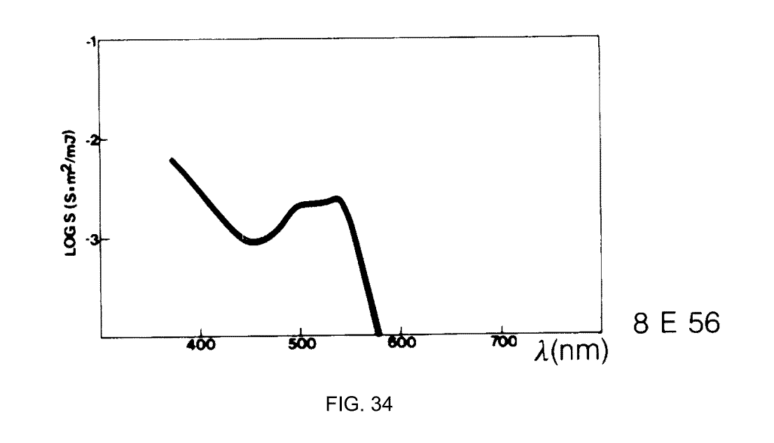

In general the light or other exposing energy used to record a replica or replicas of the mask on or in the recording material needs to be sufficiently well matched to the sensitivity properties of the recording material. For example, in the present case the selected photographic film is comparatively sensitive to green light or more specifically to light with a wavelength in the range of 500 nm to 550 nm and is comparatively insensitive to red light or more specifically to light with a wavelength greater than 600 nm (FIG. 34). A green LED (PhlatLight PT 120, Luminus Devices Inc, Billerica, Mass.) was used, housed for convenience in a light engine (BP96-01725A, Samsung, Seoul, South Korea) which produced a nicely uniform and approximately rectangular beam. When this light engine was positioned approximately 204 inches from the recording material and powered by a bench power supply (TPS-2000, Topward, Hsin Chu, Taiwan) providing 4.8 Volts and 4.2 Amps to the LED (operating in constant current mode to provide a stable LED optical power) it provided an optical power of approximately 25 μW/cm2 as measured with an optical power meter (Model 835, Newport Corp., Irvine, Calif.) and a power-sensitive photodiode assembly (Model 818-SL, Newport Corp, Irvine, Calif.) temporarily held, before and after exposure, in approximately the center of the position which was occupied by the recording material during exposure.

Corner-to-corner power variations across the recording material were estimated using this power measuring apparatus to be negligible, and a visual inspection of the uniformity across the recording material was made by substituting a white card for the recording material, and showed no noticeable spatial variations such as banding or highlights. Variations in polarization were checked visually using a hand-held polarizing disk (38,605, Edmund Scientific, Barrington, N.J.) and were judged to be insignificant. Temporal stability of the LED's power was evaluated, and found to be inconsequential, using the power measuring apparatus before and after exposures and during a prolonged period in which the air temperature in the room containing the entire apparatus was adjusted over a range of approximately 10° F. The chosen recording material is known to be relatively insensitive to changes in air humidity and other variables which for some recording materials could have a significant effect on recording sensitivity or performance and which would then for such other materials have desirably been measured and either controlled or allowed for.

For the approximately 8×10 inch mask used, by geometric calculation the divergence of the LED's beam across the mask from one corner to the diagonally opposite corner amounted to less than ±2° which could be compensated for either by adjustments to the mask or by the use of auxiliary optics such as a collimating element between the light source and the mask. The divergence was approximately symmetric because the mechanism used to hold the mask, recording films, and other elements stacked in common with them during exposure (Model 535, Newport Corp, Irvine Calif.) was attached to a stable surface using a single screw through the provided hole such that it could be twisted in the LED's beam; it was adjusted about this axis until the center of an approximately 8×10 inch mirror (temporarily held within it parallel to where the film and other materials were held during exposures) retro-reflected a temporarily provided laser beam from just above the exit lens of the light engine to just below it, establishing that the holder would hold its contents perpendicular to the LED's beam to within a small angular error. Subsequent measurements of recorded materials made using a spectro-goniometer showed that such perpendicularity was good to within a degree or two, which would generally be sufficient for such material, and higher accuracy could have been achieved by the use of more accurate angle-measuring means or by iteratively adjusting the holder until materials exhibiting the desired perpendicularity were achieved.

For convenience, all procedures using the chosen recording material prior to and including its photochemical processing were conducted under red safelight conditions using a suitable gel (Ortho Red R-10, EncapSulite International Inc, Rosenberg, Tex.) wrapped around ceiling mounted T12 fluorescent lights.

Required exposure energies for the chosen recording material and photochemical process are in the range of tens or hundreds of μJ/cm2, and with this arrangement and exposure power, the exposure durations required were thus in the seconds range (established using the relationship Energy=Power*Duration). More specifically, an exposure energy of approximately 75 μJ/cm2 was used with an exposure duration of approximately 3 seconds. Control of exposure duration was achieved using an ES.7 electro-mechanical photographic shutter (Shackman Instruments, Gerrards Cross, UK) with its SC.1 controller which is capable of providing exposures of approximately 1/60, 1/30, 1/15, ¼, ½, 1, 2, 4, 8, or 16 seconds. Several exposures were used in sequence when a desired exposure duration was not one of those directly provided by the shutter controller. For example, three exposures of one second each were used to achieve a three second exposure. The chosen recording material is known to exhibit adequate photographic reciprocity within the range of exposure durations used, so this was not compensated for as may have been necessary for other recording materials or processes, and in any case the exposure conditions were established empirically using a Hunter Driffield (HD) curve (as described below) to obtain an initial estimate and then bracketed exposures about the calculated duration to select that exposure duration which under the circumstances resulted in a material with satisfactory properties (the measurement and evaluation of which is described below).

An incoherent (LED) source was chosen rather than a coherent source (such as a laser) to reduce interference effects such as speckle and Newton's rings which would otherwise have occurred more strongly within and between the recording material and the materials adjacent to it. The chosen LED has a bandwidth (FWHM) of approximately 35 nm centered at approximately 526 nm, so that almost all of its optical emission is in the green range and is well matched to the chosen film. A more broad-band source could have been used (such as a set of red, green, and blue LEDs as provided for by the Samsung light engine), but only the green part of its energy would have been effective in exposing the chosen recording film. A less broad-band source could have been used (such as by inserting a bandpass filter (e.g., 62157, Edmund Optics, Barrington, N.J.) between the LED and the photographic film), but doing so would have narrowed, and increased the contrast of, diffractive ringing from the edges of the mask and from dust, dirt, and other foreign objects on, within, or adjacent to the recording film and from scratches, defects, and other damage or imperfections on or of the recording film and on or of materials adjacent to it.

Because of the small feature size of the desired patterns, and because of their desired sharpness and contrast, it is generally advisable to use a photochemical system (film, exposure, and development) which offers high resolution and high contrast. Conventional lith films and developers are particularly suitable, but other systems may be used if they achieve sufficient resolution and sharpness.

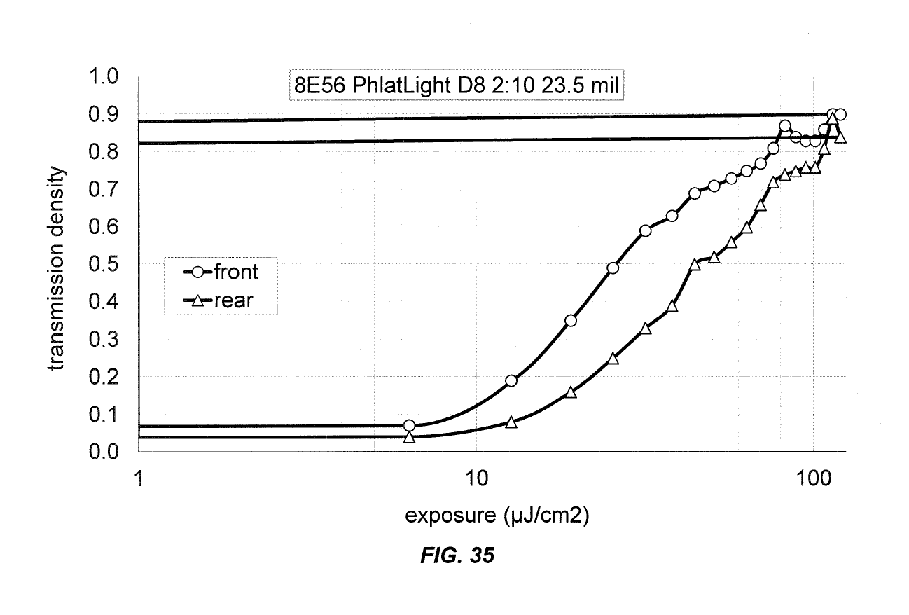

In the present case a custom coating of a single layer of approximately 6 μm of the 8E56 emulsion (Agfa-Gevaert, Mortsel, Belgium) on an approximately 7 mil polyester substrate was used, developed in Kodak D8 developer followed by fixation. FIG. 34 shows the manufacturers spectral sensitivity curve for this emulsion. FIG. 35 shows an HD curve for this emulsion and processing combination, exposed as described above and processed as described below. Agfa's coating of this material is assumed to include such standard features as subbing layers, and the rear of the polyester substrate is coated with a gelatin layer substantially matching the mechanical properties of the front gelatin (containing also the silver halide and other photosensitive materials), such as to minimize film curl at a 50% relative humidity. Silica beads or other inclusions are sometimes incorporated in such anti-curl backings to improve mechanical transport, but these can lead to increased scatter for light transmitted through the film during exposure and use, and they were not included in the present case. Had this film stock included a substantially opaque or scattering anti-halation layer or component (it did not) this could have been removed prior to use (e.g., with a water or alcohol pre-wash) to permit exposing light to pass cleanly through the first film to the second. The photosensitive emulsion of this film exhibits a pink coloration prior to processing (this is believed to be a sensitizing dye) which for the wavelengths used reduces transmission through the film during exposure by a factor of approximately two and which appears to be completely removed or decolored during the fixation step described below.

The film's 7 mil substrate was allowed for in the pattern-design calculations. Other substrate thicknesses and materials (such as, for example, glass or triacetate) could be used, with corresponding changes to the thickness and refractive index values in the design. In this case a commercial emulsion and coating was used, but emulsions are also available in liquid form (or can be prepared from scratch by the user) and can be coated on prepared substrates mechanically or by hand using such means as, for example, spin, spray, slot, jet, or dip coating, or the use of a threaded or ridged coating bar. At approximately 6 μm (0.2 mils), the emulsion's thickness was many times thinner than the approximately 2/600 inch (3 mil) wide lines used in the present negative mask and hence had negligible impact on the mask's sharpness, however had the emulsion been thicker (for example, to increase its sensitivity or Dmax) or had the processing regime caused a significant swelling or shrinkage this would have been allowed for in the design step.

A similar red-sensitive emulsion (e.g Aga 8E75) could have been used (with a red LED for exposure, and under green safelight conditions), and in fact the front and rear emulsions of the stack could have comprised one each of a red and a green sensitive emulsion (or of emulsion sensitized to two other non-overlapping wavelength regions) and exposed using red and green LEDs (or, mutatis mutandis light sources matched to the emulsions' spectral sensitivities) either simultaneously or in sequence, affording a greater degree of control over the exposing of each emulsion, whereas in the present single-color case the rear emulsion received only approximately one half of the exposure energy of the front emulsion (the first film, primarily because of its pink coloration, allowed approximately one half of the green exposing energy to pass through it, and this energy then also having to pass through the second film, further attenuating it, before, in the present case, as described below, being retroreflected back into the second film by a front-surface mirror, roughly doubling the exposure power which would otherwise have been received by the second film: these estimated effects on the power were established by power and density measurements, and by examination of the HD curves for front and rear films). Further, had two such films of different spectral sensitivity been used (or had one film been reversibly desensitized during the exposure of the other, and resensitized for its own exposure, and vice versa for the other film) then a mask could have been incorporated within the stack between the two films and exposure energy of the appropriate color applied through the internal mask to one film and then (or, in the case of different spectral sensitivities, at the same time) exposure energy of a suitable (and, in the dual-color case, different) color applied from the other side of the stack, hence achieving a material with a triple patterned structure such as that of FIG. 23.

HD curves for the chosen photographic process were prepared by exposing films in the manner herein described for holding, exposing, and processing actual materials, at substantially constant exposure powers using a range of exposure durations to provide different exposure energies. For any particular film and exposure wavelengths, the shape of such curves, and the positions and values of their major features (such as their toe, linear region, shoulder, and saturation region) depend on and can vary in detail with each of many parameters, some of the major of which are generally exposure duration (e.g., reciprocity effects), and developer concentration, temperature, agitation, and duration. If these variations are slight or predictable, such an HD curve for a particular set of conditions can be used to predict the density which will be achieved for any particular exposure power, or vice versa. Such curves were prepared both for large uniform areas of illumination without a mask and for areas with a mask in which later cases the measured densities represent averages across an area masked by many opaque and clear regions of the mask: such averages may still be useful in evaluating and estimating the effects of exposure and processing, or a microdensitometer can be used to measure the recorded density variations of actual lines and gaps between the toe and shoulder regions (for exposures below that of the toe no lines form, and for exposures above the shoulder the gaps may have been filled in).

In the present case, registration between the two films recording the pattern was maintained by the use of a laminated stack wherein the two photosensitive films were attached to a common transparent core using two layers of a lamination film. Such a stack was prepared under safelight conditions using a motorized pressure laminator (Sealeze 42C, Seal Products Inc, Naugatuck, Conn.) and a removable lamination film (PSFR Facemount Removable, Drytac Corp, Richmond, Va.) with thicknesses and composition as stated herein. Other suitable lamination films are available which are applied using heat or heat and pressure rather than just pressure. Alternatively, liquid bonding agents can be used (such as those available from Epoxy Technology, Billerica, Mass.) which are activated by heat, UV light, or exposure to air. In the present case a removable film lamination material was used because this assisted in the disassembly of test stacks after exposure and processing for evaluation and testing of the individual patterns recorded on each film. Also, this process results in a well-defined and substantially constant and repeatable stack thickness. In production, other lamination materials can be used, one or both sides of which are not designed to be removable. In any case, it is generally desirable that the lamination material and process result in a substantially transparent and non-scattering layer so that the light from the first film may pass through relatively unimpeded and undisturbed to the second film. Other methods of attaching the films, and any desired core spacer, include thermal, ultrasonic, and pressure welding with or without the use of a lamination film or liquid agent, molecular bonding of suitably clean, rigid, and flat materials, pin registration, and mechanical fasteners such as rivets.

Certain films, such as some films used for x-ray imaging using phosphor cassettes, are available coated with photosensitive emulsions on both front and back. Had such a film been used, a single sheet could have sufficed without lamination, and its manufactured thickness would have defined the gap between the two patterns. In so far as such films contain anti-halation (AH) layers or materials, these are designed to be removable after exposure (generally this occurs in one or more of the baths of their recommended processing regime): such layers could be removed prior to exposure through the use of a pre-wash or other treatment which removes or clarifies the AH property without eliminating the photosensitivity.

During exposure, to improve flatness and maintain good contact between the mask and the first film the laminated stack was held between, on the side facing the illumination source, a clean approximately ½ inch thick approximately 8×10 inch transparent acrylic plate, and on the other side an approximately 1.5 mm thick front-surface acrylic mirror (FSM) and then an approximately 1.5 mm acrylic plate [FIG. 28]. The Newport plate holder used to hold the laminated stack and these other materials during exposure provides three spring-loaded pins to hold these elements together. If greater pressure had been desired (for example, if the laminated stack had exhibited a more pronounced curvature) additional clamps, screws, or plates could have been used to provide a greater clamping force. And if a degree of curvature was desired during exposure (for example, in one dimension to improve the effective collimation of a divergent illumination beam), this could have been achieved using such means as shims, screws, and clamping plates with pre-established curvatures.

The FSM acts as an energy recycling retroreflector to increase the exposure power received by the back film, as described above. Without it the back film would be substantially underexposed or the front film would be substantially overexposed or one would be underexposed and the other overexposed so that the recorded pattern on one or both films would tend to be less contrasty. The acrylic FSM used exhibited a slight surface rippling or mottling which may have caused a reduction in clarity of the pattern in the back film which, during exposure, was immediately adjacent to it. This would have been exacerbated had the illumination source featured a narrower bandwidth, and could be reduced by using a higher-quality FSM such as a glass FSM. A front surface mirror, rather than a back surface mirror, was used to reduce the impact of such effects as scatter, diffraction, and imperfect collimation which could have been exacerbated by passage through such a back surface mirror and by path-length difference and angular deviations introduced by such passage and by any non-parallelism of such a back surface mirror.

In detail, the photochemical processing of the exposed laminated stack in the present case consisted of the following steps performed in the following order under safelight conditions:

1. Tray development (to convert latentized silver-halide grains into silver) for approximately 1 minute in fresh single-shot Kodak D8 developer freshly diluted 2:1 (i.e., approximately two parts of stock developer to approximately 1 part distilled water) at approximately 21° C. with constant manual agitation and manual inversion of the stack in the tray roughly every 15 seconds.

2. An approximately 2 minute rinse in flowing untempered unfiltered city water (approximately 26°) with manual inversion of the stack in the tray roughly every 30 seconds.

3. Tray fixation (to remove remaining silver halide) for approximately 2 minutes in stock Kodak fix (non-hardening) at approximately 23° C. with constant manual agitation and manual inversion of the stack in the tray roughly every 15 seconds.

4. An approximately 3 minute wash in flowing untempered unfiltered city water (approximately 26°) with manual inversion of the stack in the tray roughly every 30 seconds.

5. Mechanical removal of surface water using a photographic squeegee and a large clean glass plate.

6. Air drying until dry (a few minutes) held vertically in unfiltered air at approximately 23° C. and a relative humidity of approximately 50%.

Cleaner, more consistent, more contrasty, and more stable results might have been achieved by, for example, using a pre-wash to wet the film before development, extending the development time, using a stop bath after the development step, tempering, filtering, and extending the durations of the rinse and wash steps, using a final wash with a wetting agent prior to drying, better controlling temperatures, durations, agitation, and humidity, reducing the agitation during development (lith type films may benefit from this), and using filtered heated air or infra-red heating for drying, or by using a different developer (which might also permit continued use in a recirculating-tank auto-processor with replenishment) or a different fixer (or a hardening additive) or different dilutions.

Had a positive or reversal process been required for one side, this would have required additional steps between the rinse and fixation steps. Several such reversal chemistries are known. For example, first, one side only of the stack (the side which is to be reversed) could have been bleached (using, for example, a chromate bleach) to remove its developed silver, while the other side was either fixed to remove its remaining silver halide or left alone. Following or during a rinse, the film could have been re-exposed by exposure to green (or white) light. Then the bleached side of the film (or both sides if the other side had been fixed) could have been re-developed (using, for example, the same Kodak D8 developer). Other reversal chemistries may modify these steps and may use a bleach-fix or blix, and if both sides are to be reversed then the above extra steps would be modified to bleach, re-expose, and re-develop both sides.

The formula and procedure used for mixing Kodak D8 developer was:

| Distilled water (32° C.) | 750 | ml |
|---|---|---|
| Sodium Sulfite (anhydrous) | 90 | g |
| Hydroquinone | 45 | g |
| Allow to cool before adding | | |
| Sodium Hydroxide | 37.5 | g |
| Potassium Bromide | 30 | g |
| Distilled water to make | 1,000 | ml |

Take suitable safety precautions including eye protection, and consult the MSDS for each chemical. Each chemical was added in the order shown, and allowed to fully dissolve before proceeding. The hydroquinone dissolves slowly even at 32° C. The Sodium Hydroxide should be added slowly because an exothermic reaction will occur, heating the solution: it should not be allowed to overheat, and boiling could be dangerous. All temperatures and quantities are approximate. Potassium salts may be used in place of sodium salts, and vice versa, if quantities are adjusted for their different atomic weights. Stock developer was diluted 2:1 immediately before use, and used single-shot. Stock D8 will not keep for long, even in a stoppered bottle, and dilute D8 will keep for less than four hours.

Kodak fix was mixed from the manufacturer's packaged power following the manufacturer's instructions. Generally, photographic fixes are very robust such that exact times, temperatures, concentrations, and degrees of usage are relatively unimportant. However long-term stability of fixed materials may be impaired by inadequate washing prior to and following fixation. Hypo test materials may be used to confirm adequate fixation, and silver tests may be used to evaluate fixer exhaustion.

FIG. 32 shows overlain the first passthrough in the model-predicted relative transmissivity as a function of angle, and the photo-goniometer measured relative transmissivity as a function of angle, for a sample material prepared as described herein using a negative mask and two recording films each using a negative photographic process for a designed pattern of 2/600 inch wide lines with 10/600 inch wide gaps. This sample exhibited a net optical density on-axis of approximately 1.04 (i.e., a net transmissivity normal to the sample of approximately 9.3%). Upon disassembly and measurement as described herein the clear and opaque strips on the front film had transmission densities of approximately 0.03 and 3.1 respectively, the clear and opaque strips on the back film had transmission densities of approximately 0.02 and 2.0 respectively, and the clear and opaque strips on the mask had transmission densities of approximately 0.03 and 2.8 respectively.

FIG. 33 shows transmission micrographs of the mask used for the material of FIG. 32 and of its disassembled front and back films. These digital micrographs were acquired using a USB microscope (QX3, Intel Corp, Santa Clara, Calif.) and have been aligned and contrast enhanced using an image processing program (ImageJ, NIH, Bethesda, Md.). Calibration using a printed USAF 1951 test pattern (Applied Image Inc, Rochester, N.Y.), show that the widths of the lines and gaps in the mask as printed are within a few percent of their designed values, and visual examination of the micrographs shows that these widths have been quite accurately replicated in the patterns of the two films and that as expected the back film shows a higher degree of duplication artifacts than the front film.

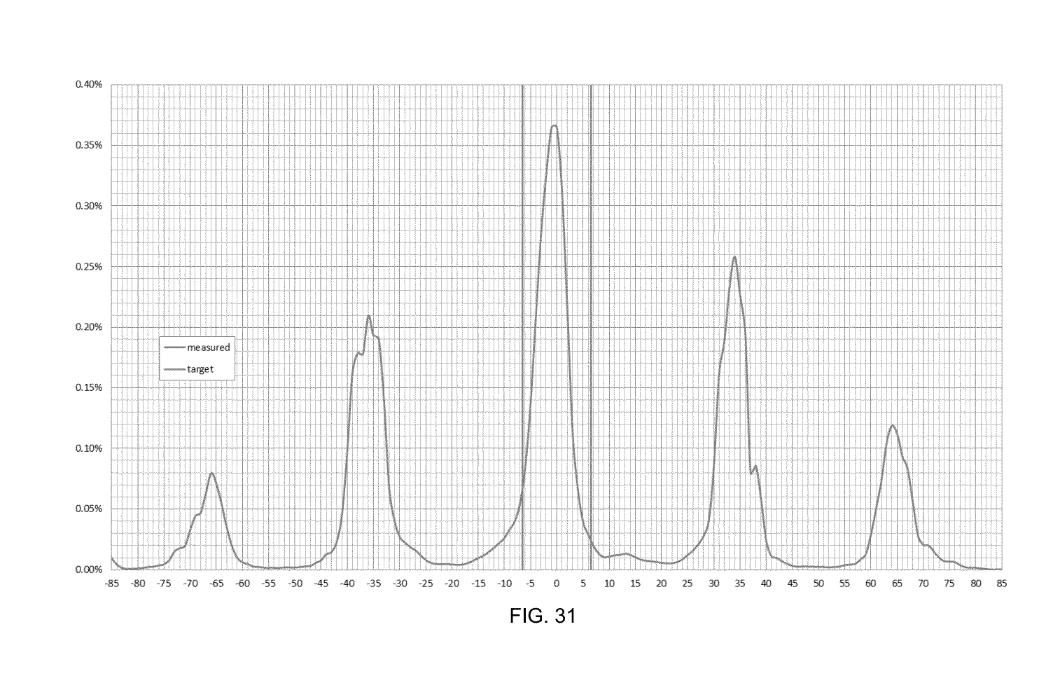

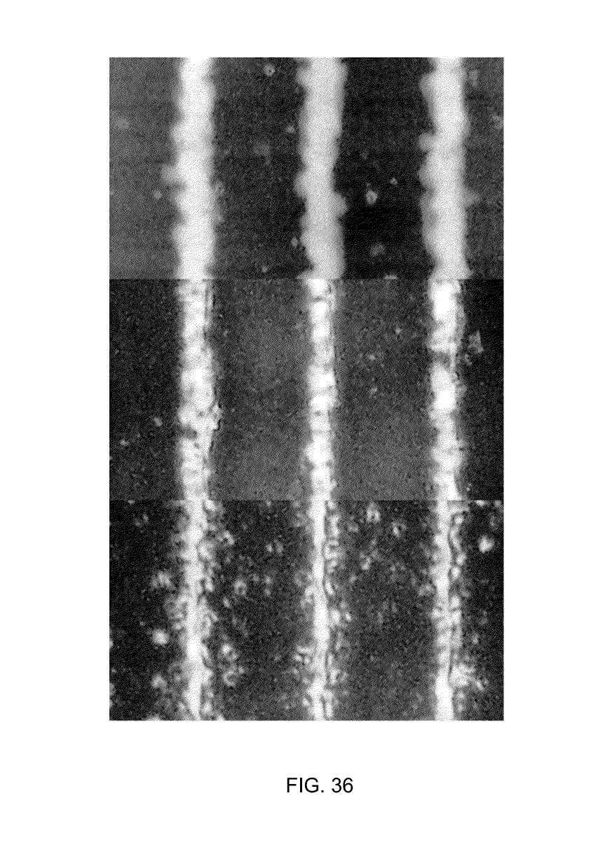

FIG. 31 shows, for a broader range of incidence angles than FIG. 32, the measured relative transmissivity for a different sample material prepared broadly as described herein but using a designed pattern of 1/600 inch wide lines with 5/600 inch wide gaps. This sample exhibited a net optical density on-axis of approximately 2.36 (i.e., a net transmissivity of approximately 0.4%) and digital micrographs (FIG. 36) show that the replicated gaps in its rear film were substantially narrower than designed.

Voxbox displays with larger illuminated areas than the approximately 12 inch by approximately 13½ inch area of the Model-22 can be constructed using larger optics at the front, including a larger Fresnel lens collimator, a larger diffraction grating, and a larger Voxblock sheet, or a plurality of these front optics can be assembled in a tiled array built up from smaller parts or a mix of small and large parts such, for example, a large collimator followed by a first layer consisting of one or more tiled arrays of smaller diffraction gratings followed by a second layer consisting of one or more tiled arrays of Voxblock sheets. In the case of tiled front materials, the rear part of such a Voxbox display can be a large monolithic system in which a single light source illuminates the front materials, or these rear parts also can be tiled such that an array of multiple light sources lights the front material. This later case can be equivalent to a tiling of multiple entire Voxbox displays to construct a large illuminated area from a collection of smaller illuminated areas each provided by one small Voxbox display, in which case it is generally advantageous to construct the small Voxbox displays with narrow, vestigial, or absent unlit edges so that a joint-free illumination can be achieved and it may be advantageous to share electrical, control, and cooling means between the collection of smaller Voxbox displays.

Via their color motion demonstration the present inventors have made certain observations and conclusions, such as for example the previously detailed values for minimal and sufficient flicker rate. To achieve these rates without the crab seeming to move unreasonably rapidly, the present inventors implemented the following additional features: in general, frame sequences are selected in which each frame (and hence each pose of the crab) is repeated two or more times (experimentally, even four or five repetitions can be used judiciously without the crab appearing to have frozen or died); to smooth out such repeating patterns in motion sequences, sometimes one or more repeats of the previous image in a sequence is inserted, and the resulting blurring of the crab's motion provides a beneficial smoothing effect to the overall motion; to provide an extended duration to the crab's story it is desirable to have also a no-crab frame which is displayed when the crab is off stage (as is indicated to the observer by corresponding off-stage stereophonic sound effects and music) and since this was not anticipated in the design of the eleven crab frames, a frame of the crab's enter-stage-left sequence is used in which fortuitously almost no crab is visible. It is generally not sufficient to simply disable the illumination to achieve an empty frame because such an unlit frame typically looks very different from the background of the other frames which typically contain at least some noise light, however a fade-down-to-black and a fade-up-to-black is practical in which the illumination is respectively ramped down or up while, for example, a neutral image is displayed such as the crab character's neutral pose or the textual frame.

In addition the present inventors have determined that it is possible to flash or pulse the three color illumination sources either all together, or in an interleaved pattern wherein only one color is on at any particular time, the interleaved color pulses either occurring back-to-back or being timed to be evenly distributed throughout the rotation of the motion mechanism. In the later case (even distribution of single-color pulses) the flicker rate seems to be increased, which is beneficial, however in general this timing sequence introduces a problem in that an additional fixed rotational displacement is included between the three color films (an approximately 3° addition for the G films and approximately 6° for the B film in the present inventors' demonstration) so that each individual color image is correctly in place when its illuminant flashes, but, since in this demonstration example a full 30° of rotation is desired for an image to pass from visible to invisible and the next image to pass from invisible to invisible, such a timing sequence results in colored ghost images which appear to lead and lag the intended image.

To avoid sudden large changes in frame rate, even if the next frame in an image sequence is also the next frame disposed angularly upon the film, it is advisable to make one full rotation plus one frame to get to that next frame (in our case, that is to rotate 390°). Similarly, if the next frame in the image sequence is one half way around the film it can be accessed upon either a half or one-and-a-half rotations. In this way the angular increment between frames as displayed may be constrained to always be between one half and one full rotation and hence to vary by a factor of only at most 2:1, whereas if this procedure is not adopted the frame rate could vary by as much as, in our example, 12:1 which results in a stuttering appearance for the holographic motion.

The present inventors distributed twelve frames for the crab movie angularly upon hologram films in an actual (rather than an as accessed) order such that wherever possible the immediately preceding and following images adjacent to any particular image are such as to form a reasonable sequence of actions for the crab character, even if not one of the sequences that would be performed when the crab is animated as intended. This ensures that in so far as an off-axis observer is able to see such previous or following images, which possibility depends upon various factors including the inter-frame angular separation, the degree of Bragg selectivity available, the holographic viewing angles of each frame, and the position of any such observer, the sequence of actions seen in any such off-axis sequence also tells a sensible story.

As described above, accessing twelve frames on a device rotating at something like 16 to 24 Hz without incurring unacceptable degrees of rotational blurring (which blurring should be included as an effect in the simulation environment) necessarily results in a low duty cycle for the illuminants and hence a comparatively dim image. One way to address this dimness is to decelerate the rotating mechanism as it approaches the desired position for a frame and then accelerate it back up to speed to seek the next frame. This involves extreme rates of acceleration and deceleration unless it is achieved using an optical image rotator, however a number of mechanisms may be used disposed around the rotating mechanism to accelerate and decelerate an additional (ideally lower mass) second moving element which itself holds the film/filter stack of the present disclosure. Suitable mechanisms can include, for example, any of a variety of mechanical linkages and cam-based mechanisms which can impart non uniform motion when driven by a uniform motion, for example Zeeman's Catastrophe machine (ZCM) or the “reciprocating rectilinear motion” device probably due to Henry T Brown (described in his 1868 book “Five Hundred and Seven Mechanical Movements”) or a spring or spring-like mechanism operating in an approximation of simple harmonic motion.

Occlusion

Summary: Various embodiments include fully or selectively removing “hidden surfaces” from multiple-slice holographic imagery.

As described above, component holograms produced in the context of the present disclosure may incorporate features such as back-face culling, shelling, and feathering to minimize or hide or conceal the effects of volume pileup between multiple recorded slices, with a caveat that in some cases, such as the clinical data anticipated in Hart, it may be advantageous to achieve the ghostly appearance (in which inner objects and details and the rear parts of objects and details may be seen through outer and front objects and details) which in the general case results from volume pileup, and a second caveat that comparatively uniform and well placed volume pileup which results from, for example, shelling, can be advantageous in brightening the holographic image. In Computer Graphics terminology, the presence of volume pileup may be described as a failure to achieve hidden surface removal (also known in optics terminology as occlusion) at least from those viewpoints into the resulting hologram from which the volume pileup is noticeable. As a third aspect the present disclosure includes systems and methods for substantially or completely eliminating or mitigating the potentially undesirable effects of volume pileup, and the corresponding dark banding (as described above) which occurs where slices should, but do not appear to, touch or overlap, while generally retaining the present disclosure's other advantages.

Lack of occlusion in the holograms of the present disclosure as so far described results from the fact that, as so far described, during the recording of each sequential exposure substantially the whole of the front of the diffusing screen of Hart is visible across substantially the whole of the recording surface of the recording material, and hence parts of the recorded images which desirably should not be visible from one or more regions of the recording material (i.e., which should be occluded or hidden by other parts of the composite holographic image when seen through the region or regions of the recording material) are visible. This may be prevented, and hence occlusion may selectively be introduced into the holograms, by providing a mechanism or means by which light from those parts of a constituent slice which should not be recorded over a certain region or regions of the recording material are blocked from reaching the region or regions of the recording material by the interposition of a selectively present or removed substantially opaque material or by providing a mechanism or means by which light from those parts of a constituent slice is altered such that even though it does reach the region or regions of the recording material it is not (or is not substantially) there recorded, for example because the provided occlusion mechanism or means has changed its direction, intensity, wavelength, or polarization to such a degree that it does not significantly or sufficiently interfere with the reference beam in the region or regions of the recording material.

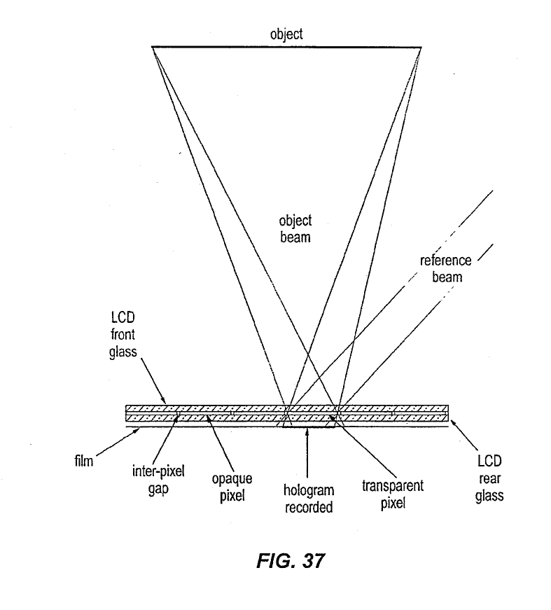

An example mechanism of the opaque kind is a patterned or shaped mask which closely overlays the recording material, blocking the object and/or reference light from reaching those regions where object light is not to be recorded. An example of the altering mechanism is a patterned or shaped polarization-controlling waveplate which rotates the polarization and/or intensity of the object and/or reference light destined to reach those regions where object light is not to be recorded. Such mechanisms may be provided by, for example, interposing a pixelated or otherwise patterned transmissive LCD screen between the diffusing screen and the recording material wherein the pixels or other patterns of the LCD may be electrically or otherwise switched between a substantially transparent and a substantially opaque state (an opaque kind of mechanism) or between states which impart a variable (including potentially a negligible) alteration in the transmission of polarized light (an altering mechanism). Such an LCD screen may thus selectively prevent recording over any desired region or regions of the recording material in a switchable and addressable manner (FIG. 37).

Suitable LCDs include, for example, the series of large grayscale LCDs manufactured by NEC such as, for example, the NL205153BM21-01 [NEC Electronics America, Inc, Santa Clara, Calif.], or such grayscale LCDs as are used in RGB-LED (or laser) illuminated color-sequential direct-view LCD monitors and televisions such as, for example, the Sony XBR8 [Sony Corporation of America, New York, N.Y.]. Alternatively LCD panels in which each sub-pixel has a specific color (such as red green and blue or red green blue and white) may be used, though in general with a single color of laser light used to record holograms through such a color-filtered LCD light is substantially transmitted through only one or two of the sub-sets of pixels (for example the green or the green and white sub pixels if a green laser is used). In any case, parallax effects dictate that any such LCD should ideally be positioned close to the recording material so that any given pixel of the LCD can influence both the object and the off-axis reference light for a pixel-sized region of the recording material.

For any particular opaque shape or pattern, the effect of such an LCD may be emulated by a mechanical mask such as, for example, a sheet of black card cut into the desired shape or pattern. Similarly, for any particular altering shape or pattern, the effect of such an LCD may be emulated by an optical mask such as, for example, a sheet of plastic waveplate material cut into the desired shape or pattern. Such mechanical or optical masks may be prepared or provided as needed for each sequential exposure, and may be interchanged for each such exposure manually or via an automatic mechanism.

A recording material with for example a very high index modulation capacity (such as DCG) or a very non-linear response (such as a silver-halide emulsion processed to a very high contrast) may record individual masked exposures sufficiently well even if only the reference beam is so masked. This can be achieved, for example, using a small transmission or reflection LCD panel inserted upstream into the reference beam in which case this mask need not be positioned close to the recording material. Such spatial modulators of beam intensity or polarization can also be used to adjust the local brightness or polarization of the reference and/or object beam across the surface of the recording material to better match the effective power of the reference and object beams at the recording surface to more closely achieve the desired beam ratio and exposure energy from point to point across the recording surface during mastering and/or copying.

To implement the occlusion aspect of the present disclosure it is necessary to calculate or otherwise determine the specific shape or pattern of masking of the recording material desired for each sequential exposure and the specific image content which is to be recorded for each such sequential exposure through each such shape or pattern of masking. For example, the desired image content may be computed by executing a conventional computer-graphics visibility algorithm for each addressable pixel or pattern offered by the exemplary LCD, such visibility algorithms including, for example, a ray-tracing algorithm or a painter's algorithm. The corresponding masking or alteration desired for any specific exposure is then just the collection of those LCD pixels or other sub-areas for which the visibility algorithm indicates identical or sufficiently similar image content. Alternatively the image content may be treated as comprising small subdivisions such as, for example, flat polygonal subdivisions or NURBS (and the content may even have been created in this fashion), and each such subdivision may be computationally projected onto the area of the recording material defining two areas or regions of the recording material, specifically a first area or region in which the subdivision is to be visible, and a second area or region in which it is not to be visible (or, in the case of double-sided subdivision, a first area where one side of the subdivision is to be visible and a second area in which the other side of the subdivision is to be visible). Such tilings of the area of the recording material may then be combined to compute a suitable set of masks for each exposure along with a list or other collection of polygon faces which are to be visible through each so calculated region of the mask.

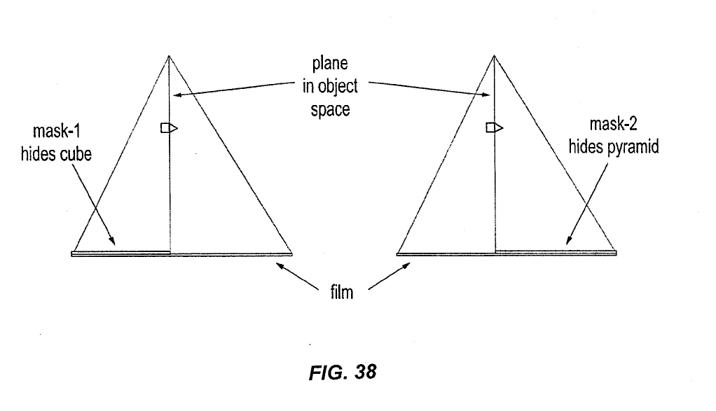

A very simple case is a double-sided plane in the holographic content which has a first pattern on its first side and a second (different) pattern on its other side. If this plane is positioned perpendicularly to the holographic recording material, then a first region of the recording material should see and record only the first pattern on the first side of the plane, and the remainder of the holographic material (forming a second region) should see and record only the second pattern on the second side of the plane (FIG. 38). A correct holographic recording of this content can be obtained by masking the second region of the recording material while recording content showing only the first pattern on the first side of the plane, and then masking the first region of the recording material while recording content showing only the second pattern on the second side of the plane.

In the most general case every pixel of the exemplary LCD acts as a separate mask in which every other pixel is suitably blocked or altered and every such pixel uses a separate exposure for each recorded z-depth in the composite hologram for which the exposure a different selection of image content is projected on the diffusing screen. Thus an LCD pixelated as X by Y pixels when combined with Z discrete image depths may use as many as X*Y*Z masks and image-content calculations and exposures. However the present inventors have determined that in general there is a great degree of similarity between the image content for each such exposure, and such “coherence” (in the computer graphics sense) may be exploited to reduce the number and/or accuracy of computations used, and in general the LCD pixels may be grouped into a smaller number of larger regions over which the same or substantially the same sub-set of image content polygons are substantially to be visible, which also may be exploited to reduce the number and/or accuracy of computations used and to reduce the number of exposures that are used.

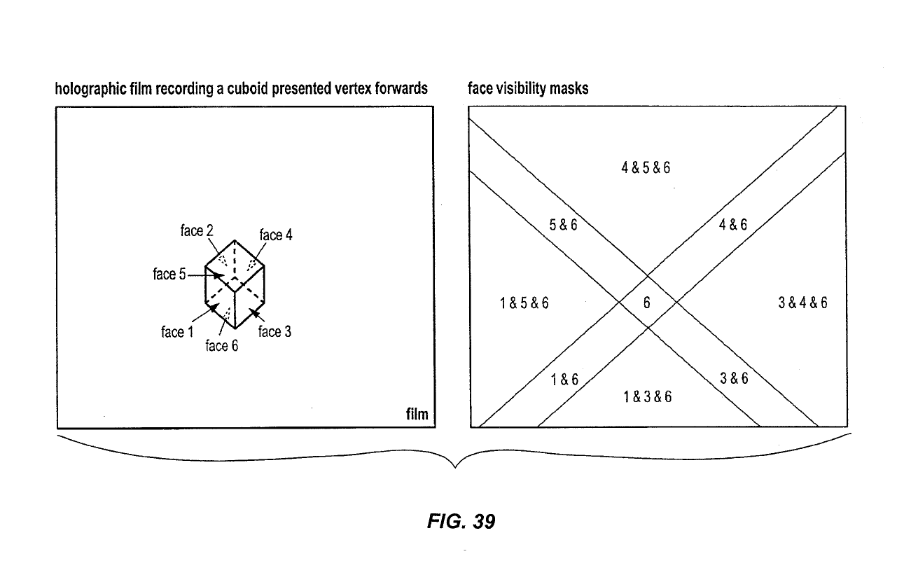

An example of intermediate complexity may help clarify the scope and extent of these reduced computations and exposures. Consider a hologram of a cube or other six-faced rectilinear three-dimensional object. Irrespective of how it is to be oriented relative to the recording material, at most five of its faces are visible from the recording material, and commonly only three faces are so visible. The three-dimensional position of each such face defines a line separating two sub areas of the recording material as described above for the single-plane example. Hence in the case in which five faces are so visible, the area of the recording material may be divided into at most nine sub regions (FIG. 39). Hence at most nine masks are sufficient rather than X*Y masks, and for each such mask at most Z exposures are used since any given combination of faces visible to any such masked area may occupy fewer than the entire available Z depth values. Rather than using X*Y*Z masks and exposures, this example uses at most nine masks and at most 9*Z exposures of the recording material and hence at most 9*Z images have to be calculated for the diffusion screen. Hence the computational cost and the number of exposures used for this special case is only approximately nine times what would be used without occlusion. In general the present inventors have estimated that holograms of many desired objects and scenes may be produced with satisfactory occlusion using only a few tens or hundreds of times as many visibility computations and exposures as would be used for a hologram of the same object or scene recorded without occlusion. Further, back-face culling, shelling, and feathering as described above can be combined with occlusion to further reduce the number of computations and exposures. The methods described above in the context of the motion aspect of the present disclosure for efficiently and cost effectively making many exposures can also be used for this occlusion aspect of the present disclosure.

A further advantage of the occlusion aspect of the present disclosure is that it permits the recording of holograms which exhibit or simulate partial transparency, and viewpoint-dependent changes of content or its appearance such as, for example, specular reflections and glints (which are generally seen via the stereoscopic disparity between such specularity as seen from the viewpoints of each eye).

Given that in general the pixels of a masking LCD as described above can be switched much more rapidly than the diffusion screen of the present disclosure can be moved between discrete z-values, in general it is faster to proceed with the occlusion aspect of the present disclosure in a depth-last fashion such that the diffuser to recording material separation is set to a first z-value, each occluded exposure for that the first z-value is made, and then the diffuser to recording material separation is set to a second z-value for each occluded exposure for that the second z-value, and so forth for each desired z value. On the other hand a depth first approach may be more desirable if, for example, a manually interchanged set of occlusion masks is utilized in which case changing through the set of z-values in depth-first series may well be achieved more rapidly or more conveniently than the act of changing between such masks repeatedly for each z-value.

Although the present disclosure has been described in detail in the foregoing embodiments, it is to be understood that the descriptions have been provided for purposes of illustration only and that other variations both in form and detail can be made thereupon by those skilled in the art without departing from the spirit and scope of the disclosure, which is defined solely by the appended claims. While certain steps outlined above may represent a specific embodiment, practitioners will appreciate that there are any number of mechanisms and processes and computing algorithms and user interfaces that may be applied to create similar results. The steps are presented for the sake of explanation only and are not intended to limit the scope of the disclosure in any way.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

We claim:

1. A method for producing an anisotropic optical material, the method comprising:
fabricating a mask upon which is disposed an alternating pattern of substantially-opaque regions and substantially-transparent regions;
assembling a stack of one or more sheets of substantially transparent material upon which is disposed one or more layers of photosensitive material; and
copying the pattern of the mask into the one or more layers of photosensitive material of the stack using a photographic process.

2. The method of claim 1, wherein the mask is at least one of: attached to the stack prior to the copying or removed from the stack subsequent to the copying.

3. The method of claim 1, wherein the process of fabrication of the mask includes at least one of: a printing process or a photographic process, wherein the printing process is at least one of: additive or subtractive, and wherein the photographic process is at least one of: a positive process or a negative process.

4. The method of claim 1, wherein the pattern comprises substantially-opaque lines alternating with substantially-transparent lines.

5. The method of claim 4, wherein the width of the substantially-opaque lines is approximately equal to the width of the substantially-transparent lines.

6. The method of claim 1, wherein the shape and size of the substantially-opaque regions are approximately equal to the shape and size of the substantially-transparent regions.

7. The method of claim 1, wherein the substantially-opaque regions and the substantially-transparent regions are at least one of: substantially square, substantially rectangular, substantially triangular, or substantially hexagonal.

8. The method of claim 1, wherein the transition from a substantially-opaque region to a neighboring substantially-transparent region is gradual.

9. The method of claim 1, wherein the process of assembly includes lamination with a substantially transparent adhesive.

10. The method of claim 2, wherein the process of attachment includes lamination with a substantially transparent adhesive.

11. The method of claim 1, wherein the pattern is created by copying a master pattern.

12. The method of claim 11, wherein the copying uses a photographic process, and wherein the photographic process is at least one of: a positive photographic process or a negative photographic process.

13. The method of claim 1, wherein the copying uses at least one of: a substantially collimated exposure source, a scanned exposure source, exposure energy incident substantially at a normal angle of incidence or exposure energy incident substantially at a substantially tilted angle of incidence.

14. The method of claim 1, wherein during the copying at least one of: the mask is scanned through exposure energy from an exposure source or the stack is scanned through exposure energy from an exposure source.

15. The method of claim 14, wherein the stack is drawn from a roll.

16. A system for producing an anisotropic optical material, the system comprising:
a fabrication device configured to fabricate a mask upon which is disposed an alternating pattern of substantially-opaque regions and substantially-transparent regions;
an assembly device configured to assemble a stack of one or more sheets of substantially transparent material upon which is disposed one or more layers of photosensitive material; and
a copying device configured to copy the pattern of the mask into the one or more layers of photosensitive material of the stack using a photographic process.

17. An article of manufacture for producing an anisotropic optical material, the article comprising:
a fabrication device configured to fabricate a mask upon which is disposed an alternating pattern of substantially-opaque regions and substantially-transparent regions;
an assembly device configured to assemble a stack of one or more sheets of substantially transparent material upon which is disposed one or more layers of photosensitive material; and
a copying device configured to copy the pattern of the mask into the one or more layers of photosensitive material of the stack using a photographic process.
